(19) United States
(12) Patent Application Publication
(10) Pub. No.: US 2021/0144998 A1
(43) Pub. Date: May 20, 2021

(54) COMPOSITIONS AND METHODS FOR TREATING HUANGLONGBING DISEASE IN CITRUS

(71) Applicant: NEW LIFE CROP SCIENCES LLC, DOVER, FL (US)

(72) Inventor: EDER LEONARDO SASTOQUE CALA, VALRICO, FL (US)

(21) Appl. No.: 17/098,887

(22) Filed: Nov. 16, 2020

Related U.S. Application Data
(60) Provisional application No. 62/935,737, filed on Nov. 15, 2019.

(51) Int. Cl. A01N 37/40; C05F 11/10; A01N 25/02; A01N 25/30; A01N 37/06

(52) U.S. Cl. CPC A01N 37/40; C05F 11/10; A01N 37/06; A01N 25/30; A01N 25/02

(57) ABSTRACT

The subject invention pertains to compositions and methods for controlling and/or treating citrus greening in citrus plants, such as orange trees, grapefruit trees, lime trees, lemon trees and the like. The compositions include fertilizers and liquid formulations.

### CROSS-REFERENCE TO RELATED APPLICATION

This application claims the benefit of U.S. Provisional Application Ser. No. 62/935,737, filed Nov. 15, 2019, the disclosure of which is hereby incorporated by reference in its entirety, including all figures, tables and amino acid or nucleic acid sequences.

### BACKGROUND OF THE INVENTION

Huanglongbing (HLB) or citrus greening disease was first reported in southern China in 1919. The disease is now found in approximately 40 different Asian, African, and North and South American countries and has become a serious threat in Florida, California, Louisiana, Texas, Cuba and Brazil, all of which are major citrus producing locations. Citrus greening disease is caused by the phloem-limited fastidious prokaryotic α-proteobacterium Candidatus Liberibacter spp., Ca. africanus, and Ca. L. americanus.

Citrus trees that become infected with the citrus greening disease go into decline, producing misshapen, off-flavor fruit, and then die within a few years. The billion dollar (annual) Florida citrus industry is severely threatened by this vector-disease pathosystem. Further, the disease also threatens the citrus industry in California. There is, currently, no cure for this disease and trees are routinely destroyed once severely infected. Moreover, there are no known relevant cultivars that are resistant to citrus greening disease.

The subject invention provides compositions and methods that provide a solution to this problem in the form of compositions comprising one of more of the compounds, some of which are plant secondary metabolites, disclosed in this application. The compositions are applied to infected citrus plants/trees as a means for reducing HLB disease.

### BRIEF SUMMARY OF THE INVENTION

This invention relates to compositions for the treatment of citrus greening. In certain embodiments, citrus plants are treated with the disclosed compositions after citrus greening has been identified within the citrus plant or a grove thereby mitigating or reducing the severity of disease in the citrus plants or trees within a grove. The subject invention also provides compositions and formulations comprising one or more of the disclosed compounds that are suitable for application to citrus plants/trees exhibiting signs of citrus greening.

### DETAILED DISCLOSURE OF THE INVENTION

As used herein, the singular forms “a”, “an” and “the” are intended to include the plural forms as well, unless the context clearly indicates otherwise. Further, to the extent that the terms “including”, “includes”, “having”, “has”, “with”, or variants thereof are used in either the detailed description and/or the claims, such terms are intended to be inclusive in a manner similar to the term “comprising”. The transitional terms/phrases (and any grammatical variations thereof) “comprising”, “comprises”, and “comprise” include the phrases “consisting essentially of”, “consists essentially of”, “consisting”, and “consists”.

The phrases “consisting essentially of” and “consists essentially of” indicate that the claim encompasses embodiments containing the specified materials or steps and those that do not materially affect the basic and novel characteristic(s) of the claim.

The term “about” or “approximately” means within an acceptable error range for the particular value as determined by one of ordinary skill in the art, which will depend in part on how the value is measured or determined, i.e., the limitations of the measurement system. In the context of time where the terms “about” and “approximately” are used in connection with quarterly or semiannual application of the disclosed compositions, a variation of between 2 and 8 weeks is contemplated between applications of the disclosed compositions. In the context of time where the terms “about” and “approximately” are used in connection with weekly application of the disclosed compositions, a variation of between 2 and 5 days is contemplated between applications of the disclosed compositions. In the context of time where the terms “about” and “approximately” are used in connection with monthly application of the disclosed compositions, a variation of between 2 and 3 weeks is between applications of the disclosed compositions is contemplated.

In some aspects of the invention, the disclosed compositions are applied to trees exhibiting symptoms of citrus greening multiple times, for example the diseased trees are treated approximately every six (6) months. Other embodiments contemplate application of the disclosed compositions in weekly, monthly, quarterly (every three months), and semiannual time frames. Yet other embodiments provide for repeated application of the disclosed compositions in time intervals of “about X months” or “about X weeks”, where X is an integer selected from 1, 2, 3, 4, 5, 6, 7, 8, 9, 10, 11 or 12.

In the context of compositions containing amounts of ingredients where the terms “about” or “approximately” are used, these compositions contain the stated amount of the ingredient with a variation (error range) of 0-10% around the stated value (X±10%).

In the present disclosure, ranges are stated in shorthand, so as to avoid having to set out at length and describe each and every value within the range. Any appropriate value within the range can be selected, where appropriate, as the upper value, lower value, or the terminus of the range. For example, a range of 0.1-1.0 represents the terminal values of 0.1 and 1.0, as well as the intermediate values of 0.2, 0.3, 0.4, 0.5, 0.6, 0.7, 0.8, 0.9, and all intermediate ranges encompassed within 0.1-1.0, such as 0.2-0.5, 0.2-0.8, 0.7-1.0, etc. Ranges provided herein are understood to be shorthand for all of the values within the range. For example, a range of 1 to 20 is understood to include any number, combination of numbers, or sub-range from the group consisting of 1, 2, 3, 4, 5, 6, 7, 8, 9, 10, 11, 12, 13, 14, 15, 16, 17, 18, 19, 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein, the term “reduce” (and grammatical variants thereof) refers to a negative alteration of at least 1%, 5%, 10%, 25%, 50%, 75%, or 100% with respect to the pathogen population present in the citrus plants affected by the disease within a citrus grove. In the context of the present invention, “control and/or treatment of citrus greening” means an improvement in the health and/or production of fruit by citrus plants/trees demonstrating symptoms of citrus greening. Alternatively, the disclosed methods reduce the severity of disease in citrus plants demonstrating symptoms of citrus greening by reducing the pathogen population present in infected citrus plants/trees.

One aspect of the invention provides compositions comprising one or more of the compounds (or stereoisomers and/or tautomers thereof and/or agriculturally acceptable salts thereof or secondary plant metabolites (phenolic acids, flavonoids, etc.) and/or agriculturally acceptable salts thereof as set forth in Table 1-2. The compounds set forth in Tables 1-2, as well as stereoisomers, tautomers and agriculturally acceptable salts thereof, may be referred to as “active agents” or “active ingredients”. In some embodiments, compositions comprising a combination of the compounds (or stereoisomers and/or tautomers thereof and/or agriculturally acceptable salts thereof/or secondary plant metabolites) as set forth in Tables 1-2 are provided for the control and/or treatment of citrus greening. As discussed above, the compositions as disclosed herein include one or more active agent, as set forth in Table 1 and/or 2 and can also contain one or more of the following components: agriculturally acceptable solvents, agriculturally acceptable carriers, stabilizers, antioxidant, preservatives or agriculturally acceptable surfactants. Yet other embodiments provide for the addition of various plant nutrients including vitamins, such as Vitamin A and Vitamin C, and/or crop oils to the disclosed compositions/formulations in suitable amounts.

Agriculturally acceptable solvents: In certain embodiments, active agents that are not soluble in aqueous solutions can, first, be solubilized in organic solvents or mixtures thereof and then dispersed in a carrier (e.g., water). Suitable organic solvents include all polar and non-polar organic solvents usually employed for formulation purposes. Non-limiting examples of organic solvents include ketones, e.g. acetone, methyl ethyl ketone, methyl isobutyl ketone or cyclohexanone, amides, e.g. dimethyl formamide and alkanecarboxylic acid amides, e.g. N,N-dimethyl decaneamide and N,N-dimethyl octanamide, cyclic solvents, e.g. N-methyl-pyrrolidone, N-octyl-pyrrolidone, N-dodecyl-pyrrolidone, N-octyl-caprolactame, N-dodecyl-caprolactame and butyrolactone, strong polar solvents, e.g. dimethylsulfoxide, and aromatic hydrocarbons, e.g. xylol, mineral oils, e.g. white spirit, petroleum, alkyl benzenes and spindle oil, esters, e.g. propyleneglycol-monomethylether acetate, adipic acid dibutylester, acetic acid hexylester, acetic acid heptylester, citric acid tri-n-butylester and phthalic acid di-n-butylester, and alcohols, e.g. methanol, ethanol, propanol, benzyl alcohol and 1-methoxy-2-propanol. For active agents soluble in aqueous solutions, water or any other aqueous solution can be used to solubilize the active agent.

Agriculturally acceptable carriers: A carrier is a natural or synthetic, organic or inorganic substance which is mixed or combined with the active agents for better applicability, in particular for application to citrus plants. The carrier is generally inert and should be suitable for use in agriculture. Non-limiting examples of carriers include water, alcohols (such as ethanol, propanol or butanol), organic solvents, mineral and vegetable oils, and derivatives thereof. Various mixtures of carriers can be used.

Agriculturally acceptable surfactants: The compositions according to the invention may contain surfactants or mixtures thereof. Suitable surfactants are emulsifiers, penetrants, dispersants or wetting agents having ionic or nonionic properties, or mixtures of these surfactants. Examples of these are salts of polyacrylic acid, salts of lignosulfonic acid, salts of phenolsulfonic acid or naphthalenesulfonic acid, polycondensates of ethylene oxide with fatty alcohols or with fatty acids or with fatty amines, substituted phenols (preferably alkylphenols or arylphenols), salts of sulfosuccinic esters, taurine derivatives (preferably alkyl taurates), phosphoric esters of polyethoxylated alcohols or phenols, fatty esters of polyols, and derivatives of the compounds containing sulfates, sulfonates and phosphates. A surfactant can be used if an active agent and/or one of the inert carriers is insoluble in water and when the application takes place in water. Other surfactants include common ionic and non-ionic substances, for example ethoxylated nonylphenols, polyalkylene glycolether of linear or branched alcohols, reaction products of alkyl phenols with ethylene oxide and/or propylene oxide, reaction products of fatty acid amines with ethylene oxide and/or propylene oxide, furthermore fatty acid esters, alkyl sulfonates, alkyl sulfates, alkyl ethersulfates, alkyl etherphosphates, arylsulfate, ethoxylated arylalkylphenols, e.g. tristyryl-phenol-ethoxylates, furthermore ethoxylated and propoxylated arylalkylphenols like sulfated or phosphated arylalkylphenol-ethoxylates and -ethoxy and -propoxylates. Further examples are natural and synthetic, water soluble polymers, e.g. lignosulfonates, gelatin, gum arabic, phospholipids, starch, hydrophobic modified starch and cellulose derivatives, in particular cellulose ester and cellulose ether, further polyvinyl alcohol, polyvinyl acetate, polyvinyl pyrrolidone, polyacrylic acid, polymethacrylic acid and co-polymerisates of (meth)acrylic acid and (meth)acrylic acid esters, and further co-polymerisates of methacrylic acid and methacrylic acid esters which are neutralized with alkali metal hydroxide and also condensation products of optionally substituted naphthalene sulfonic acid salts with formaldehyde. Other examples of agriculturally acceptable surfactants include crop oil concentrates organic (COC), methylated seed oils (MSO), high surfactant methylated seed oils (HSMSO), silicone surfactants (SS) and non-ionic surfactants (NIS). The proportion of surfactants is between about 0.5% and 20% by weight of the composition in its commercial form (as a concentrate).

The compositions according to the invention can comprise ready-to-use compositions which can be applied with suitable apparatus to a citrus plant or a commercial concentrate (formulation) that has to be diluted with, for example, water prior to use. Thus, the disclosed compositions may be in the form of a commercial/concentrated formulation or in a diluted form suitable for application to diseased citrus plants (e.g., mixed with other active ingredients, such as insecticides, attractants, sterilants, biostimulants, biocontrol agents, bactericides, acaricides, nematicides, fungicides, growth regulators, herbicides, fertilizers, and/or safeners).

In various aspects of the invention, the composition, in a commercial form/formulation, comprises between about 0.05% and about 99% by weight, about 0.01% and about 98% by weight, between about 0.1% and about 95% by weight, between about 1% and about 30% by weight, about 10% to about 25% by weight, about 15% to about 20% by weight, or between about 0.5% and about 90% by weight of the active agent (or combination of active agents) and one or more of the following components: agriculturally suitable solvents, agriculturally suitable carriers, or agriculturally suitable surfactants. Typically, the amount of active agent(s) present in a commercial formulation is between about 10% and about 99% by weight, about 10% and about 50% by weight, about 10% and about 40% by weight, about 10% and about 30% by weight, about 20% and about 40% by weight, about 25% and about 35% by weight, between about 60% and about 90% by weight, between about 70% and about 90% by weight or between about 80% and about 99% by weight. Various embodiments provide for amounts of active agent(s) in an amount of about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, or about 99%. Agriculturally suitable solvents, agriculturally suitable carriers, and/or agriculturally suitable surfactants can, each, account for between about 0.05% and about 99% by weight, about 0.01% and about 98% by weight, between about 0.1 and about 95% by weight, or between about 0.5% and about 90% by weight. As is apparent, the total weight of the composition is 100%, thus, if the active agent (or combination of active agents) represents 50% of the composition by weight, agriculturally suitable solvents, agriculturally suitable carriers, and/or agriculturally suitable surfactants account for the other 50% of the composition by weight.

In other embodiments, active ingredients in a commercial formulation can be provided in approximately equal amounts by weight (for example grams, ounces, pounds, kilograms, etc.) per liter of commercial formulation. These values can, of course, be converted in to grams, ounces, pounds, kilograms per gallon by those skilled in the art. For example, where more than one of the active ingredients listed in Tables 1 and/or 2 are combined in a composition, approximately equal or in equal amounts (by weight) of each active ingredient can be combined. Yet other embodiments provide for various amounts (by weight) of each active ingredient within a commercial formulation as disclosed herein. For example, each active ingredient can be present in amounts that range between 0.1 g and 100 g relative to the other active ingredients found in the commercial formulation. Thus, each active ingredient can be present in a commercial formulation in an amount of about 0.1 g to about 100 grams per liter (g per liter), about 0.1 g to about 50 g per liter, about 0.1 g to about 25 g per liter, about 0.1 g to 10 g per liter, 0.5 g to about 5 g per liter, 0.2 g to about 2 g per liter, about 0.5 g to about 1.5 g per liter, or about 1 g per liter.

Thus, for a commercial formulation having two active ingredient components, the amount can range between 0.1 g-100 g:0.1 g-100 g per liter;

for a commercial formulation having three active ingredient components, the ratio can range between 0.1 g-100 g:0.1 g-100 g:0.1 g-100 g per liter;

for a commercial formulation having four active ingredient components, the ratio can range between 0.1 g-100 g:0.1 g-100 g:0.1 g-100 g:0.1 g-100 g per liter;

for a commercial formulation having five active ingredient components, the ratio can range between 0.1 g-100 g:0.1 g-100 g:0.1 g-100 g:0.1 g-100 g:0.1 g-100 g per liter;

for a commercial formulation having six active ingredient components, the ratio can range between 0.1 g-100 g:0.1 g-100 g:0.1 g-100 g:0.1 g-100 g:0.1 g-100 g:0.1 g-100 g per liter;

for a commercial formulation having seven active ingredient components, the ratio can range between 0.1 g-100 g:0.1 g-100 g:0.1 g-100 g:0.1 g-100 g:0.1 g-100 g:0.1 g-100 g:0.1 g-10 g per liter;

for a commercial formulation having eight active ingredient components, the ratio can range between 0.1 g-100 g:0.1 g-100 g:0.1 g-100 g:0.1 g-100 g:0.1 g-100 g:0.1 g-100 g:0.1 g-100:0.1 g-100 g per liter;

for a commercial formulation having nine active ingredient components, the ratio can range between 0.1 g-100 g:0.1 g-100 g:0.1 g-100 g:0.1 g-100 g:0.1 g-100 g:0.1 g-100 g:0.1 g-100 g:0.1 g-100 g:0.1 g-100 g per liter; and

for a commercial formulation having ten active ingredient components, the ratio can range between 0.1 g-100 g:0.1 g-100 g:0.1 g-100 g:0.1 g-100 g:0.1 g-100 g:0.1 g-100 g:0.1 g-100 g:0.1 g-100 g:0.1 g-100 g:0.1 g-100 g per liter. Of course as additional active ingredients are added to the commercial formulation, each additional active ingredient can be added in an amount ranging between 0.1 g-100 g. As discussed above, the active ingredients in a commercial formulation can be provided in grams, ounces, pounds, kilograms, etc.

By way of a non-limiting example, combinations of active ingredients or stereoisomers, tautomers and/or agrochemically acceptable salts thereof from Table 2 include the following sets of combinations in the disclosed commercial formulations or application formulations (where a=Vanillic acid; b=Syringic acid; c=P-Coumaric acid; d=Silicic acid; e=Cinnamic acid; f=Ferulic acid; g=Fisetin; h=Oxybenzone; i=Orbifloxacin; and j=Rosiglitazone maleate):

2 combination sets: a, b; a, c; a, d; a, e; a, f; a, g; a, h; a, i; a, j; b, c; b, d, b, e; b, f; b, g; b, h; b, i; b, j; c, d; c, e; c, f; c, g; c, h; c, i; c, j; d, e; d, f, d, g; d, h; d, i; d, j; e, f, e, g; e, h; e, i; e, j; f, g; f, h; f, i; f, j; g, h; g, i; g, j; h, i; h, j; or i, j;

3 combination sets: a, b, c; a, b, d; a, b, e; a, b, f; a, b, g; a, b, h; a, b, i; a, b, j; a, c, d; a, c, e; a, c, f; a, c, g; a, c, h; a, c, i; a, c, j; a, d, e; a, d, f; a, d, g; a, d, h; a, d, i; a, d, j; a, e, f; a, e, g; a, e, h; a, e, i; a, e, j; a, f, g; a, f, h; a, f, i; a, f, j; a, g, h; a, g, i; a, g, j; a, h, i; a, h, j; a, i, j; b, c, d; b, c, e; b, c, f, b, c, g; b, c, h; b, c, i; b, c, j; b, d, e; b, d, f, b, d, g; b, d, h; b, d, i; b, d, j; b, e, f, b, e, g; b, e, h; b, e, i; b, e, j; b, f, g; b, f, h; b, f, i; b, f, j; b, g, h; b, g, i; b, g, j; b, h, i; b, h, j; b, i, j; c, d, e; c, d, f; c, d, g; c, d, h; c, d, i; c, d, j; c, e, f; c, e, g; c, e, h; c, e, i; c, e, j; c, f, g; c, f, h; c, f, i; c, f, j; c, g, h; c, g, i; c, g, j; c, h, i; c, h, j; c, i, j; d, e, f; d, e, g; d, e, h; d, e, i; d, e, j; d, f, g; d, f, h; d, f, i; d, f, j; d, g, h; d, g, i; d, g, j; d, h, i; d, h, j; d, i, j; e, f, g; e, f, h; e, f, i; e, f, j; e, g, h; e, g, i; e, g, j; e, h, i; e, h, j; e, i, j; f, g, h; f, g, i; f, g, j; f, h, i; f, h, j; f, i, j; g, h, i; g, h, j; g, i, j; or h, i, j;

4 combination sets: a, b, c, d; a, b, c, e; a, b, c, f; a, b, c, g; a, b, c, h; a, b, c, i; a, b, c, j; a, b, d, e; a, b, d, f; a, b, d, g; a, b, d, h; a, b, d, i; a, b, d, j; a, b, e, f, a, b, e, g; a, b, e, h; a, b, e, i; a, b, e, j; a, b, f, g; a, b, f, h; a, b, f, i; a, b, f, j; a, b, g, h; a, b, g, i; a, b, g, j; a, b, h, i; a, b, h, j; a, b, i, j; a, c, d, e; a, c, d, f; a, c, d, g; a, c, d, h; a, c, d, i; a, c, d, j; a, c, e, f; a, c, e, g; a, c, e, h; a, c, e, i; a, c, e, j; a, c, f, g; a, c, f, h; a, c, f, i; a, c, f, j; a, c, g, h; a, c, g, i; a, c, g, j; a, c, h, i; a, c, h, j; a, c, i, j; a, d, e, f; a, d, e, g; a, d, e, h; a, d, e, i; a, d, e, j; a, d, f, g; a, d, f, h; a, d, f, i; a, d, f, j; a, d, g, h; a, d, g, i; a, d, g, j; a, d, h, i; a, d, h, j; a, d, i, j; a, e, f, g; a, e, f, h; a, e, f, i; a, e, f, j; a, e, g, h; a, e, g, i; a, e, g, j; a, e, h, i; a, e, h, j; a, e, i, j; a, f, g, h; a, f, g, i; a, f, g, j; a, f, h, i; a, f, h, j; a, f, i, j; a, g, h, i; a, g, h, j; a, g, i, j; a, h, i, j; b, c, d, e; b, c, d, f, b, c, d, g; b, c, d, h; b, c, d, i; b, c, d, j; b, c, e, f; b, c, e, g; b, c, e, h; b, c, e, i; b, c, e, j; b, c, f, g; b, c, f, h; b, c, f, i; b, c, f, j; b, c, g, h; b, c, g, i; b, c, g, j; b, c, h, i; b, c, h, j; b, c, i, j; b, d, e, f, b, d, e, g; b, d, e, h; b, d, e, i; b, d, e, j; b, d, f, g; b, d, f, h; b, d, f, i; b, d, f, j; b, d, g, h; b, d, g, i; b, d, g, j; b, d, h, i; b, d, h, j; b, d, i, j; b, e, f, g; b, e, f, h; b, e, f, i; b, e, f, j; b, e, g, h; b, e, g, i; b, e, g, j; b, e, h, i; b, e, h, j; b, e, i, j; b, f, g, h; b, f, g, i; b, f, g, j; b, f, h, i; b, f, h, j; b, f, i, j; b, g, h, i; b, g, h, j; b, g, i, j; b, h, i, j; c, d, e, f; c, d, e, g; c, d, e, h; c, d, e, i; c, d, e, j; c, d, f, g; c, d, f, h; c, d, f, i; c, d, f, j; c, d, g, h; c, d, g, i; c, d, g, j; c, d, h, i; c, d, h, j; c, d, i, j; c, e, f, g; c, e, f, h; c, e, f, i; c, e, f, j; c, e, g, h; c, e, g, i; c, e, g, j; c, e, h, i; c, e, h, j; c, e, i, j; c, f, g, h; c, f, g, i; c, f, g, j; c, f, h, i; c, f, h, j; c, f, i, j; c, g, h, i; c, g, h, j; c, g, i, j; c, h, i, j; d, e, f, g; d, e, f, h; d, e, f, i; d, e, f, j; d, e, g, h; d, e, g, i; d, e, g, j; d, e, h, i; d, e, h, j; d, e, i, j; d, f, g, h; d, f, g, i; d, f, g, j; d, f, h, i; d, f, h, j; d, f, i, j; d, g, h, i; d, g, h, j; d, g, i, j; d, h, i, j; e, f, g, h; e, f, g, i; e, f, g, j; e, f, h, i; e, f, h, j; e, f, i, j; e, g, h, i; e, g, h, j; e, g, i, j; e, h, i, j; f, g, h, i; f, g, h, j; f, g, i, j; f, h, i, j; or g, h, i, j;

5 combination sets: a, b, c, d, e; a, b, c, d, f; a, b, c, d, g; a, b, c, d, h; a, b, c, d, i; a, b, c, d, j; a, b, c, e, f; a, b, c, e, g; a, b, c, e, h; a, b, c, e, i; a, b, c, e, j; a, b, c, f, g; a, b, c, f, h; a, b, c, f, i; a, b, c, f, j; a, b, c, g, h; a, b, c, g, i; a, b, c, g, j; a, b, c, h, i; a, b, c, h, j; a, b, c, i, j; a, b, d, e, f; a, b, d, e, g; a, b, d, e, h; a, b, d, e, i; a, b, d, e, j; a, b, d, f, g; a, b, d, f, h; a, b, d, f, i; a, b, d, f, j; a, b, d, g, h; a, b, d, g, i; a, b, d, g, j; a, b, d, h, i; a, b, d, h, j; a, b, d, i, j; a, b, e, f, g; a, b, e, f, h; a, b, e, f, i; a, b, e, f, j; a, b, e, g, h; a, b, e, g, i; a, b, e, g, j; a, b, e, h, i; a, b, e, h, j; a, b, e, i, j; a, b, f, g, h; a, b, f, g, i; a, b, f, g, j; a, b, f, h, i; a, b, f, h, j; a, b, f, i, j; a, b, g, h, i; a, b, g, h, j; a, b, g, i, j; a, b, h, i, j; a, c, d, e, f; a, c, d, e, g; a, c, d, e, h; a, c, d, e, i; a, c, d, e, j; a, c, d, f, g; a, c, d, f, h; a, c, d, f, i; a, c, d, f, j; a, c, d, g, h; a, c, d, g, i; a, c, d, g, j; a, c, d, h, i; a, c, d, h, j; a, c, d, i, j; a, c, e, f, g; a, c, e, f, h; a, c, e, f, i; a, c, e, f, j; a, c, e, g, h; a, c, e, g, i; a, c, e, g, j; a, c, e, h, i; a, c, e, h, j; a, c, e, i, j; a, c, f, g, h; a, c, f, g, i; a, c, f, g, j; a, c, f, h, i; a, c, f, h, j; a, c, f, i, j; a, c, g, h, i; a, c, g, h, j; a, c, g, i, j; a, c, h, i, j; a, d, e, f, g; a, d, e, f, h; a, d, e, f, i; a, d, e, f, j; a, d, e, g, h; a, d, e, g, i; a, d, e, g, j; a, d, e, h, i; a, d, e, h, j; a, d, e, i, j; a, d, f, g, h; a, d, f, g, i; a, d, f, g, j; a, d, f, h, i; a, d, f, h, j; a, d, f, i, j; a, d, g, h, i; a, d, g, h, j; a, d, g, i, j; a, d, h, i, j; a, e, f, g, h; a, e, f, g, i; a, e, f, g, j; a, e, f, h, i; a, e, f, h, j; a, e, f, i, j; a, e, g, h, i; a, e, g, h, j; a, e, g, i, j; a, e, h, i, j; a, f, g, h, i; a, f, g, h, j; a, f, g, i, j; a, f, h, i, j; a, g, h, i, j; b, c, d, e, f; b, c, d, e, g; b, c, d, e, h; b, c, d, e, i; b, c, d, e, j; b, c, d, f, g; b, c, d, f, h; b, c, d, f, i; b, c, d, f, j; b, c, d, g, h; b, c, d, g, i; b, c, d, g, j; b, c, d, h, i; b, c, d, h, j; b, c, d, i, j; b, c, e, f, g; b, c, e, f, h; b, c, e, f, i; b, c, e, f, j; b, c, e, g, h; b, c, e, g, i; b, c, e, g, j; b, c, e, h, i; b, c, e, h, j; b, c, e, i, j; b, c, f, g, h; b, c, f, g, i; b, c, f, g, j; b, c, f, h, i; b, c, f, h, j; b, c, f, i, j; b, c, g, h, i; b, c, g, h, j; b, c, g, i, j; b, c, h, i, j; b, d, e, f, g; b, d, e, f, h; b, d, e, f, i; b, d, e, f, j; b, d, e, g, h; b, d, e, g, i; b, d, e, g, j; b, d, e, h, i; b, d, e, h, j; b, d, e, i, j; b, d, f, g, h; b, d, f, g, i; b, d, f, g, j; b, d, f, h, i; b, d, f, h, j; b, d, f, i, j; b, d, g, h, i; b, d, g, h, j; b, d, g, i, j; b, d, h, i, j; b, e, f, g, h; b, e, f, g, i; b, e, f, g, j; b, e, f, h, i; b, e, f, h, j; b, e, f, i, j; b, e, g, h, i; b, e, g, h, j; b, e, g, i, j; b, e, h, i, j; b, f, g, h, i; b, f, g, h, j; b, f, g, i, j; b, f, h, i, j; b, g, h, i, j; c, d, e, f, g; c, d, e, f, h; c, d, e, f, i; c, d, e, f, j; c, d, e, g, h; c, d, e, g, i; c, d, e, g, j; c, d, e, h, i; c, d, e, h, j; c, d, e, i, j; c, d, f, g, h; c, d, f, g, i; c, d, f, g, j; c, d, f, h, i; c, d, f, h, j; c, d, f, i, j; c, d, g, h, i; c, d, g, h, j; c, d, g, i, j; c, d, h, i, j; c, e, f, g, h; c, e, f, g, i; c, e, f, g, j; c, e, f, h, i; c, e, f, h, j; c, e, f, i, j; c, e, g, h, i; c, e, g, h, j; c, e, g, i, j; c, e, h, i, j; c, f, g, h, i; c, f, g, h, j; c, f, g, i, j; c, f, h, i, j; c, g, h, i, j; d, e, f, g, h; d, e, f, g, i; d, e, f, g, j; d, e, f, h, i; d, e, f, h, j; d, e, f, i, j; d, e, g, h, i; d, e, g, h, j; d, e, g, i, j; d, e, h, i, j; d, f, g, h, i; d, f, g, h, j; d, f, g, i, j; d, f, h, i, j; d, g, h, i, j; e, f, g, h, i; e, f, g, h, j; e, f, g, i, j; e, f, h, i, j; e, g, h, i, j; or f, g, h, i, j;

6 combination sets: a, b, c, d, e, f; a, b, c, d, e, g; a, b, c, d, e, h; a, b, c, d, e, i; a, b, c, d, e, j; a, b, c, d, f, g; a, b, c, d, f, h; a, b, c, d, f, i; a, b, c, d, f, j; a, b, c, d, g, h; a, b, c, d, g, i; a, b, c, d, g, j; a, b, c, d, h, i; a, b, c, d, h, j; a, b, c, d, i, j; a, b, c, e, f, g; a, b, c, e, f, h; a, b, c, e, f, i; a, b, c, e, f, j; a, b, c, e, g, h; a, b, c, e, g, i; a, b, c, e, g, j; a, b, c, e, h, i; a, b, c, e, h, j; a, b, c, e, i, j; a, b, c, f, g, h; a, b, c, f, g, i; a, b, c, f, g, j; a, b, c, f, h, i; a, b, c, f, h, j; a, b, c, f, i, j; a, b, c, g, h, i; a, b, c, g, h, j; a, b, c, g, i, j; a, b, c, h, i, j; a, b, d, e, f, g; a, b, d, e, f, h; a, b, d, e, f, i; a, b, d, e, f, j; a, b, d, e, g, h; a, b, d, e, g, i; a, b, d, e, g, j; a, b, d, e, h, i; a, b, d, e, h, j; a, b, d, e, i, j; a, b, d, f, g, h; a, b, d, f, g, i; a, b, d, f, g, j; a, b, d, f, h, i; a, b, d, f, h, j; a, b, d, f, i, j; a, b, d, g, h, i; a, b, d, g, h, j; a, b, d, g, i, j; a, b, d, h, i, j; a, b, e, f, g, h; a, b, e, f, g, i; a, b, e, f, g, j; a, b, e, f, h, i; a, b, e, f, h, j; a, b, e, f, i, j; a, b, e, g, h, i; a, b, e, g, h, j; a, b, e, g, i, j; a, b, e, h, i, j; a, b, f, g, h, i; a, b, f, g, h, j; a, b, f, g, i, j; a, b, f, h, i, j; a, b, g, h, i, j; a, c, d, e, f, g; a, c, d, e, f, h; a, c, d, e, f, i; a, c, d, e, f, j; a, c, d, e, g, h; a, c, d, e, g, i; a, c, d, e, g, j; a, c, d, e, h, i; a, c, d, e, h, j; a, c, d, e, i, j; a, c, d, f, g, h; a, c, d, f, g, i; a, c, d, f, g, j; a, c, d, f, h, i; a, c, d, f, h, j; a, c, d, f, i, j; a, c, d, g, h, i; a, c, d, g, h, j; a, c, d, g, i, j; a, c, d, h, i, j; a, c, e, f, g, h; a, c, e, f, g, i; a, c, e, f, g, j; a, c, e, f, h, i; a, c, e, f, h, j; a, c, e, f, i, j; a, c, e, g, h, i; a, c, e, g, h, j; a, c, e, g, i, j; a, c, e, h, i, j; a, c, f, g, h, i; a, c, f, g, h, j; a, c, f, g, i, j; a, c, f, h, i, j; a, c, g, h, i, j; a, d, e, f, g, h; a, d, e, f, g, i; a, d, e, f, g, j; a, d, e, f, h, i; a, d, e, f, h, j; a, d, e, f, i, j; a, d, e, g, h, i; a, d, e, g, h, j; a, d, e, g, i, j; a, d, e, h, i, j; a, d, f, g, h, i; a, d, f, g, h, j; a, d, f, g, i, j; a, d, f, h, i, j; a, d, g, h, i, j; a, e, f, g, h, i; a, e, f, g, h, j; a, e, f, g, i, j; a, e, f, h, i, j; a, e, g, h, i, j; a, f, g, h, i, j; b, c, d, e, f, g; b, c, d, e, f, h; b, c, d, e, f, i; b, c, d, e, f, j; b, c, d, e, g, h; b, c, d, e, g, i; b, c, d, e, g, j; b, c, d, e, h, i; b, c, d, e, h, j; b, c, d, e, i, j; b, c, d, f, g, h; b, c, d, f, g, i; b, c, d, f, g, j; b, c, d, f, h, i; b, c, d, f, h, j; b, c, d, f, i, j; b, c, d, g, h, i; b, c, d, g, h, j; b, c, d, g, i, j; b, c, d, h, i, j; b, c, e, f, g, h; b, c, e, f, g, i; b, c, e, f, g, j; b, c, e, f, h, i; b, c, e, f, h, j; b, c, e, f, i, j; b, c, e, g, h, i; b, c, e, g, h, j; b, c, e, g, i, j; b, c, e, h, i, j; b, c, f, g, h, i; b, c, f, g, h, j; b, c, f, g, i, j; b, c, f, h, i, j; b, c, g, h, i, j; b, d, e, f, g, h; b, d, e, f, g, i; b, d, e, f, g, j; b, d, e, f, h, i; b, d, e, f, h, j; b, d, e, f, i, j; b, d, e, g, h, i; b, d, e, g, h, j; b, d, e, g, i, j; b, d, e, h, i, j; b, d, f, g, h, i; b, d, f, g, h, j; b, d, f, g, i, j; b, d, f, h, i, j; b, d, g, h, i, j; b, e, f, g, h, i; b, e, f, g, h, j; b, e, f, g, i, j; b, e, f, h, i, j; b, e, g, h, i, j; b, f, g, h, i, j; c, d, e, f, g, h; c, d, e, f, g, i; c, d, e, f, g, j; c, d, e, f, h, i; c, d, e, f, h, j; c, d, e, f, i, j; c, d, e, g, h, i; c, d, e, g, h, j; c, d, e, g, i, j; c, d, e, h, i, j; c, d, f, g, h, i; c, d, f, g, h, j; c, d, f, g, i, j; c, d, f, h, i, j; c, d, g, h, i, j; c, e, f, g, h, i; c, e, f, g, h, j; c, e, f, g, i, j; c, e, f, h, i, j; c, e, g, h, i, j; c, f, g, h, i, j; d, e, f, g, h, i; d, e, f, g, h, j; d, e, f, g, i, j; d, e, f, h, i, j; d, e, g, h, i, j; d, f, g, h, i, j; or e, f, g, h, i, j;

7 combination sets: a, b, c, d, e, f, g; a, b, c, d, e, f, h; a, b, c, d, e, f, i; a, b, c, d, e, f, j; a, b, c, d, e, g, h; a, b, c, d, e, g, i; a, b, c, d, e, g, j; a, b, c, d, e, h, i; a, b, c, d, e, h, j; a, b, c, d, e, i, j; a, b, c, d, f, g, h; a, b, c, d, f, g, i; a, b, c, d, f, g, j; a, b, c, d, f, h, i; a, b, c, d, f, h, j; a, b, c, d, f, i, j; a, b, c, d, g, h, i; a, b, c, d, g, h, j; a, b, c, d, g, i, j; a, b, c, d, h, i, j; a, b, c, e, f, g, h; a, b, c, e, f, g, i; a, b, c, e, f, g, j; a, b, c, e, f, h, i; a, b, c, e, f, h, j; a, b, c, e, f, i, j; a, b, c, e, g, h, i; a, b, c, e, g, h, j; a, b, c, e, g, i, j; a, b, c, e, h, i, j; a, b, c, f, g, h, i; a, b, c, f, g, h, j; a, b, c, f, g, i, j; a, b, c, f, h, i, j; a, b, c, g, h, i, j; a, b, d, e, f, g, h; a, b, d, e, f, g, i; a, b, d, e, f, g, j; a, b, d, e, f, h, i; a, b, d, e, f, h, j; a, b, d, e, f, i, j; a, b, d, e, g, h, i; a, b, d, e, g, h, j; a, b, d, e, g, i, j; a, b, d, e, h, i, j; a, b, d, f, g, h, i; a, b, d, f, g, h, j; a, b, d, f, g, i, j; a, b, d, f, h, i, j; a, b, d, g, h, i, j; a, b, e, f, g, h, i; a, b, e, f, g, h, j; a, b, e, f, g, i, j; a, b, e, f, h, i, j; a, b, e, g, h, i, j; a, b, f, g, h, i, j; a, c, d, e, f, g, h; a, c, d, e, f, g, i; a, c, d, e, f, g, j; a, c, d, e, f, h, i; a, c, d, e, f, h, j; a, c, d, e, f, i, j; a, c, d, e, g, h, i; a, c, d, e, g, h, j; a, c, d, e, g, i, j; a, c, d, e, h, i, j; a, c, d, f, g, h, i; a, c, d, f, g, h, j; a, c, d, f, g, i, j; a, c, d, f, h, i, j; a, c, d, g, h, i, j; a, c, e, f, g, h, i; a, c, e, f, g, h, j; a, c, e, f, g, i, j; a, c, e, f, h, i, j; a, c, e, g, h, i, j; a, c, f, g, h, i, j; a, d, e, f, g, h, i; a, d, e, f, g, h, j; a, d, e, f, g, i, j; a, d, e, f, h, i, j; a, d, e, g, h, i, j; a, d, f, g, h, i, j; a, e, f, g, h, i, j; b, c, d, e, f, g, h; b, c, d, e, f, g, i; b, c, d, e, f, g, j; b, c, d, e, f, h, i; b, c, d, e, f, h, j; b, c, d, e, f, i, j; b, c, d, e, g, h, i; b, c, d, e, g, h, j; b, c, d, e, g, i, j; b, c, d, e, h, i, j; b, c, d, f, g, h, i; b, c, d, f, g, h, j; b, c, d, f, g, i, j; b, c, d, f, h, i, j; b, c, d, g, h, i, j; b, c, e, f, g, h, i; b, c, e, f, g, h, j; b, c, e, f, g, i, j; b, c, e, f, h, i, j; b, c, e, g, h, i, j; b, c, f, g, h, i, j; b, d, e, f, g, h, i; b, d, e, f, g, h, j; b, d, e, f, g, i, j; b, d, e, f, h, i, j; b, d, e, g, h, i, j; b, d, f, g, h, i, j; b, e, f, g, h, i, j; c, d, e, f, g, h, i; c, d, e, f, g, h, j; c, d, e, f, g, i, j; c, d, e, f, h, i, j; c, d, e, g, h, i, j; c, d, f, g, h, i, j; c, e, f, g, h, i, j; or d, e, f, g, h, i, j;

8 combination sets: a, b, c, d, e, f, g, h; a, b, c, d, e, f, g, i; a, b, c, d, e, f, g, j; a, b, c, d, e, f, h, i; a, b, c, d, e, f, h, j; a, b, c, d, e, f, i, j; a, b, c, d, e, g, h, i; a, b, c, d, e, g, h, j; a, b, c, d, e, g, i, j; a, b, c, d, e, h, i, j; a, b, c, d, f, g, h, i; a, b, c, d, f, g, h, j; a, b, c, d, f, g, i, j; a, b, c, d, f, h, i, j; a, b, c, d, g, h, i, j; a, b, c, e, f, g, h, i; a, b, c, e, f, g, h, j; a, b, c, e, f, g, i, j; a, b, c, e, f, h, i, j; a, b, c, e, g, h, i, j; a, b, c, f, g, h, i, j; a, b, d, e, f, g, h, i; a, b, d, e, f, g, h, j; a, b, d, e, f, g, i, j; a, b, d, e, f, h, i, j; a, b, d, e, g, h, i, j; a, b, d, f, g, h, i, j; a, b, e, f, g, h, i, j; a, c, d, e, f, g, h, i; a, c, d, e, f, g, h, j; a, c, d, e, f, g, i, j; a, c, d, e, f, h, i, j; a, c, d, e, g, h, i, j; a, c, d, f, g, h, i, j; a, c, e, f, g, h, i, j; a, d, e, f, g, h, i, j; b, c, d, e, f, g, h, i; b, c, d, e, f, g, h, j; b, c, d, e, f, g, i, j; b, c, d, e, f, h, i, j; b, c, d, e, g, h, i, j; b, c, d, f, g, h, i, j; b, c, e, f, g, h, i, j; b, d, e, f, g, h, i, j; or c, d, e, f, g, h, i, j;

9 combination sets: a, b, c, d, e, f, g, h, i; a, b, c, d, e, f, g, h, j; a, b, c, d, e, f, g, i, j; a, b, c, d, e, f, h, i, j; a, b, c, d, e, g, h, i, j; a, b, c, d, f, g, h, i, j; a, b, c, e, f, g, h, i, j; a, b, d, e, f, g, h, i, j; a, c, d, e, f, g, h, i, j; or b, c, d, e, f, g, h, i, j; or

10 combination set: a, b, c, d, e, f, g, h, i, j.

In certain embodiments, the combination of active agents comprises syringic acid, p-coumaric acid, vanillic acid, and cinnamic acid, each of which is present in a commercial formulation in an amount of about 0.1 g to about 100 g per liter, about 0.1 g to about 50 g per liter, about 0.1 g to about 25 g per liter, about 0.1 g to 10 g per liter, 0.5 g to about 5 g per liter, 0.2 g to about 2 g per liter, about 0.5 g to about 1.5 g per liter, or about 1 g per liter.

The compositions comprising one or more active agent(s) that are prepared from commercial formulations (in a diluted form suitable for application to a citrus plant; “an application formulation”) may vary in a broad range. The concentration of the active ingredients in the application formulation is generally between about 0.001% to about 5% by weight, preferably between about 0.01% and 2% by weight or about 1%. Agriculturally suitable solvents, agriculturally suitable carriers, and/or agriculturally suitable surfactants can, each, account for between about 0.1% and about 30% by weight, about 0.1% and about 25% by weight, between about 0.1% and about 15% percent by weight, or between about 0.5 and about 5% by weight when present, with the balance of the composition weight being provided by an inert agriculturally acceptable carrier, for example, water. As discussed above with respect to a commercial formulation, where more than one of the active ingredients listed in Tables 1 and 2 are combined in a composition that is provided in a diluted form, approximately equal or in equal amounts (by weight) of each active ingredient are present. Yet other embodiments provide for various ratios (by weight) of each active ingredient within a diluted composition as disclosed. For example, each active ingredient can be present in ratios that range between 0.1 and 100 relative to the other active ingredients found in the composition as is discussed with respect to the commercial formulation that is diluted. In some embodiments, the commercial formulation can be diluted at ratios of 1:1 to 1:100 or more with an agriculturally acceptable carrier (commercial formulation: agriculturally acceptable carrier), such as water, for example, 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, or 1:100. In some embodiments, the commercial formulation is diluted at ratios of about 1:1 to about 1:75, about 1:1 to about 1:50, about 1:1 to about 1:40, about 1:1 to about 1:30, about 1:1 to about 1:20, or about 1:1 to about 1:10.

Exemplary plants that can be treated in accordance with the disclosed compositions include any cultivar from the genus Citrus, including but not limited to Citrus sinensis, lemon (C. limon), Persian lime (C. latifolia), grapefruit (C. paradisi), sour orange (C. aurantium), and mandarin (C. reticulata). Thus, according to a specific embodiment, the citrus plant or tree includes, but is not limited to, all citrus species and subspecies, including sweet oranges of commercial varieties (Citrus sinensis Osbeck (L.)), clementines (C. clementina), mandarin oranges (C. reticulata), key limes (C. aurantifolia), lemon (C. limon), sour orange (C. aurantium), hybrids and relatives (Citranges, Citrumelos, Citrandarins), Balsamocitrus dawei, C. maxima, C. jambhiri, Clausena indica, C. lansium, Triphasia trifolia, Swinglea glutinosa, Micromellum tephrocarpa, Merope spp., Eremolemon, Atalantia spp., Severinia buxifolia, Microcitrus spp., Fortunella spp., Calodendrum capense, Murraya spp. and Poncirus trifoliata. In some embodiments the citrus plant is an orange, a lemon, a lime, a grapefruit, a clementine, a tangerine, a tangelo or a pomelo tree.

The subject invention also provides for methods for controlling and/or treating citrus greening disease in citrus plants comprising the administration of a composition comprising, consisting essentially of, or consisting of the compounds (active agent(s)) disclosed in Tables 1-2 (and/or stereoisomers, tautomers, plant secondary metabolites, microbial metabolites and/or agriculturally acceptable salts thereof) to the citrus plant. Typically, the composition is administered to the citrus plant as “an application formulation”. For example, the compositions can be administered (applied) to plants by foliar spray, injection into the phloem, or drench application to the root system. Citrus plants typically receive foliar spray application of fungicides, insecticides, and/or nutritionals. Most foliar sprays are applied by airblast sprayers. Thus, in one embodiment, compositions disclosed within this application are applied via foliar spray to citrus plants.

In another embodiment, the disclosed compositions are applied to citrus plants via drench application to the root system of a citrus plant typically applied by a herbicide sidedress applicator. A root drench, also referred to as a soil drench, is applied when the soil around the plant's base is slightly moist. Weeds, leaves or other material covering the soil under the tree canopy can be controlled to allow nutrients and other applications to penetrate the soil and reach the roots of the tree.

A third option for delivering the disclosed compositions to citrus plants comprises delivering the composition to the citrus plants using irrigation systems. Exemplary irrigation systems that can be used to deliver the disclosed compositions to citrus plants (via an injection system that introduce the composition into the water supply) include microjets (low volume systems with sprinklers adjacent to each tree or between two trees), flood irrigation, or overhead sprinklers. While any of these irrigation systems could be used to deliver the disclosed compositions to citrus plants, microjets are preferred as it delivers the composition to the citrus plants as a soil application or a drench. Typically, a commercial form of the disclosed composition would be injected into the irrigation system in an amount that delivers active agent(s) in amounts that correspond to an “application formulation” when irrigation is applied to a citrus plant.

A fourth option for delivering the disclosed composition to citrus is trunk feeding either by injection or by external application. The delivery efficiency by the injection method is near 100% as the entire volume is forced into the vascular system of the tree. The external application method has shown viability and presence of the composition into the vascular system of the tree without quantification.

Another embodiment provides plant fertilizers comprising compositions as disclosed herein or comprising one or more active ingredients as disclosed herein in Tables 1 and/or 2 or stereoisomers, tautomers and/or agrochemically acceptable salts thereof. As a non-limiting example, combinations of active ingredients from Table 2 include the following sets of combinations (where a=Vanillic acid; b=Syringic acid; c=P-Coumaric acid; d=Silicic acid; e=Cinnamic acid; f=Ferulic acid; g=Fisetin; h=Oxybenzone; i=Orbifloxacin; and j=Rosiglitazone maleate):

2 combination sets: a, b; a, c; a, d; a, e; a, f; a, g; a, h; a, i; a, j; b, c; b, d, b, e; b, f; b, g; b, h; b, i; b, j; c, d; c, e; c, f; c, g; c, h; c, i; c, j; d, e; d, f, d, g; d, h; d, i; d, j; e, f, e, g; e, h; e, i; e, j; f, g; f, h; f, i; f, j; g, h; g, i; g, j; h, i; h, j; or i, j;

3 combination sets: a, b, c; a, b, d; a, b, e; a, b, f; a, b, g; a, b, h; a, b, i; a, b, j; a, c, d; a, c, e; a, c, f, a, c, g; a, c, h; a, c, i; a, c, j; a, d, e; a, d, f; a, d, g; a, d, h; a, d, i; a, d, j; a, e, f; a, e, g; a, e, h; a, e, i; a, e, j; a, f, g; a, f, h; a, f, i; a, f, j; a, g, h; a, g, i; a, g, j; a, h, i; a, h, j; a, i, j; b, c, d; b, c, e; b, c, f, b, c, g; b, c, h; b, c, i; b, c, j; b, d, e; b, d, f, b, d, g; b, d, h; b, d, i; b, d, j; b, e, f, b, e, g; b, e, h; b, e, i; b, e, j; b, f, g; b, f, h; b, f, i; b, f, j; b, g, h; b, g, i; b, g, j; b, h, i; b, h, j; b, i, j; c, d, e; c, d, f; c, d, g; c, d, h; c, d, i; c, d, j; c, e, f; c, e, g; c, e, h; c, e, i; c, e, j; c, f, g; c, f, h; c, f, i; c, f, j; c, g, h; c, g, i; c, g, j; c, h, i; c, h, j; c, i, j; d, e, f; d, e, g; d, e, h; d, e, i; d, e, j; d, f, g; d, f, h; d, f, i; d, f, j; d, g, h; d, g, i; d, g, j; d, h, i; d, h, j; d, i, j; e, f, g; e, f, h; e, f, i; e, f, j; e, g, h; e, g, i; e, g, j; e, h, i; e, h, j; e, i, j; f, g, h; f, g, i; f, g, j; f, h, i; f, h, j; f, i, j; g, h, i; g, h, j; g, i, j; or h, i, j;

4 combination sets: a, b, c, d; a, b, c, e; a, b, c, f; a, b, c, g; a, b, c, h; a, b, c, i; a, b, c, j; a, b, d, e; a, b, d, f; a, b, d, g; a, b, d, h; a, b, d, i; a, b, d, j; a, b, e, f, a, b, e, g; a, b, e, h; a, b, e, i; a, b, e, j; a, b, f, g; a, b, f, h; a, b, f, i; a, b, f, j; a, b, g, h; a, b, g, i; a, b, g, j; a, b, h, i; a, b, h, j; a, b, i, j; a, c, d, e; a, c, d, f; a, c, d, g; a, c, d, h; a, c, d, i; a, c, d, j; a, c, e, f; a, c, e, g; a, c, e, h; a, c, e, i; a, c, e, j; a, c, f, g; a, c, f, h; a, c, f, i; a, c, f, j; a, c, g, h; a, c, g, i; a, c, g, j; a, c, h, i; a, c, h, j; a, c, i, j; a, d, e, f; a, d, e, g; a, d, e, h; a, d, e, i; a, d, e, j; a, d, f, g; a, d, f, h; a, d, f, i; a, d, f, j; a, d, g, h; a, d, g, i; a, d, g, j; a, d, h, i; a, d, h, j; a, d, i, j; a, e, f, g; a, e, f, h; a, e, f, i; a, e, f, j; a, e, g, h; a, e, g, i; a, e, g, j; a, e, h, i; a, e, h, j; a, e, i, j; a, f, g, h; a, f, g, i; a, f, g, j; a, f, h, i; a, f, h, j; a, f, i, j; a, g, h, i; a, g, h, j; a, g, i, j; a, h, i, j; b, c, d, e; b, c, d, f; b, c, d, g; b, c, d, h; b, c, d, i; b, c, d, j; b, c, e, f; b, c, e, g; b, c, e, h; b, c, e, i; b, c, e, j; b, c, f, g; b, c, f, h; b, c, f, i; b, c, f, j; b, c, g, h; b, c, g, i; b, c, g, j; b, c, h, i; b, c, h, j; b, c, i, j; b, d, e, f; b, d, e, g; b, d, e, h; b, d, e, i; b, d, e, j; b, d, f, g; b, d, f, h; b, d, f, i; b, d, f, j; b, d, g, h; b, d, g, i; b, d, g, j; b, d, h, i; b, d, h, j; b, d, i, j; b, e, f, g; b, e, f, h; b, e, f, i; b, e, f, j; b, e, g, h; b, e, g, i; b, e, g, j; b, e, h, i; b, e, h, j; b, e, i, j; b, f, g, h; b, f, g, i; b, f, g, j; b, f, h, i; b, f, h, j; b, f, i, j; b, g, h, i; b, g, h, j; b, g, i, j; b, h, i, j; c, d, e, f; c, d, e, g; c, d, e, h; c, d, e, i; c, d, e, j; c, d, f, g; c, d, f, h; c, d, f, i; c, d, f, j; c, d, g, h; c, d, g, i; c, d, g, j; c, d, h, i; c, d, h, j; c, d, i, j; c, e, f, g; c, e, f, h; c, e, f, i; c, e, f, j; c, e, g, h; c, e, g, i; c, e, g, j; c, e, h, i; c, e, h, j; c, e, i, j; c, f, g, h; c, f, g, i; c, f, g, j; c, f, h, i; c, f, h, j; c, f, i, j; c, g, h, i; c, g, h, j; c, g, i, j; c, h, i, j; d, e, f, g; d, e, f, h; d, e, f, i; d, e, f, j; d, e, g, h; d, e, g, i; d, e, g, j; d, e, h, i; d, e, h, j; d, e, i, j; d, f, g, h; d, f, g, i; d, f, g, j; d, f, h, i; d, f, h, j; d, f, i, j; d, g, h, i; d, g, h, j; d, g, i, j; d, h, i, j; e, f, g, h; e, f, g, i; e, f, g, j; e, f, h, i; e, f, h, j; e, f, i, j; e, g, h, i; e, g, h, j; e, g, i, j; e, h, i, j; f, g, h, i; f, g, h, j; f, g, i, j; f, h, i, j; or g, h, i, j;

5 combination sets: a, b, c, d, e; a, b, c, d, f; a, b, c, d, g; a, b, c, d, h; a, b, c, d, i; a, b, c, d, j; a, b, c, e, f; a, b, c, e, g; a, b, c, e, h; a, b, c, e, i; a, b, c, e, j; a, b, c, f, g; a, b, c, f, h; a, b, c, f, i; a, b, c, f, j; a, b, c, g, h; a, b, c, g, i; a, b, c, g, j; a, b, c, h, i; a, b, c, h, j; a, b, c, i, j; a, b, d, e, f; a, b, d, e, g; a, b, d, e, h; a, b, d, e, i; a, b, d, e, j; a, b, d, f, g; a, b, d, f, h; a, b, d, f, i; a, b, d, f, j; a, b, d, g, h; a, b, d, g, i; a, b, d, g, j; a, b, d, h, i; a, b, d, h, j; a, b, d, i, j; a, b, e, f, g; a, b, e, f, h; a, b, e, f, i; a, b, e, f, j; a, b, e, g, h; a, b, e, g, i; a, b, e, g, j; a, b, e, h, i; a, b, e, h, j; a, b, e, i, j; a, b, f, g, h; a, b, f, g, i; a, b, f, g, j; a, b, f, h, i; a, b, f, h, j; a, b, f, i, j; a, b, g, h, i; a, b, g, h, j; a, b, g, i, j; a, b, h, i, j; a, c, d, e, f; a, c, d, e, g; a, c, d, e, h; a, c, d, e, i; a, c, d, e, j; a, c, d, f, g; a, c, d, f, h; a, c, d, f, i; a, c, d, f, j; a, c, d, g, h; a, c, d, g, i; a, c, d, g, j; a, c, d, h, i; a, c, d, h, j; a, c, d, i, j; a, c, e, f, g; a, c, e, f, h; a, c, e, f, i; a, c, e, f, j; a, c, e, g, h; a, c, e, g, i; a, c, e, g, j; a, c, e, h, i; a, c, e, h, j; a, c, e, i, j; a, c, f, g, h; a, c, f, g, i; a, c, f, g, j; a, c, f, h, i; a, c, f, h, j; a, c, f, i, j; a, c, g, h, i; a, c, g, h, j; a, c, g, i, j; a, c, h, i, j; a, d, e, f, g; a, d, e, f, h; a, d, e, f, i; a, d, e, f, j; a, d, e, g, h; a, d, e, g, i; a, d, e, g, j; a, d, e, h, i; a, d, e, h, j; a, d, e, i, j; a, d, f, g, h; a, d, f, g, i; a, d, f, g, j; a, d, f, h, i; a, d, f, h, j; a, d, f, i, j; a, d, g, h, i; a, d, g, h, j; a, d, g, i, j; a, d, h, i, j; a, e, f, g, h; a, e, f, g, i; a, e, f, g, j; a, e, f, h, i; a, e, f, h, j; a, e, f, i, j; a, e, g, h, i; a, e, g, h, j; a, e, g, i, j; a, e, h, i, j; a, f, g, h, i; a, f, g, h, j; a, f, g, i, j; a, f, h, i, j; a, g, h, i, j; b, c, d, e, f; b, c, d, e, g; b, c, d, e, h; b, c, d, e, i; b, c, d, e, j; b, c, d, f, g; b, c, d, f, h; b, c, d, f, i; b, c, d, f, j; b, c, d, g, h; b, c, d, g, i; b, c, d, g, j; b, c, d, h, i; b, c, d, h, j; b, c, d, i, j; b, c, e, f, g; b, c, e, f, h; b, c, e, f, i; b, c, e, f, j; b, c, e, g, h; b, c, e, g, i; b, c, e, g, j; b, c, e, h, i; b, c, e, h, j; b, c, e, i, j; b, c, f, g, h; b, c, f, g, i; b, c, f, g, j; b, c, f, h, i; b, c, f, h, j; b, c, f, i, j; b, c, g, h, i; b, c, g, h, j; b, c, g, i, j; b, c, h, i, j; b, d, e, f, g; b, d, e, f, h; b, d, e, f, i; b, d, e, f, j; b, d, e, g, h; b, d, e, g, i; b, d, e, g, j; b, d, e, h, i; b, d, e, h, j; b, d, e, i, j; b, d, f, g, h; b, d, f, g, i; b, d, f, g, j; b, d, f, h, i; b, d, f, h, j; b, d, f, i, j; b, d, g, h, i; b, d, g, h, j; b, d, g, i, j; b, d, h, i, j; b, e, f, g, h; b, e, f, g, i; b, e, f, g, j; b, e, f, h, i; b, e, f, h, j; b, e, f, i, j; b, e, g, h, i; b, e, g, h, j; b, e, g, i, j; b, e, h, i, j; b, f, g, h, i; b, f, g, h, j; b, f, g, i, j; b, f, h, i, j; b, g, h, i, j; c, d, e, f, g; c, d, e, f, h; c, d, e, f, i; c, d, e, f, j; c, d, e, g, h; c, d, e, g, i; c, d, e, g, j; c, d, e, h, i; c, d, e, h, j; c, d, e, i, j; c, d, f, g, h; c, d, f, g, i; c, d, f, g, j; c, d, f, h, i; c, d, f, h, j; c, d, f, i, j; c, d, g, h, i; c, d, g, h, j; c, d, g, i, j; c, d, h, i, j; c, e, f, g, h; c, e, f, g, i; c, e, f, g, j; c, e, f, h, i; c, e, f, h, j; c, e, f, i, j; c, e, g, h, i; c, e, g, h, j; c, e, g, i, j; c, e, h, i, j; c, f, g, h, i; c, f, g, h, j; c, f, g, i, j; c, f, h, i, j; c, g, h, i, j; d, e, f, g, h; d, e, f, g, i; d, e, f, g, j; d, e, f, h, i; d, e, f, h, j; d, e, f, i, j; d, e, g, h, i; d, e, g, h, j; d, e, g, i, j; d, e, h, i, j; d, f, g, h, i; d, f, g, h, j; d, f, g, i, j; d, f, h, i, j; d, g, h, i, j; e, f, g, h, i; e, f, g, h, j; e, f, g, i, j; e, f, h, i, j; e, g, h, i, j; or f, g, h, i, j;

6 combination sets: a, b, c, d, e, f; a, b, c, d, e, g; a, b, c, d, e, h; a, b, c, d, e, i; a, b, c, d, e, j; a, b, c, d, f, g; a, b, c, d, f, h; a, b, c, d, f, i; a, b, c, d, f, j; a, b, c, d, g, h; a, b, c, d, g, i; a, b, c, d, g, j; a, b, c, d, h, i; a, b, c, d, h, j; a, b, c, d, i, j; a, b, c, e, f, g; a, b, c, e, f, h; a, b, c, e, f, i; a, b, c, e, f, j; a, b, c, e, g, h; a, b, c, e, g, i; a, b, c, e, g, j; a, b, c, e, h, i; a, b, c, e, h, j; a, b, c, e, i, j; a, b, c, f, g, h; a, b, c, f, g, i; a, b, c, f, g, j; a, b, c, f, h, i; a, b, c, f, h, j; a, b, c, f, i, j; a, b, c, g, h, i; a, b, c, g, h, j; a, b, c, g, i, j; a, b, c, h, i, j; a, b, d, e, f, g; a, b, d, e, f, h; a, b, d, e, f, i; a, b, d, e, f, j; a, b, d, e, g, h; a, b, d, e, g, i; a, b, d, e, g, j; a, b, d, e, h, i; a, b, d, e, h, j; a, b, d, e, i, j; a, b, d, f, g, h; a, b, d, f, g, i; a, b, d, f, g, j; a, b, d, f, h, i; a, b, d, f, h, j; a, b, d, f, i, j; a, b, d, g, h, i; a, b, d, g, h, j; a, b, d, g, i, j; a, b, d, h, i, j; a, b, e, f, g, h; a, b, e, f, g, i; a, b, e, f, g, j; a, b, e, f, h, i; a, b, e, f, h, j; a, b, e, f, i, j; a, b, e, g, h, i; a, b, e, g, h, j; a, b, e, g, i, j; a, b, e, h, i, j; a, b, f, g, h, i; a, b, f, g, h, j; a, b, f, g, i, j; a, b, f, h, i, j; a, b, g, h, i, j; a, c, d, e, f, g; a, c, d, e, f, h; a, c, d, e, f, i; a, c, d, e, f, j; a, c, d, e, g, h; a, c, d, e, g, i; a, c, d, e, g, j; a, c, d, e, h, i; a, c, d, e, h, j; a, c, d, e, i, j; a, c, d, f, g, h; a, c, d, f, g, i; a, c, d, f, g, j; a, c, d, f, h, i; a, c, d, f, h, j; a, c, d, f, i, j; a, c, d, g, h, i; a, c, d, g, h, j; a, c, d, g, i, j; a, c, d, h, i, j; a, c, e, f, g, h; a, c, e, f, g, i; a, c, e, f, g, j; a, c, e, f, h, i; a, c, e, f, h, j; a, c, e, f, i, j; a, c, e, g, h, i; a, c, e, g, h, j; a, c, e, g, i, j; a, c, e, h, i, j; a, c, f, g, h, i; a, c, f, g, h, j; a, c, f, g, i, j; a, c, f, h, i, j; a, c, g, h, i, j; a, d, e, f, g, h; a, d, e, f, g, i; a, d, e, f, g, j; a, d, e, f, h, i; a, d, e, f, h, j; a, d, e, f, i, j; a, d, e, g, h, i; a, d, e, g, h, j; a, d, e, g, i, j; a, d, e, h, i, j; a, d, f, g, h, i; a, d, f, g, h, j; a, d, f, g, i, j; a, d, f, h, i, j; a, d, g, h, i, j; a, e, f, g, h, i; a, e, f, g, h, j; a, e, f, g, i, j; a, e, f, h, i, j; a, e, g, h, i, j; a, f, g, h, i, j; b, c, d, e, f, g; b, c, d, e, f, h; b, c, d, e, f, i; b, c, d, e, f, j; b, c, d, e, g, h; b, c, d, e, g, i; b, c, d, e, g, j; b, c, d, e, h, i; b, c, d, e, h, j; b, c, d, e, i, j; b, c, d, f, g, h; b, c, d, f, g, i; b, c, d, f, g, j; b, c, d, f, h, i; b, c, d, f, h, j; b, c, d, f, i, j; b, c, d, g, h, i; b, c, d, g, h, j; b, c, d, g, i, j; b, c, d, h, i, j; b, c, e, f, g, h; b, c, e, f, g, i; b, c, e, f, g, j; b, c, e, f, h, i; b, c, e, f, h, j; b, c, e, f, i, j; b, c, e, g, h, i; b, c, e, g, h, j; b, c, e, g, i, j; b, c, e, h, i, j; b, c, f, g, h, i; b, c, f, g, h, j; b, c, f, g, i, j; b, c, f, h, i, j; b, c, g, h, i, j; b, d, e, f, g, h; b, d, e, f, g, i; b, d, e, f, g, j; b, d, e, f, h, i; b, d, e, f, h, j; b, d, e, f, i, j; b, d, e, g, h, i; b, d, e, g, h, j; b, d, e, g, i, j; b, d, e, h, i, j; b, d, f, g, h, i; b, d, f, g, h, j; b, d, f, g, i, j; b, d, f, h, i, j; b, d, g, h, i, j; b, e, f, g, h, i; b, e, f, g, h, j; b, e, f, g, i, j; b, e, f, h, i, j; b, e, g, h, i, j; b, f, g, h, i, j; c, d, e, f, g, h; c, d, e, f, g, i; c, d, e, f, g, j; c, d, e, f, h, i; c, d, e, f, h, j; c, d, e, f, i, j; c, d, e, g, h, i; c, d, e, g, h, j; c, d, e, g, i, j; c, d, e, h, i, j; c, d, f, g, h, i; c, d, f, g, h, j; c, d, f, g, i, j; c, d, f, h, i, j; c, d, g, h, i, j; c, e, f, g, h, i; c, e, f, g, h, j; c, e, f, g, i, j; c, e, f, h, i, j; c, e, g, h, i, j; c, f, g, h, i, j; d, e, f, g, h, i; d, e, f, g, h, j; d, e, f, g, i, j; d, e, f, h, i, j; d, e, g, h, i, j; d, f, g, h, i, j; or e, f, g, h, i, j;

7 combination sets: a, b, c, d, e, f, g; a, b, c, d, e, f, h; a, b, c, d, e, f, i; a, b, c, d, e, f, j; a, b, c, d, e, g, h; a, b, c, d, e, g, i; a, b, c, d, e, g, j; a, b, c, d, e, h, i; a, b, c, d, e, h, j; a, b, c, d, e, i, j; a, b, c, d, f, g, h; a, b, c, d, f, g, i; a, b, c, d, f, g, j; a, b, c, d, f, h, i; a, b, c, d, f, h, j; a, b, c, d, f, i, j; a, b, c, d, g, h, i; a, b, c, d, g, h, j; a, b, c, d, g, i, j; a, b, c, d, h, i, j; a, b, c, e, f, g, h; a, b, c, e, f, g, i; a, b, c, e, f, g, j; a, b, c, e, f, h, i; a, b, c, e, f, h, j; a, b, c, e, f, i, j; a, b, c, e, g, h, i; a, b, c, e, g, h, j; a, b, c, e, g, i, j; a, b, c, e, h, i, j; a, b, c, f, g, h, i; a, b, c, f, g, h, j; a, b, c, f, g, i, j; a, b, c, f, h, i, j; a, b, c, g, h, i, j; a, b, d, e, f, g, h; a, b, d, e, f, g, i; a, b, d, e, f, g, j; a, b, d, e, f, h, i; a, b, d, e, f, h, j; a, b, d, e, f, i, j; a, b, d, e, g, h, i; a, b, d, e, g, h, j; a, b, d, e, g, i, j; a, b, d, e, h, i, j; a, b, d, f, g, h, i; a, b, d, f, g, h, j; a, b, d, f, g, i, j; a, b, d, f, h, i, j; a, b, d, g, h, i, j; a, b, e, f, g, h, i; a, b, e, f, g, h, j; a, b, e, f, g, i, j; a, b, e, f, h, i, j; a, b, e, g, h, i, j; a, b, f, g, h, i, j; a, c, d, e, f, g, h; a, c, d, e, f, g, i; a, c, d, e, f, g, j; a, c, d, e, f, h, i; a, c, d, e, f, h, j; a, c, d, e, f, i, j; a, c, d, e, g, h, i; a, c, d, e, g, h, j; a, c, d, e, g, i, j; a, c, d, e, h, i, j; a, c, d, f, g, h, i; a, c, d, f, g, h, j; a, c, d, f, g, i, j; a, c, d, f, h, i, j; a, c, d, g, h, i, j; a, c, e, f, g, h, i; a, c, e, f, g, h, j; a, c, e, f, g, i, j; a, c, e, f, h, i, j; a, c, e, g, h, i, j; a, c, f, g, h, i, j; a, d, e, f, g, h, i; a, d, e, f, g, h, j; a, d, e, f, g, i, j; a, d, e, f, h, i, j; a, d, e, g, h, i, j; a, d, f, g, h, i, j; a, e, f, g, h, i, j; b, c, d, e, f, g, h; b, c, d, e, f, g, i; b, c, d, e, f, g, j; b, c, d, e, f, h, i; b, c, d, e, f, h, j; b, c, d, e, f, i, j; b, c, d, e, g, h, i; b, c, d, e, g, h, j; b, c, d, e, g, i, j; b, c, d, e, h, i, j; b, c, d, f, g, h, i; b, c, d, f, g, h, j; b, c, d, f, g, i, j; b, c, d, f, h, i, j; b, c, d, g, h, i, j; b, c, e, f, g, h, i; b, c, e, f, g, h, j; b, c, e, f, g, i, j; b, c, e, f, h, i, j; b, c, e, g, h, i, j; b, c, f, g, h, i, j; b, d, e, f, g, h, i; b, d, e, f, g, h, j; b, d, e, f, g, i, j; b, d, e, f, h, i, j; b, d, e, g, h, i, j; b, d, f, g, h, i, j; b, e, f, g, h, i, j; c, d, e, f, g, h, i; c, d, e, f, g, h, j; c, d, e, f, g, i, j; c, d, e, f, h, i, j; c, d, e, g, h, i, j; c, d, f, g, h, i, j; c, e, f, g, h, i, j; or d, e, f, g, h, i, j;

8 combination sets: a, b, c, d, e, f, g, h; a, b, c, d, e, f, g, i; a, b, c, d, e, f, g, j; a, b, c, d, e, f, h, i; a, b, c, d, e, f, h, j; a, b, c, d, e, f, i, j; a, b, c, d, e, g, h, i; a, b, c, d, e, g, h, j; a, b, c, d, e, g, i, j; a, b, c, d, e, h, i, j; a, b, c, d, f, g, h, i; a, b, c, d, f, g, h, j; a, b, c, d, f, g, i, j; a, b, c, d, f, h, i, j; a, b, c, d, g, h, i, j; a, b, c, e, f, g, h, i; a, b, c, e, f, g, h, j; a, b, c, e, f, g, i, j; a, b, c, e, f, h, i, j; a, b, c, e, g, h, i, j; a, b, c, f, g, h, i, j; a, b, d, e, f, g, h, i; a, b, d, e, f, g, h, j; a, b, d, e, f, g, i, j; a, b, d, e, f, h, i, j; a, b, d, e, g, h, i, j; a, b, d, f, g, h, i, j; a, b, e, f, g, h, i, j; a, c, d, e, f, g, h, i; a, c, d, e, f, g, h, j; a, c, d, e, f, g, i, j; a, c, d, e, f, h, i, j; a, c, d, e, g, h, i, j; a, c, d, f, g, h, i, j; a, c, e, f, g, h, i, j; a, d, e, f, g, h, i, j; b, c, d, e, f, g, h, i; b, c, d, e, f, g, h, j; b, c, d, e, f, g, i, j; b, c, d, e, f, h, i, j; b, c, d, e, g, h, i, j; b, c, d, f, g, h, i, j; b, c, e, f, g, h, i, j; b, d, e, f, g, h, i, j; or c, d, e, f, g, h, i, j;

9 combination sets: a, b, c, d, e, f, g, h, i; a, b, c, d, e, f, g, h, j; a, b, c, d, e, f, g, i, j; a, b, c, d, e, f, h, i, j; a, b, c, d, e, g, h, i, j; a, b, c, d, f, g, h, i, j; a, b, c, e, f, g, h, i, j; a, b, d, e, f, g, h, i, j; a, c, d, e, f, g, h, i, j; or b, c, d, e, f, g, h, i, j; or

10 combination set: a, b, c, d, e, f, g, h, i, j.

In certain embodiments, the combination of active agents that are added to a fertilizer comprises syringic acid, p-coumaric acid, vanillic acid, and cinnamic acid.

The fertilizers include a wide variety of fertilizer granules, particles or pellets (which are referred to collectively herein as fertilizer granules) such as organic and inorganic nitrogen-containing compounds comprising urea, urea-formaldehyde condensation products, amino acids, ammonium salts and nitrates, potassium salts (preferably chlorides, sulfates, nitrates) and phosphoric acid and/or salts of phosphoric acid. Also, it should be noted that the fertilizer granules suitable for inclusion in the present mixtures may also contain micronutrients, such as iron, manganese, magnesium, boron, copper, zinc and the like.

The physical forms of the fertilizers to be employed in combination with disclosed compositions or one or more active ingredients to produce the disclosed plant fertilizers include granules and extruded particles. The chemical analysis for the fertilizer component to be included in the present compositions, when present, should range from about 1 to about 40% by weight elemental nitrogen (N) (for example, about 15-36% by weight); about 1 to about 30% by weight phosphorous (for example, about 1-27% by weight); and about 1 to about 20% by weight potassium (for example, about 3-15% by weight). The micronutrient content of the fertilizer ingredient, preferably, should range from about 1 to about 20,000 ppm (parts per million). The quantity of the disclosed compositions to be incorporated in combination with the fertilizer component should range from about 0.001% to about 5% by weight of the total composition.

In an alternative embodiment of the present invention, inert solid carriers may be admixed with one or more active ingredient as disclosed herein and added to fertilizers. Suitable inert solid carrier materials for use herein include any of a variety of organic and/or inorganic materials, which absorb or which may be coated with the compositions or one or more active ingredient as disclosed herein and that have been appropriately ground/fractionated/sized. Suitable organic materials include cellulose, corncobs, peanut hulls, processed paper pulp, sawdust and the like whereas suitable inorganic materials include limestone, gypsum, sand, vermiculite, perlite, fuller's earth and clays such as attapulgite clays, bentonite clays, montmorillonite clays. The quantity of the disclosed compositions or active ingredients to be incorporated in combination with an inert carrier material to prepare the compositions of the present invention should range from about 1% to about 10% by weight of the total composition.

As would be clear from the disclosure above, a single active ingredient or various combinations of active ingredients can be combined with the inert solid carriers disclosed herein. Where single active ingredients are combined with a single population of inert solid carriers, any number of inert solid carrier populations can be combined to provide a combination of active ingredients in a fertilizers. For example four different populations of inert solid carriers can be combined such that a first population comprising a first active ingredient, a second population comprising a second active ingredient, a third population comprising a third active ingredient and a fourth population comprising a fourth active ingredient can be combined and added to a fertilizer.

Fertilizers and inert carriers comprising the disclosed compositions or one or more active ingredient may be produced employing any of a variety of processes. For example, one or more active ingredient or formulations (e.g., commercial formulations or application formulations) comprising one or more of the active ingredients can be applied to a fertilizer/inert granule using one or more of the following techniques: (a) as a spray mixture with solvents and/or surfactants; or (b) adhered to the outer surface of the fertilizer/inert granule with an adhesive/sticking agent; or (c) incorporated into a mixture of dry ingredients and a liquid, and then extruded or molded into discrete particles; or (d) impregnated into a porous granule.

Specifically, fertilizer compositions may be prepared by mixing active ingredients disclosed herein with a granular fertilizer in effective amounts (for example, in a rotating drum container) and mixing the ingredients for a sufficient period of time until the active ingredients are coated on and absorbed in the fertilizer granules. As would be apparent, other methods may be employed for producing compositions of the present invention containing the disclosed compositions or one or more active ingredient as disclosed herein. These include, and are not limited to:

dissolving a commercial formulation or application formulation comprising one or more active ingredient in a liquid solvent/surfactant blend, then spraying this mixture on a fertilizer and/or inert carrier material so the solution is absorbed on the substrate particles; or

using a formulation (e.g., a commercial formulation or an application formulation) as disclosed herein or one or more active ingredient in a dry powder state, tacking this onto the surface of a fertilizer and/or inert carrier material using a liquid sticking agent or adhesive to distribute the composition or the one or more active ingredient onto the substrate particles. The fertilizer compositions to which formulations according to the invention have been added can be applied at various rates to citrus plants as a granular fertilizer in order to control citrus greening.

### Example

Various compounds disclosed in Tables 1 and 2 were tested singularly and in various combinations, for example two compound combinations, three compound combinations, etc. Approximately 81 combinations of compounds reviewed at three different application rates for positive effects on trees exhibiting symptoms of citrus greening. All formula combinations were applied to diseased trees in four 4 biweekly treatments. Each treatment had three replicates and three different application rates. Each formulation or combination was evaluated at the end of 8 weeks of applications followed by a response period of 2 weeks. Diseased trees exhibited visible improvement with respect to disease (defined as new vigorous growth, growth without symptoms, thickness of foliage, no visible minor element deficiencies, and/or single uniform crop set) when treated with combinations of two, three, four and more active agents. Treated citrus trees exhibited new growth without symptoms of citrus greening within about 8 weeks after the start of treatment. An increase in the amount and density of foliage was observed over the next four months. In about the first 8 months to year after treatment, the citrus trees presented a renewed appearance of health and established a uniform crop set. As the trees continued to progress through this period, the rate of infection decreased to non-impactful levels. Combinations of four active agents provided especially consistent results with respect to tree recovery from citrus greening. Trees treated with formulations that contained only one compound did not demonstrate significant improvement in tree health.

All trials were arranged in randomized complete blocks, designed with three (3) replicates per treatment and each trial was repeated twice. Seventy two (72) trees were randomly chosen in block 4 of the trial. The trees in the trial were randomly chosen none were in consecutive order or uniformly placed within the grove.

The Citrus trees in block 4 treated were: Hamlin on Swingle citrumelo rootstock and Hamlin on Carizzo citrange rootstock. The ages of the trees ranged between 6 to 31 years old. The block received eight (8) treatments occurring every two weeks in the Fall/Winter weather beginning October and finishing in January. The applications were made in the morning hours between 7:00 am and 10:00 am on the same day of each treatment week. The soils found in block 4 were Arents-MUS #17, Wauchula sand-MUS #49 and Tavares sand-MUS #45.

The Grapefruit trees in block 4 were treated as the Citrus trees were following the same protocols except application frequency. The Grapefruit block received eight (8) treatments occurring every week due to the severity of the tree decline. The applications were made in the morning hours between 7:00 am and 10:00 am on the same day of each week. The applications were made in the summer months and continued with 4 additional treatments applied every two weeks. The Red Ruby Grapefruit trees are on Swingle citrumelo rootstock with an average age of 8 years. The soils found were Grapefruit on Candler Sand-MUS #8.

The trial with the Hamlin Citrus and the Red Ruby Grapefruit Citrus indicated combinations of compounds out of Table 2 and a range of application rates that were successful in reducing the degree of infection of HLB indicated by PCR validation and by field observations of increased fruit set, new growth, fruit taste, root health, and overall vitality of the tree. The combination of syringic acid, p-coumaric acid, vanillic acid, and cinnamic acid provided consistent improvement in citrus tree health. The trial also revealed the management of leaf minor, rust mites, and psyllids shown only on and by the treated trees.

The real time PCR amplification done in triplicate for the actual quantification of RNR gene against the internal control gene COX. The values showed a significant trend in the reduction of the HLB presence.

TABLE 1
Active Agents

| | | Mol. | | |
|---|---|---|---|---|
| Molecular structure | Name | weight | Mol. formula | CAS # |
| 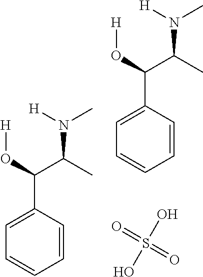 | (−)-Ephedrine hemisulfate | 428.54 | (C₁₀H₁₅NO)₂ · H₂SO₄ | 134-72-5 |
| 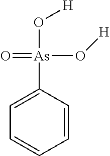 | [4-(4- arsonobenzyl)phenyl]arsonic acid | 202.04 | C6H7AsO3 | 98-05-5 |
| 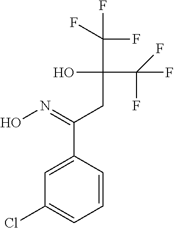 [SMILES: O/N=C(/CC(O)(C(F)(F)F)C(F)(F)F)c1cccc(Cl)c1] | 1-Butanone, 1-(3-chlorophenyl)- 4,4,4-trifluoro-3-hydroxy-3- (trifluoromethyl)-, oxime | 335.63 | ClF₆NO₂ | |
| 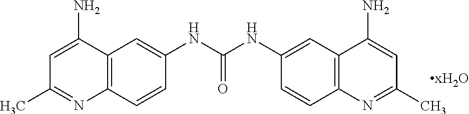 | 1,3-bis(4-amino-2-methyl-6- quinolyl)urea | 372.42 | C₂₁H₂₀N₆O · xH₂O | 5424-37-3 |
| 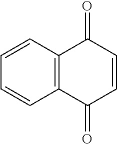 [SMILES: O=C1C=CC(=O)c2ccccc21] | 1,4-NAPHTHOQUINONE | 158.15 | C₁₀H₆O₂ | 130-15-4 |
| 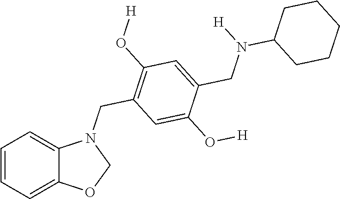 [SMILES: Oc1cc(CN2COc3ccccc32)c(O)cc1CNC1CCCCC1] | 2-(1,3-benzoxazol-3(2H)- ylmethyl)-5- ((cyclohexylamino)methyl)-1,4- benzenediol | 354.4 | C21H26N2O3 | |
| | 2-[2-(carboxylatomethyl- | 490.82 | C10H14HgN2O8 | |
| | (carboxymethyl)amino)ethyl- | | | |
| | (carboxymethyl)amino]acetate; | | | |
| | mercury(+2) cation | | | |
| 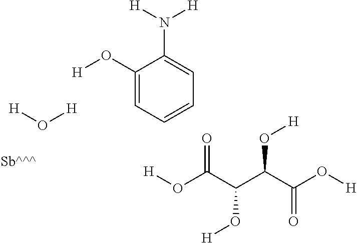 | 2-aminophenol; antimony; (2S,3R)-2,3- dihydroxybutanedioic acid; hydrate | 398.99 | C10H15NO8Sb | |
| 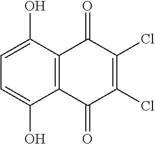 [SMILES: O=C1C(Cl)=C(Cl)C(=O)c2c(O)ccc(O)c21] | 2,3-DICHLORO-5,8- DIHYDROXYNAPTHO- QUINONE | 259.04 | C₁₀H₄Cl₂O₄ | 14918-69-5 |
| 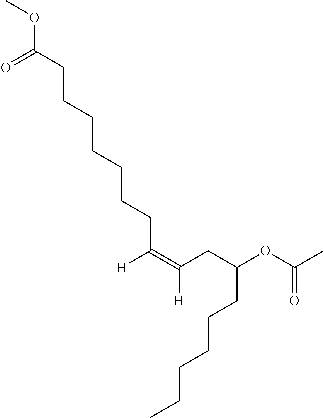 [SMILES: CCCCCCC(C/C=C\CCCCCCCC(=O)OC)OC(C)=O] | 21-O- Acetylstreptovaricinoic acid methyl ester | 354.5 | C21H38O4 | 4648-28-6 |
| 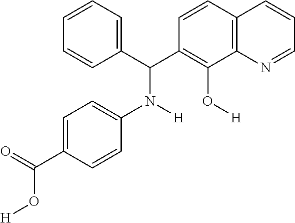 [SMILES: O=C(O)c1ccc(NC(c2ccccc2)c2ccc3cccnc3c2O)cc1] | 4-(((8-hydroxy-7- quinolinyl)(phenyl)methyl) amino)benzoic acid | 370.4 | C23H18N2O3 | 5335-97-7 |
| 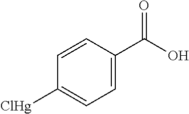 | 4-Chloromercuribenzoic acid | 357.16 | ClHgC₆H₄CO₂H | 59-85-8 |
| 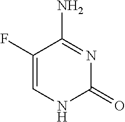 | 5-FLUOROCYTOSINE | 129.09 | C₄H₄FN₃O | 217-968-7 |
| 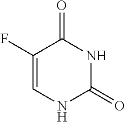 | 5-Fluorouracil (2; inactive LdtR LOPAC) | 130.08 | C₄H₃FN₂O₂ | 51-21-8 |
| 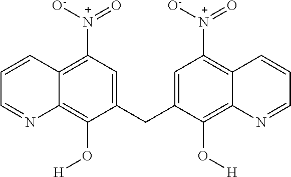 [SMILES: O=[N+]([O-])c1cc(Cc2cc([N+](=O)[O-])c3cccnc3c2O)c(O)c2ncccc12] | 7-[(8-hydroxy-5-nitro-7- quinolyl)methyl]-5-nitro- quinolin-8-ol | 392.3 | C19H12N4O6 | 76289-30-0 |
| 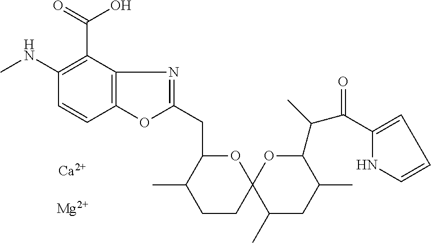 [SMILES: CNc1ccc2oc(CC3OC4(CCC3C)OC(C(C)C(=O)c3ccc[nH]3)C(C)CC4C)nc2c1C(=O)O ; [Ca+2] ; [Mg+2]] | calcimycin | 523.62 | C₂₉H₃₇N₃O₆ | 52665-69-7 |
| 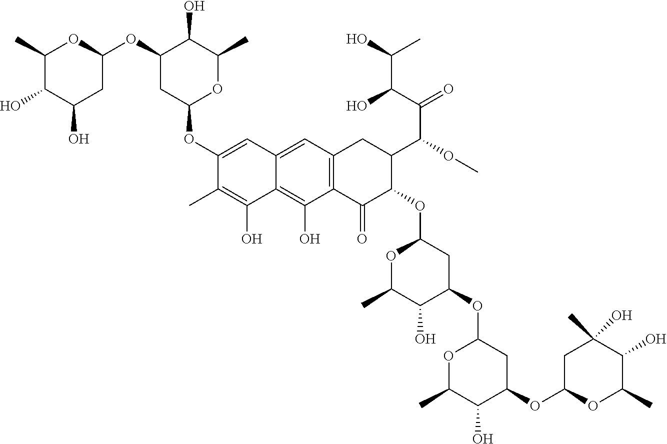 [SMILES: CO[C@@H](C(=O)[C@@H](O)[C@H](C)O)C1Cc2cc3cc(O[C@H]4C[C@@H](O[C@H]5C[C@@H](O)[C@H](O)[C@@H](C)O5)[C@@H](O)[C@@H](C)O4)c(C)c(O)c3c(O)c2C(=O)[C@H]1O[C@H]1C[C@@H](OC2C[C@@H](O[C@H]3C[C@](C)(O)[C@H](O)[C@@H](C)O3)[C@H](O)[C@@H](C)O2)[C@H](O)[C@@H](C)O1] | A Mithracin | 1085.15 | C₅₂H₇₆O₂₄ | 18378-89-7 |
| 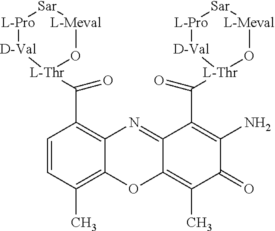 | actinomycin D (2) | 1255.42 | C₆₂H₈₆N₁₂O₁₆ | 50-76-0 |
| 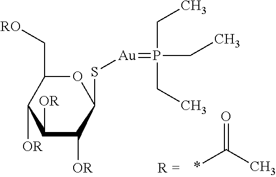 | Auranofin | 678.48 | C₂₀H₃₄AuO₉PS | 34031-32-8 |
| 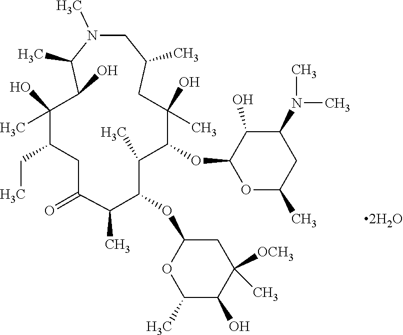 [SMILES: CC[C@H]1CC(=O)[C@H](C)[C@@H](O[C@H]2C[C@@](C)(OC)[C@@H](O)[C@H](C)O2)[C@H](C)[C@@H](O[C@@H]2O[C@H](C)C[C@H](N(C)C)[C@H]2O)[C@](C)(O)C[C@@H](C)CN(C)[C@H](C)[C@@H](O)[C@]1(C)O] | AZITHROMYCIN (2) | 785.02 | C₃₈H₇₂N₂O₁₂ · 2H₂O | 117772-70-0 |
| 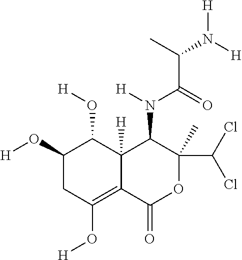 [SMILES: C[C@H](N)C(=O)N[C@@H]1[C@H]2C(=C(O)C[C@@H](O)[C@@H]2O)C(=O)O[C@]1(C)C(Cl)Cl] | Bactobolin Propanamide | 383.2 | C14H20Cl2N2O6 | 72615-20-4 |
| | Bay 11-7082 | | | |
| | Bay 11-7085 | | | |
| 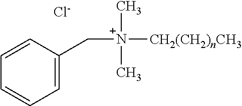 | BENZALKONIUM CHLORIDE | | C₆H₅CH₂N(CH₃)₂RCl (R = C₈H₁₇ to C₁₈H₃₇) | 63449-41-2 |
| 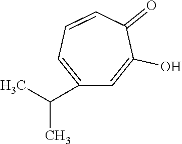 | beta-Thujaplicin | 164.2 | C₁₀H₁₂O₂ | 499-44-5 |
| 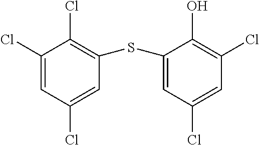 [SMILES: Oc1c(Cl)cc(Cl)cc1Sc1cc(Cl)cc(Cl)c1Cl] | BITHIONATE SODIUM | 354 | C12H4Cl4O2S-2 | |
| 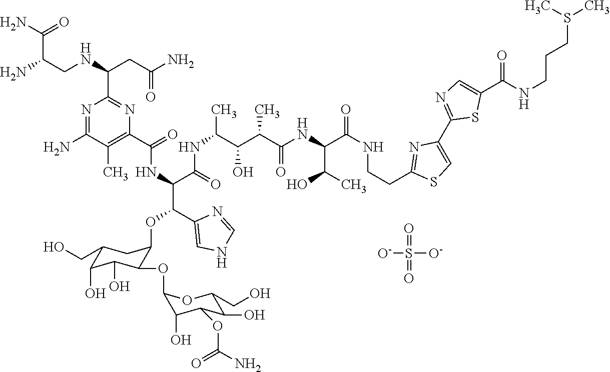 | BLEOMYCIN A5 - SULFATE | 1512.6 | C55H85N17O25S4 | 9041-93-4 |
| 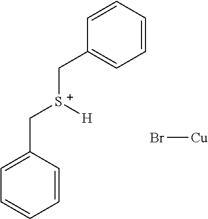 | bromocopper; (dipyridin-2- ylmethylideneamino)- (methylsulfanyl- sulfoniumylidene- methyl)azanide | 358.8 | C14H15BrCuS+ | |
| 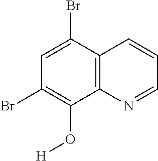 [SMILES: Oc1c(Br)cc(Br)c2cccnc12] | BROXYQUINOLINE | 302.95 | C9H5Br2NO | 521-74-4 |
| 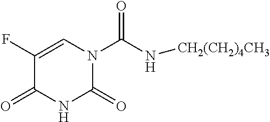 | CARMOFUR (3) | 257.26 | C₁₁H₁₆FN₃O₃ | 61422-45-5 |
| 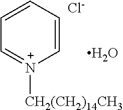 | CETYLPYRIDINIUM CHLORIDE | 358 | C₂₁H₃₈ClN · H₂O | 6004-24-6 |
| 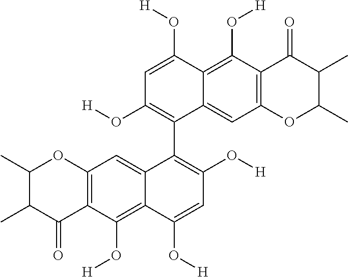 | Chaetochromin | 546.5 | C30H26O10 | 75514-37-3 |
| 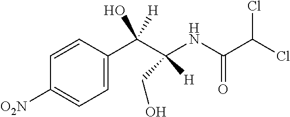 [SMILES: O=C(N[C@H](CO)[C@H](O)c1ccc([N+](=O)[O-])cc1)C(Cl)Cl] | CHLORAMPHENICOL (2) | 323.13 | Cl₂CHCONHCH(CH₂OH) CH(OH)C₆H₄NO₂ | 56-75-7 |
| 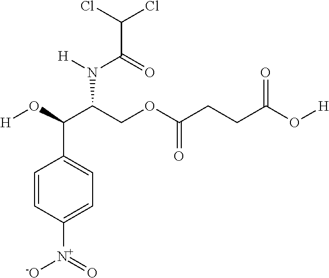 | CHLORAMPHENICOL HEMISUCCINATE | 423.2 | C15H16Cl2N2O8 | 3544-94-3 |
| 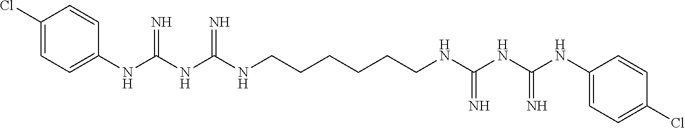 [SMILES: N=C(NCCCCCCNC(=N)NC(=N)Nc1ccc(Cl)cc1)NC(=N)Nc1ccc(Cl)cc1] | CHLORHEXIDINE | 505.45 | [—(CH₂)₃NHC(═NH)NHC (═NH)NHC₆H₄Cl]₂ | 55-56-1 |
| 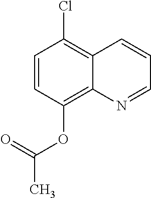 | CHLOROACETOXY- QUINOLINE | 221.63 | C₁₁H₈ClNO₂ | 10173-02-1 |
| 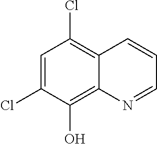 [SMILES: Oc1c(Cl)cc(Cl)c2cccnc12] | CHLOROXINE | 214.05 | C₉H₅Cl₂NO | 773-76-2 |
| 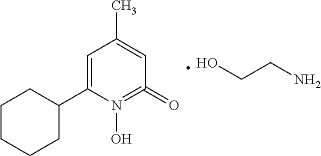 | CICLOPIROX OLAMINE | 268.35 | C₁₂H₁₇NO₂ · C₂H₇NO | 41621-49-2 |
| 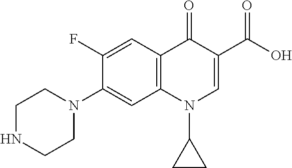 [SMILES: O=C(O)c1cn(C2CC2)c2cc(N3CCNCC3)c(F)cc2c1=O] | CIPROFLOXACIN | 331.34 | C₁₇H₁₈FN₃O₃ | 85721-33-1 |
| 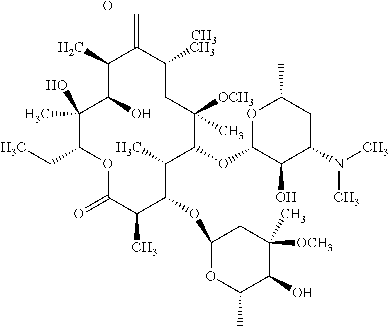 | CLARITHROMYCIN (2; inactive LdtR & RpoH NIHCC) | 747.95 | C₃₈H₆₉NO₁₃ | 81103-11-9 |
| 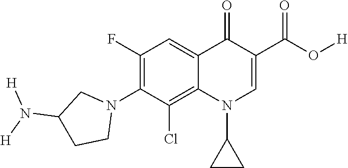 [SMILES: NC1CCN(c2c(F)cc3c(=O)c(C(=O)O)cn(C4CC4)c3c2Cl)C1] | Clinafloxacin | 365.8 | C17H17ClFN3O3 | 105956-97-6 |
| 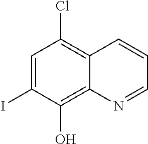 [SMILES: Oc1c(I)cc(Cl)c2cccnc12] | CLIOQUINOL | 305.5 | C₉H₅ClINO | 130-26-7 |
| 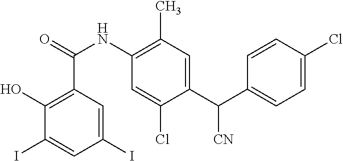 [SMILES: Cc1cc(C(C#N)c2ccc(Cl)cc2)c(Cl)cc1NC(=O)c1cc(I)cc(I)c1O] | Closantel | 663.07 | C₂₂H₁₄Cl₂I₂N₂O₂ | 57808-65-8 |
| 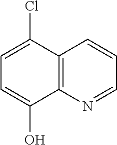 [SMILES: Oc1ccc(Cl)c2cccnc12] | CLOXYQUIN | 179.6 | C₉H₆ClNO | 130-16-5 |
| 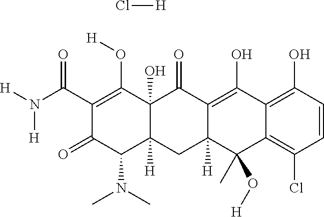 [SMILES: Cl ; CN(C)[C@@H]1C(=O)C(C(N)=O)=C(O)[C@@]2(O)C(=O)C3=C(O)c4c(O)ccc(Cl)c4[C@@](C)(O)[C@H]3C[C@@H]12] | CLTC U-6780 B-Aureo Tetra 5 Auxeomycin Clorocipan Isphamycin Aureocarmyl (2) | 515.3 | C22H24Cl2N2O8 | 64-72-2 |
| 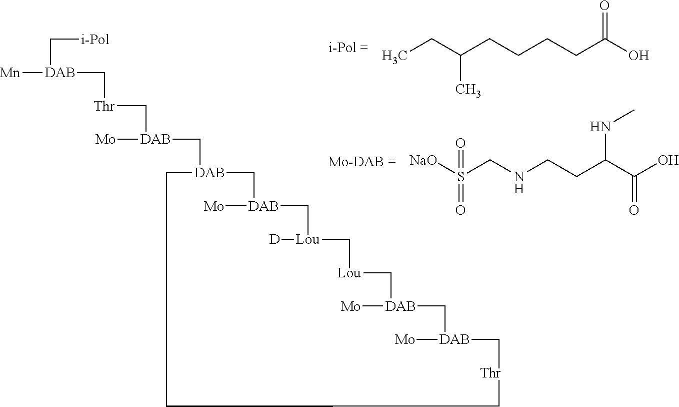 | COLISTIMETHATE SODIUM | 1759.9 | C58H115N16Na5O28S5 | 8068-28-8 |
| 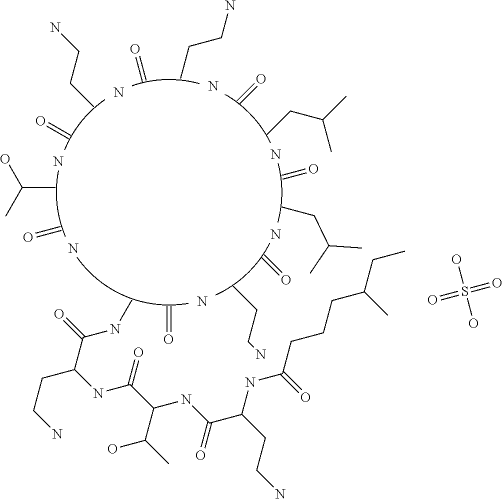 | COLISTIN SULFATE | 1267.5 | C53H102N16O17S | 1264-72-8 |
| 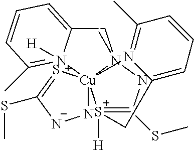 | copper; [(6-methylpyridin-2- yl)methylideneamino]- (methylsulfanyl- sulfoniumylidene- methyl)azanide | 514.2 | C18H22CuN6S4 | |
| 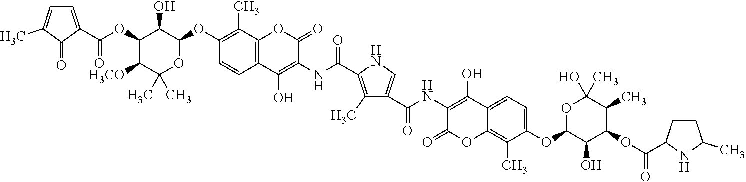 | Coumermycin A1 | 1110.08 | C₅₅H₅₉N₅O₂₀ | |
| 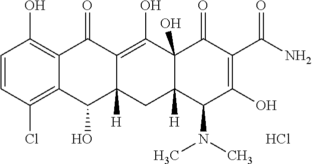 [SMILES: CN(C)[C@@H]1C(O)=C(C(N)=O)C(=O)[C@@]2(O)C(O)=C3C(=O)c4c(O)ccc(Cl)c4[C@@H](O)[C@H]3C[C@@H]12 ; Cl] | Demeclocycline hydrochloride (2) | 501.31 | C₂₁H₂₁ClN₂O₈ · HCl | 64-73-3 |
| 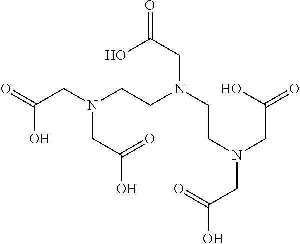 [SMILES: O=C(O)CN(CCN(CC(=O)O)CC(=O)O)CCN(CC(=O)O)CC(=O)O] | Diethylenetriaminepentaacetic acid (1; inactive LOPAC) | 393.35 | [(HOOCCH₂)₂NCH₂CH₂]₂N CH₂COOH | 67-43-6 |
| 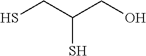 | DIMERCAPROL | 124.23 | HOCH₂CH(SH)CH₂SH | 59-52-9 |
| 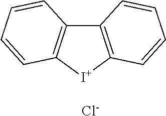 [SMILES: c1ccc2c(c1)[I+]c1ccccc1-2 ; [Cl-]] | Diphenyleneiodonium chloride (2) | 314.55 | C₁₂H₈ClI | 4673-26-1 |
| 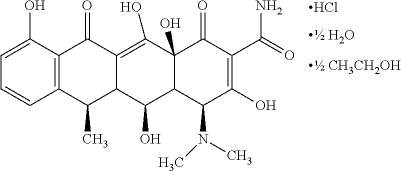 | Doxycycline hyclate | 512.94 | C₂₂H₂₄N₂O₈ · HCl · 0.5H₂O · 0.5C₂H₆O | 24390-14-5 |
| | Doxycycline hydrochloride (2) | 480.9 | C₂₂H₂₄N₂O₈ · HCl | 10592-13-9 |
| 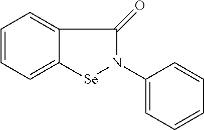 [SMILES: O=c1c2ccccc2[se]n1-c1ccccc1] | Ebselen (2; inactive LdtR & RpoH NIHCC) | 274.18 | C₁₃H₉NOSe | 60940-34-3 |
| 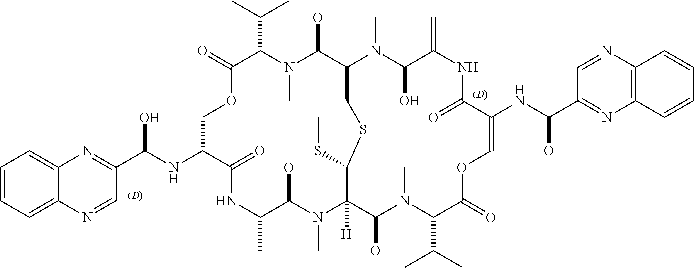 | Echinomycin | 1101.26 | C₅₁H₆₄N₁₂O₁₂S₂ | 512-64-1 |
| 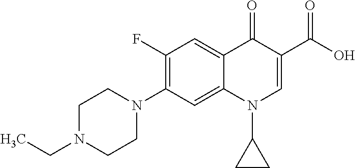 [SMILES: CCN1CCN(c2cc3c(cc2F)c(=O)c(C(=O)O)cn3C2CC2)CC1] | ENROFLOXACIN (3) | 359.39 | C₁₉H₂₂FN₃O₃ | 93106-60-6 |
| 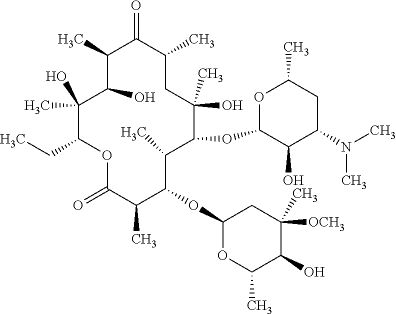 [SMILES: CC[C@H]1OC(=O)[C@H](C)[C@@H](O[C@H]2C[C@@](C)(OC)[C@@H](O)[C@H](C)O2)[C@H](C)[C@@H](O[C@@H]2O[C@H](C)C[C@H](N(C)C)[C@H]2O)[C@](C)(O)C[C@@H](C)C(=O)[C@H](C)[C@@H](O)[C@]1(C)O] | ERYTHROMYCIN | 733.93 | C₃₇H₆₇NO₁₃ | 114-07-8 |
| 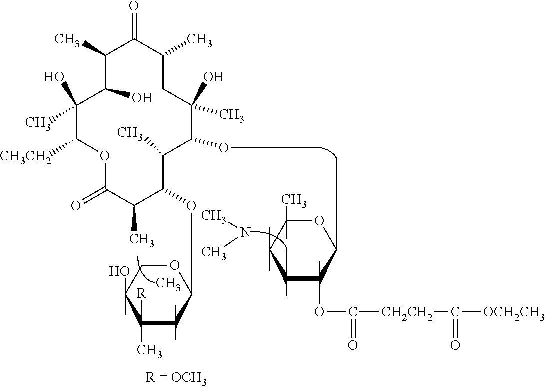 | ERYTHROMYCIN ETHYLSUCCINATE | 862.05 | C₄₃H₇₅NO₁₆ | 1264-62-6 |
| | ERYTHROMYCIN | 1018.4 | C₃₇H₆₇NO₁₃ · C₁₈H₃₆O₂ | 643-22-1 |
| | STEARATE | | | |
| 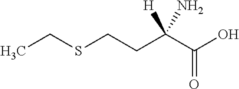 | Ethionine | 163.24 | C₂H₅SCH₂CH₂CH(NH₂)CO₂H | 13073-35-3 |
| 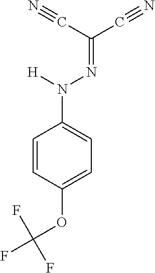 [SMILES: N#CC(C#N)=NNc1ccc(OC(F)(F)F)cc1] | FCCP | 254.17 | C10H5F3N4O | 370-86-5 |
| 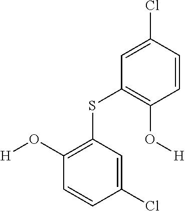 [SMILES: Oc1ccc(Cl)cc1Sc1cc(Cl)ccc1O] | Fenticlor | 287.2 | C12H8Cl2O2S | 97-24-5 |
| 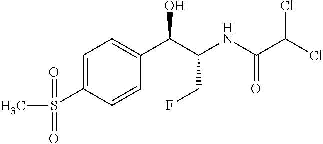 [SMILES: CS(=O)(=O)c1ccc([C@@H](O)[C@@H](CF)NC(=O)C(Cl)Cl)cc1] | FLORFENICOL | 358.21 | C₁₂H₁₄Cl₂FNO₄S | 73231-34-2 |
| 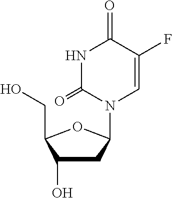 | FLOXURIDINE (2) | 246.19 | C₉H₁₁FN₂O₅ | 50-91-9 |
| 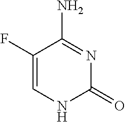 | FLUCYTOSINE | 129.09 | C₄H₄FN₃O | 2022-85-7 |
| 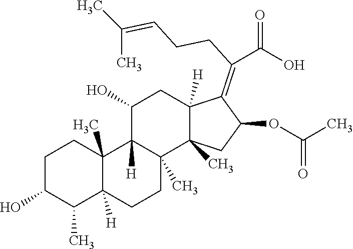 | FUSIDIC ACID | 516.71 | C31H48O6 | 6990 06 3 |
| 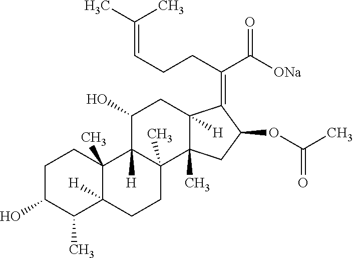 | Fusidic acid sodium | 538.69 | C₃₁H₄₇O₆Na | 751-94-0 |
| 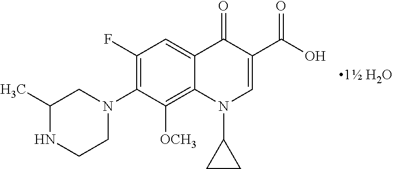 [SMILES: COc1c(N2CCNC(C)C2)c(F)cc2c(=O)c(C(=O)O)cn(C3CC3)c12] | GATIFLOXACIN (2) | 402.42 | C₁₉H₂₂FN₃O₄ · 1.5H₂O | 180200-66-2 |
| 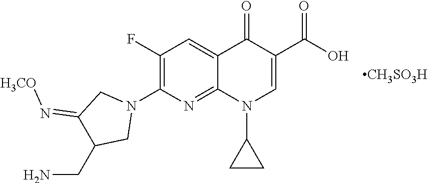 | GEMIFLOXACIN MESYLATE | 485.49 | C₁₈H₂₀FN₅O₄ · CH₄O₃S | 210353-53-0 |
| 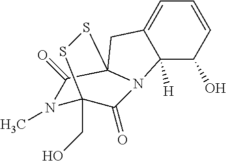 [SMILES: CN1C(=O)C23CC4=CC=C[C@H](O)[C@H]4N2C(=O)C1(CO)SS3] | Gliotoxin | 326.39 | C₁₃H₁₄N₂O₄S₂ | 67-99-2 |
| 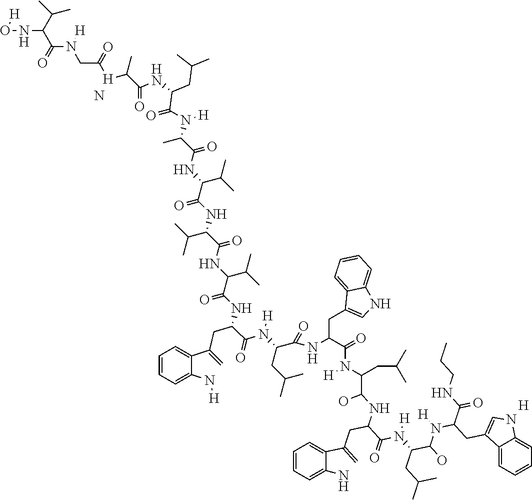 | GRAMICIDIN | 1882.3 | C99H140N20O17 | 1405-97-6 |
| 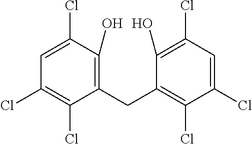 [SMILES: Oc1c(Cl)cc(Cl)c(Cl)c1Cc1c(O)c(Cl)cc(Cl)c1Cl] | HEXACHLOROPHENE | 406.9 | CH₂[C₆H(Cl)₃OH]₂ | 70-30-4 |
| 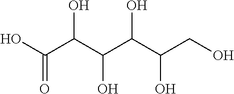 [SMILES: O=C(O)C(O)C(O)C(O)C(O)CO] | Hexonic acid, antimony salt | 196.16 | C6H12O7 | 526-95-4 |
| 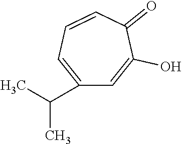 | Hinokitol-β-Thujaplicine | 164.2 | C₁₀H₁₂O₂ | 499-44-5 |
| 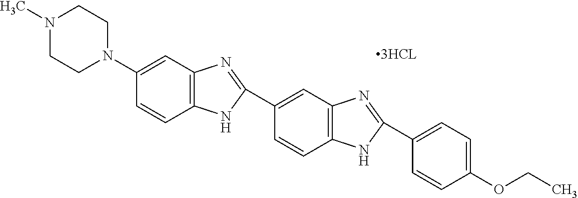 [SMILES: CCOc1ccc(-c2nc3cc(-c4nc5cc(N6CCN(C)CC6)ccc5[nH]4)ccc3[nH]2)cc1] | Hoechst 33342 | 452.55 | C₂₇H₂₈N₆O · 3HCl | 23491-52-3 |
| 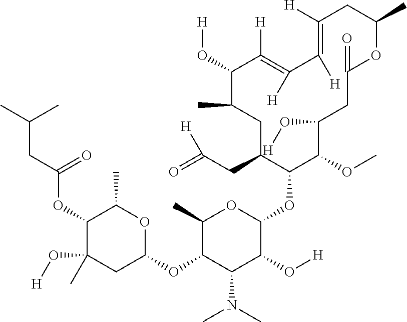 [SMILES: CO[C@@H]1[C@H](O[C@H]2O[C@H](C)[C@@H](O[C@@H]3C[C@](C)(O)[C@H](OC(=O)CC(C)C)[C@H](C)O3)[C@@H](N(C)C)[C@H]2O)[C@@H](CC=O)C[C@@H](C)[C@H](O)/C=C/C=C/C[C@@H](C)OC(=O)C[C@H]1O] | KITASAMYCIN | 786 | C40H67NO14 | 16846-34-7 |
| 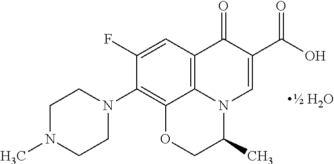 [SMILES: C[C@H]1COc2c(N3CCN(C)CC3)c(F)cc3c(=O)c(C(=O)O)cn1c23] | LEVOFLOXACIN (3) | 370.38 | C₁₈H₂₀FN₃O₄ · 0.5H₂O | 138199-71-0 |
| 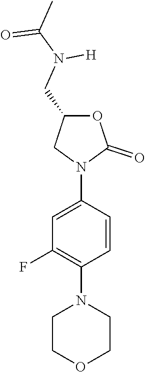 [SMILES: CC(=O)NC[C@H]1CN(c2ccc(N3CCOCC3)c(F)c2)C(=O)O1] | LINEZOLIDE (1; inactive NIHCC) | 337.35 | C16H20FN3O4 | 165800-03-3 |
| 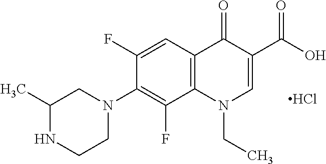 [SMILES: CCn1cc(C(=O)O)c(=O)c2cc(F)c(N3CCNC(C)C3)c(F)c21 ; Cl] | Lomefloxacin hydrochloride (2; inactive LOPAC & VisNR Microsource) | 387.81 | C₁₇H₁₉F₂N₃O₃ · HCl | 98079-52-8 |
| 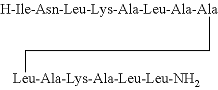 | Mastoparan | 1421.81 | C₆₇H₁₂₄N₁₈O₁₅ | 145854-59-7 |
| 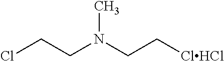 | MECHLORETHAMINE | 192.51 | (ClCH₂CH₂)₂NCH₃ · HCl | 55-86-7 |
| 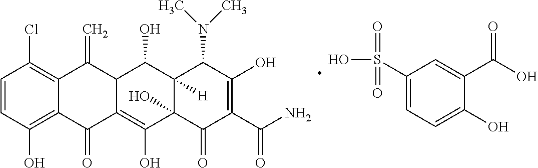 | MECLOCYCLINE SULFOSALICYLATE | 695.05 | C₂₂H₂₁ClN₂O₈ · C₇H₆O₆S | 73816-42-9 |
| 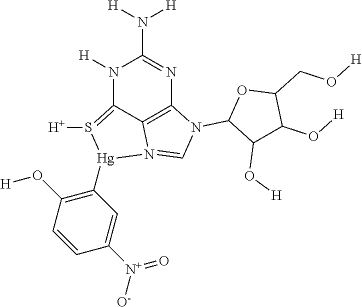 | Mercury, (2-hydroxy-5- nitrophenyl)(6-thioguanosinato- N7,S6)- | 639 | C16H18HgN6O7S+ | |
| 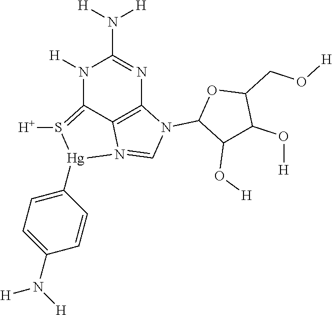 | Mercury, (4-aminophenyl)(6- thioguanosinato-N7,S6)- | 593 | C16H20HgN6O4S+ | |
| | METHYLBENZETHONIUM | 462.11 | C₂₈H₄₄NO₂Cl | 25155-18-4 |
| | CHLORIDE | | | |
| 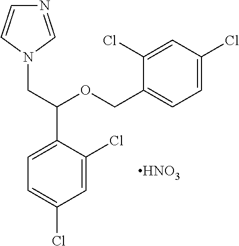 | MICONAZOLE NITRATE | 479.14 | C₁₈H₁₄Cl₄N₂O · HNO₃ | 22832-87-7 |
| 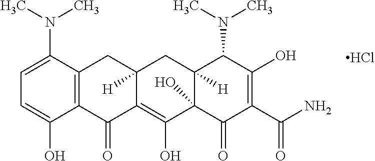 | Minocycline hydrochloride (2) | 493.94 | C₂₃H₂₇N₃O₇ · HCl | 13614-98-7 |
| 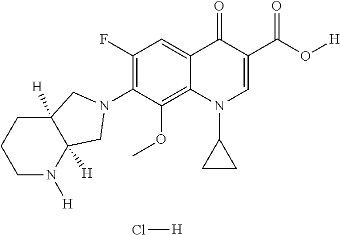 [SMILES: COc1c(N2C[C@@H]3CCCN[C@@H]3C2)c(F)cc2c(=O)c(C(=O)O)cn(C3CC3)c12 ; Cl] | MOXIFLOXACIN HCl | 437.9 | C21H25ClFN3O4 | 186826-86-8 |
| 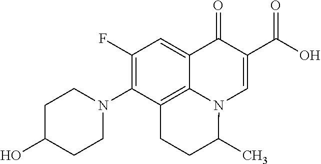 [SMILES: CC1CCc2c(N3CCC(O)CC3)c(F)cc3c(=O)c(C(=O)O)cn1c23] | Nadifloxacin | 360.38 | C₁₉H₂₁FN₂O₄ | 124858-35-1 |
| 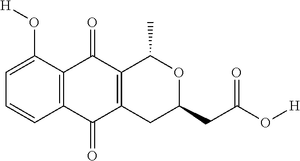 [SMILES: C[C@@H]1O[C@@H](CC(=O)O)CC2=C1C(=O)c1c(O)cccc1C2=O] | Nanaomycin A | 302.28 | C16H14O6 | 52934-83-5 |
| 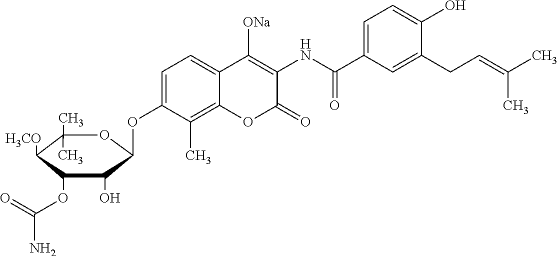 | NOVOBIOCIN SODIUM (2) | 634.61 | C₃₁H₃₅N₂NaO₁₁ | 1476-53-5 |
| 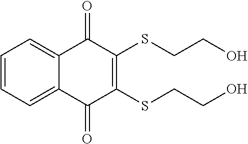 [SMILES: O=C1C(SCCO)=C(SCCO)C(=O)c2ccccc21] | 2,3-bis[(2- Hydroxyethyl)thiol]-1,4- naphthoquinone | 310.39 | C₁₄H₁₄O₄S₂ | 93718-83-3 |
| 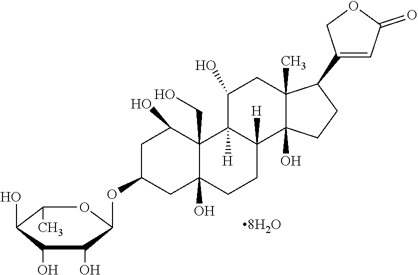 | OUABAIN | 728.77 | C₂₉H₄₄O₁₂ · 8H₂O | 11018-89-6 |
| 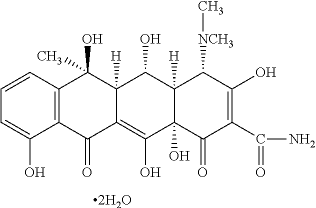 [SMILES: CN(C)[C@@H]1C(O)=C(C(N)=O)C(=O)[C@@]2(O)C(O)=C3C(=O)c4c(O)cccc4[C@@](C)(O)[C@H]3[C@H](O)[C@@H]12 ; "·2H2O"] | OXYTETRACYCLINE | 496.46 | C₂₂H₂₄N₂O₉ · 2H₂O | 6153-64-6 |
| 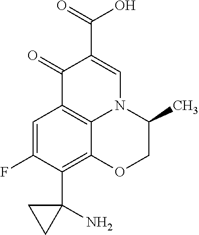 [SMILES: C[C@H]1COc2c(C3(N)CC3)c(F)cc3c(=O)c(C(=O)O)cn1c23] | PAZUFLOXACIN (2) | 318.3 | C₁₆H₁₅FN₂O₄ | 127045-41-4 |
| 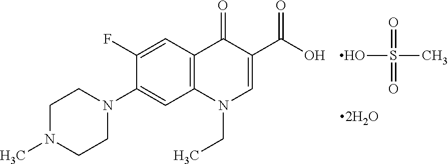 | PEFLOXACIN MESYLATE (2; inactive NIHCC) | 465.49 | C₁₇H₂₀FN₃O₃ · CH₄O₃S · 2H₂O | 149676-40-4 |
| 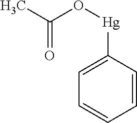 | PHENYLMERCURIC ACETATE | 336.74 | C₆H₅HgOCOCH₃ | 62-38-4 |
| 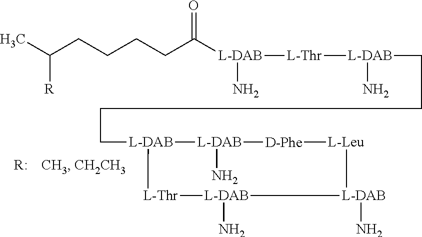 | POLYMYXIN B SULFATE | 1385.61 | C₅₅H₉₆N₁₆O₁₃ · 2H₂SO₄ | 1405-20-5 |
| 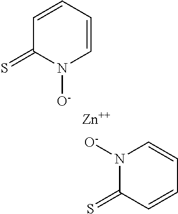 [SMILES: [O-]n1ccccc1=S ; [Zn+2] ; [O-]n1ccccc1=S] | PYRITHIONE ZINC | 317.7 | C₁₀H₈N₂O₂S₂Zn | |
| | PYRVINIUM PAMOATE | 1151.39 | C₇₅H₇₀N₆O₆ | 3546-41-6 |
| 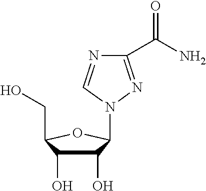 | Ribavirin (2; inactive RpoH Biomol FDA) | 244.2 | C₈H₁₂N₄O₅ | 36791-04-5 |
| 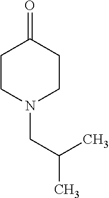 | RIFABUTIN | 847 | C₄₆H₆₂N₄O₁₁ | 72559-06-9 |
| 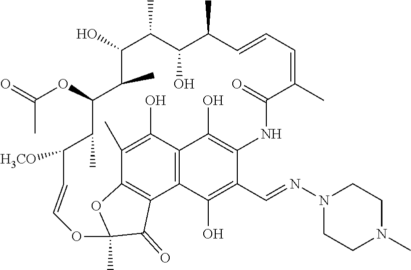 [SMILES: CO[C@H]1/C=C/O[C@@]2(C)Oc3c(C)c(O)c4c(O)c(c(/C=N/N5CCN(C)CC5)c(O)c4c3C2=O)NC(=O)/C(C)=C\C=C\[C@H](C)[C@H](O)[C@@H](C)[C@@H](O)[C@@H](C)[C@H](OC(C)=O)[C@@H]1C] | Rifampicin | 822.94 | C₄₃H₅₈N₄O₁₂ | 13292-46-1 |
| 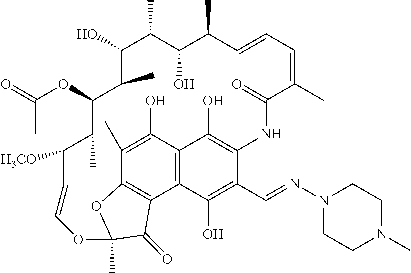 [SMILES: CO[C@H]1/C=C/O[C@@]2(C)Oc3c(C)c(O)c4c(O)c(c(/C=N/N5CCN(C)CC5)c(O)c4c3C2=O)NC(=O)/C(C)=C\C=C\[C@H](C)[C@H](O)[C@@H](C)[C@@H](O)[C@@H](C)[C@H](OC(C)=O)[C@@H]1C] | RIFAMPIN | 822.94 | C₄₃H₅₈N₄O₁₂ | 13292-46-1 |
| 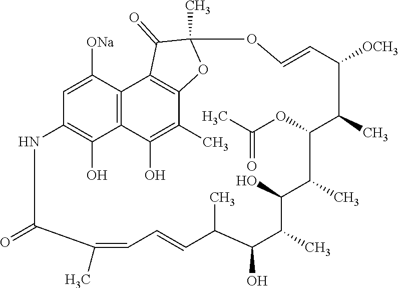 | RIFAMYCIN SV | 719.75 | C₃₇H₄₆NNaO₁₂ | 14897-39-3 |
| 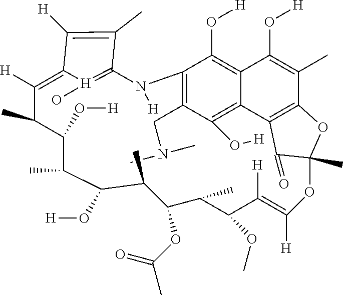 | Rifamycin, 3- [(dimethylamino)methyl]- | 754.9 | C40H54N2O12 | 4135-85-7 |
| 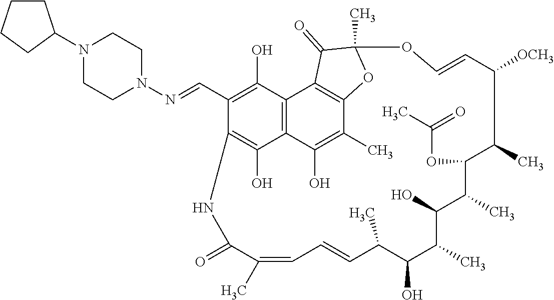 [SMILES: CO[C@H]1/C=C/O[C@@]2(C)Oc3c(C)c(O)c4c(O)c(c(/C=N/N5CCN(C6CCCC6)CC5)c(O)c4c3C2=O)NC(=O)/C(C)=C\C=C\[C@H](C)[C@H](O)[C@@H](C)[C@@H](O)[C@@H](C)[C@H](OC(C)=O)[C@@H]1C] | RIFAPENTINE | 877.03 | C₄₇H₆₄N₄O₁₂ | 61379-65-5 |
| 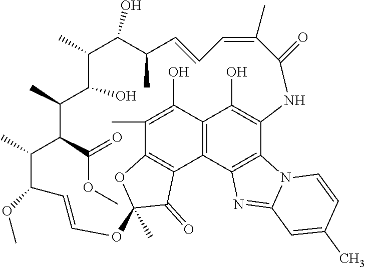 | RIFAXIMIN (2) | 785.88 | C₄₃H₅₁N₃O₁₁ | 80621-81-4 |
| 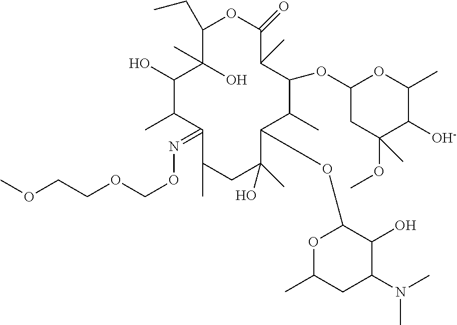 [SMILES: CCC1OC(=O)C(C)C(OC2CC(C)(OC)C([O-])C(C)O2)C(C)C(OC2OC(C)CC(N(C)C)C2O)C(C)(O)CC(C)/C(=N\OCOCCOC)C(C)C(O)C1(C)O] | ROXITHROMYCIN (2) | 837.05 | C₄₁H₇₆N₂O₁₅ | 80214-83-1 |
| 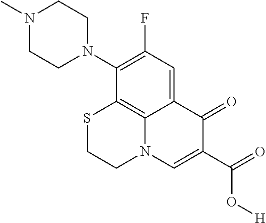 [SMILES: CN1CCN(c2c(F)cc3c(=O)c(C(=O)O)cn4c3c2SCC4)CC1] | RUFLOXACIN HCl (2; inactive LdtR & RpoH NIHCC) | 363.4 | C17H18FN3O3S | 101363-10- 4 |
| | Sancycline | | | |
| 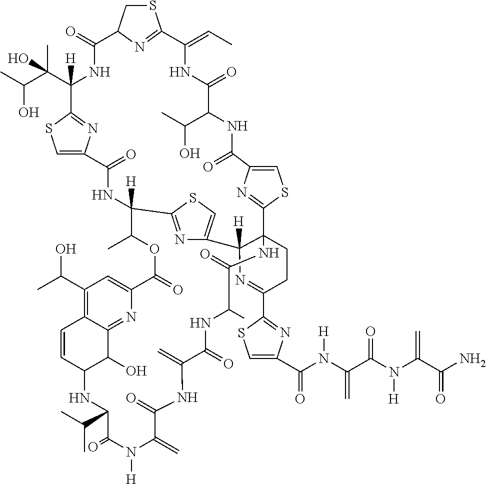 [SMILES: C=C(NC(=O)C(=C)NC(=O)c1csc(C2=N[C@@H]3c4csc(n4)[C@H]4NC(=O)c5csc(n5)[C@H]([C@](C)(O)C(C)O)NC(=O)C5CSC(=N5)/C(=C/C)NC(=O)C(C(C)O)NC(=O)c5csc(n5)C3(CC2)NC(=O)C(C)NC(=O)C(=C)NC(=O)C(=C)NC(=O)[C@H](C(C)C)NC2C=Cc3c(C(C)O)cc(nc3C2O)C(=O)OC4C)n1)C(N)=O] | Siomycin A | 1648.9 | C71H81N19O18S5 | 12656-09-6 |
| 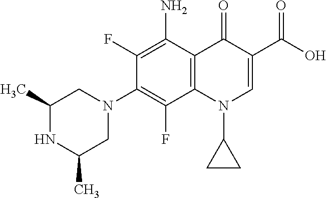 [SMILES: C[C@@H]1CN(c2c(F)c(N)c3c(=O)c(C(=O)O)cn(C4CC4)c3c2F)C[C@H](C)N1] | Sparfloxacin | 392.4 | C₁₉H₂₂F₂N₄O₃ | 110871-86-8 |
| 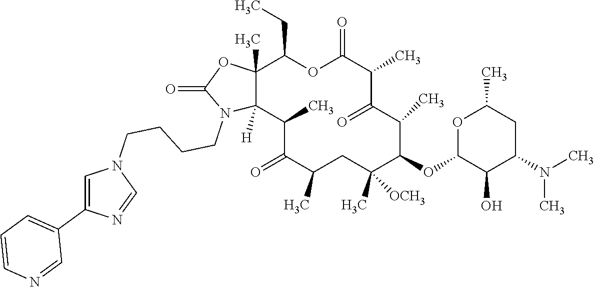 [SMILES: CC[C@H]1OC(=O)[C@H](C)C(=O)[C@H](C)[C@@H](O[C@@H]2O[C@H](C)C[C@H](N(C)C)[C@H]2O)[C@](C)(OC)C[C@@H](C)C(=O)[C@H](C)[C@H]2N(CCCCn3cnc(-c4cccnc4)c3)C(=O)O[C@]12C] | TELITHROMYCIN | 812 | C₄₃H₆₅N₅O₁₀ | 191114-48-4 |
| 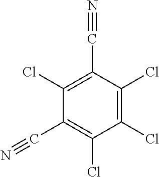 [SMILES: N#Cc1c(Cl)c(Cl)c(Cl)c(C#N)c1Cl] | TETRACHLOROISOPHTHAL ONITRILE | 265.9 | C8Cl4N2 | 1897-45-6 |
| 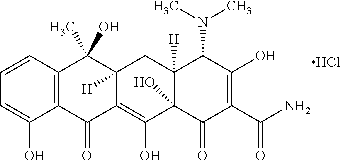 | TETRACYCLINE HYDROCHLORIDE | 480.9 | C₂₂H₂₄N₂O₈ · HCl | 64-75-5 |
| 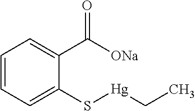 | THIMEROSAL | 404.81 | 2-(C₂H₅HgS)C₆H₄CO₂Na | 54-64-8 |
| 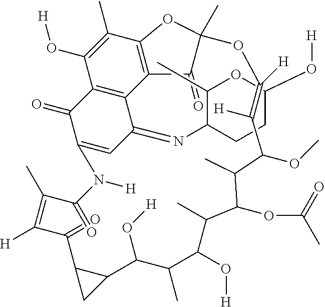 | Tolypomycin Y | 822.9 | C43H54N2O14 | 23412-26-2 |
| 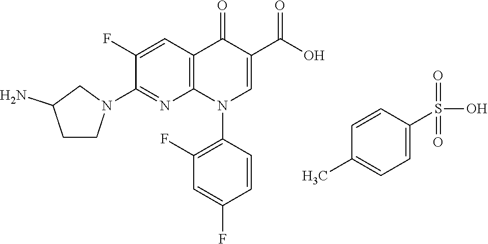 [SMILES: NC1CCN(c2nc3c(cc2F)c(=O)c(C(=O)O)cn3-c2ccc(F)cc2F)C1 ; Cc1ccc(S(=O)(=O)O)cc1] | TOSUFLOXACIN TOSYLATE (2) | 576.54 | C₂₆H₂₃F₃N₄O₆S | 115964-29-9 |
| 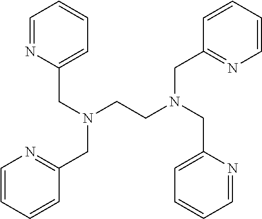 [SMILES: c1ccc(CN(CCN(Cc2ccccn2)Cc2ccccn2)Cc2ccccn2)nc1] | TPEN | 424.54 | C₂₆H₂₈N₆ | 16858-02-9 |
| 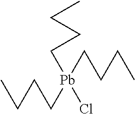 | Tributylchlorolead | 414 | C12H27ClPb | 13302-14-2 |
| 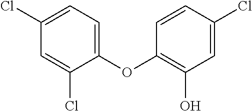 [SMILES: Oc1cc(Cl)ccc1Oc1ccc(Cl)cc1Cl] | TRICLOSAN | 289.54 | C₁₂H₇Cl₃O₂ | 3380-34-5 |
| 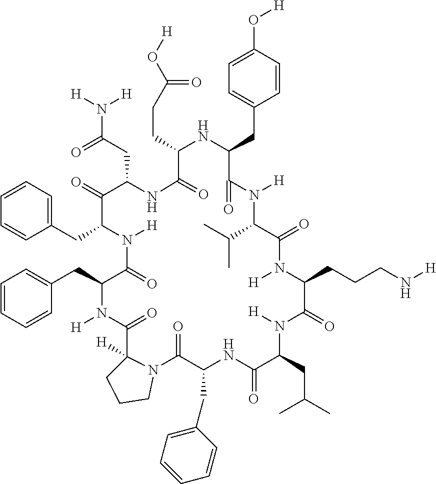 [SMILES: CC(C)C[C@@H]1NC(=O)[C@H](CCCN)NC(=O)[C@H](C(C)C)NC(=O)[C@H](Cc2ccc(O)cc2)N[C@@H](CCC(=O)O)C(=O)N[C@@H](CC(N)=O)C(=O)[C@@H](Cc2ccccc2)NC(=O)[C@H](Cc2ccccc2)NC(=O)[C@@H]2CCCN2C(=O)[C@@H](Cc2ccccc2)NC1=O] | TYROTHRICIN | 1228.4 | C65H85N11O13 | 1404-88-2 |
| 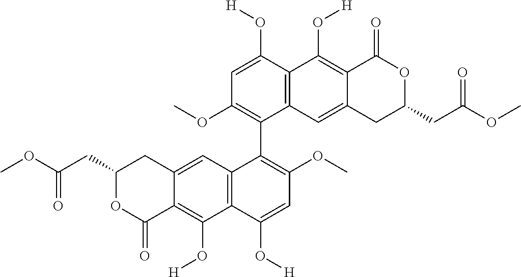 | Viriditoxin | 662.6 | C34H30O14 | 35483-50-2 |

TABLE 2
Active Agents

| | | Mol. | | | |
|---|---|---|---|---|---|
| Molecular structure | Name | weight | Mol. formula | Vendor | Vendor_ID |
| 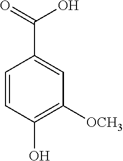 [SMILES: COc1cc(C(=O)O)ccc1O] | Vanillic acid | 168.15 | C8 H8 O4 | Specs | CAS 121-34-6 |
| 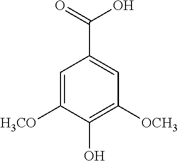 [SMILES: COc1cc(C(=O)O)cc(OC)c1O] | Syringic acid | 198.17 | C9 H10 O5 | Specs | CAS 530-57-4 |
| 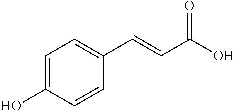 [SMILES: O=C(O)/C=C/c1ccc(O)cc1] | P-Coumaric acid | 164.16 | C9 H8 O3 | Specs | CAS 501-98-4 |
| 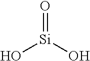 | Silicic acid | 96.11 | H404Si | Specs | CAS 1343-98-2 |
| 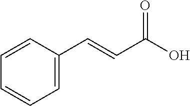 [SMILES: O=C(O)/C=C/c1ccccc1] | Cinnamic acid | 148.16 | C9 H8 O2 | Specs | CAS 140-10-3 |
| 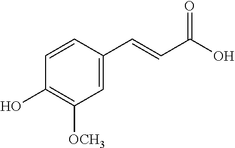 [SMILES: COc1cc(/C=C/C(=O)O)ccc1O] | Ferulic acid | 194.18 | C10 H10 O4 | Specs | CAS 1135-24-6 |
| 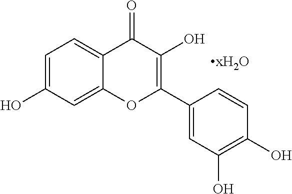 [SMILES: O=c1c(O)c(-c2ccc(O)c(O)c2)oc2cc(O)ccc12] | Fisetin | 286.24 | C₁₅H₁₀O₆ · xH₂O | Specs | CAS 345909-34-4 |
| 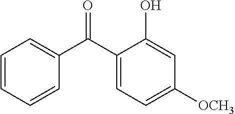 [SMILES: COc1ccc(C(=O)c2ccccc2)c(O)c1] | Oxybenzone | 228.24 | HOC₆H₃(OCH₃)COC₆H₅ | Specs | CAS 131-57-7 |
| 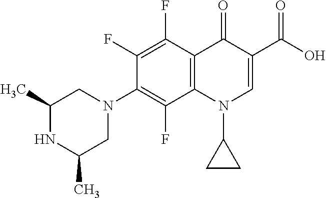 [SMILES: C[C@@H]1CN(c2c(F)c(F)c3c(=O)c(C(=O)O)cn(C4CC4)c3c2F)C[C@H](C)N1] | Orbifloxacin | 395.38 | C₁₉H₂₀F₃N₃O₃ | Specs | CAS 113617-63-3 |
| | Rosiglitazone | 473.5 | C₁₈H₁₉N₃O₃S · C₄H₄O₄ | Specs | CAS 155141-29-0 |
| | maleate | | | | |

### Embodiments

The application includes, and is not limited to, the following embodiments:

1. A composition comprising one or more compound as set forth in Table 1 and/or Table 2 or stereoisomers, tautomers and/or agrochemically acceptable salts thereof (active agent) and one or more component selected from: agriculturally suitable solvents, agriculturally suitable carriers, agriculturally suitable surfactants and mixtures thereof.

2. The composition according to embodiment 1, wherein said agriculturally suitable solvent is: a polar organic solvent, a non-polar organic solvent, ketone, acetone, methyl ethyl ketone, methyl isobutyl ketone, cyclohexanone, amide, dimethyl formamide, alkanecarboxylic acid amide, N,N-dimethyl decaneamide, N,N-dimethyl octanamide, cyclic solvent, N-methyl-pyrrolidone, N-octyl-pyrrolidone, N-dodecyl-pyrrolidone, N-octyl-caprolactame, N-dodecyl-caprolactame, butyrolactone, a strong polar solvent, dimethylsulfoxide, aromatic hydrocarbons, xylol, mineral oils, white spirit, petroleum, alkyl benzene, spindle oil, ester, propyleneglycol-monomethylether acetate, adipic acid dibutylester, acetic acid hexylester, acetic acid heptylester, citric acid tri-n-butylester, phthalic acid di-n-butylester, alcohol, methanol, ethanol, propanol, benzyl alcohol, 1-methoxy-2-propanol, water or mixtures thereof.

3. The composition according to any one of embodiments 1-2, wherein the agriculturally acceptable carrier is selected from water, an alcohol, ethanol, propanol, butanol, organic solvent, mineral oil, vegetable oil, and mixtures thereof.

4. The composition according to any one of embodiments 1-3, wherein the agriculturally acceptable surfactant is selected from salts of polyacrylic acid, salts of lignosulfonic acid, salts of phenolsulfonic acid, naphthalenesulfonic acid, polycondensates of ethylene oxide with fatty alcohols, fatty acids or fatty amines, substituted phenols, alkylphenols, arylphenols), salts of sulfosuccinic esters, taurine derivatives, alkyl taurates, phosphoric esters of polyethoxylated alcohols or phenols, fatty esters of polyols, ethoxylated nonylphenols, polyalkylene glycolether of linear or branched alcohols, reaction products of alkyl phenols with ethylene oxide and/or propylene oxide, reaction products of fatty acid amines with ethylene oxide and/or propylene oxide, fattic acid esters, alkyl sulfonates, alkyl sulfates, alkyl ethersulfates, alkyl etherphosphates, arylsulfate, ethoxylated arylalkylphenols, tristyryl-phenol-ethoxylates, ethoxylated and propoxylated arylalkylphenols, sulfated or phosphated arylalkylphenol-ethoxylates, sulfated or phosphated ethoxy-propoxylates, lignosulfonates, gelatin, gum arabic, phospholipids, starch, hydrophobic modified starch and cellulose derivatives, cellulose ester, cellulose ether, polyvinyl alcohol, polyvinyl acetate, polyvinyl pyrrolidone, polyacrylic acid, crop oil concentrates organic (COC), methylated seed oils (MSO), high surfactant methylated seed oils (HSMSO), silicone surfactants (SS), non-ionic surfactants (NIS)polymethacrylic acid and co-polymerisates of (meth)acrylic acid and (meth)acrylic acid esters, and mixtures thereof.

5. The composition according to any one of embodiments 1-4, wherein the active agent(s) are present in an amount of about 0.05% and about 99% by weight and agriculturally suitable solvents, agriculturally suitable carriers, and/or agriculturally suitable surfactants are present in an amount of between about 0.05% and about 99% by weight.

6. The composition according to any one of embodiments 1-5, said composition comprising (−)-Ephedrine hemisulfate; [4-(4-arsonobenzyl)phenyl]arsonic acid; 1-Butanone, 1-(3-chlorophenyl)-4,4,4-trifluoro-3-hydroxy-3-(trifluoromethyl)-, oxime; 1,3-bis(4-amino-2-methyl-6-quinolyl)urea; 1,4-naphthoquinone; 2-(1,3-benzoxazol-3(2H)-ylmethyl)-5-((cyclohexylamino)methyl)-1,4-benzenediol; 2-[2-(carboxylatomethyl-(carboxymethyl)amino)ethyl-(carboxymethyl)amino]acetate; mercury(+2) cation; 2-aminophenol; antimony; (2S,3R)-2,3-dihydroxybutanedioic acid; hydrate; 2,3-dichloro-5,8-dihydroxynaphthoquinone; 21-O-Acetylstreptovaricinoic acid methyl ester; 4-(((8-hydroxy-7-quinolinyl)(phenyl)methyl)amino)benzoic acid; 4-Chloromercuribenzoic acid; 5-Fluorocytosine; 5-Fluorouracil (2; inactive LdtR LOPAC); 7-[(8-hydroxy-5-nitro-7-quinolyl)methyl]-5-nitro-quinolin-8-ol; calcimycin; A Mithracin; actinomycin D (2); Auranofin; Azithromycin (2); Bactobolin Propanamide; Bay 11-7082; Bay 11-7085; Benzalkonium chloride; beta-Thujaplicin; Bithionate sodium; Bleomycin A5-sulfate; Bromocopper; (dipyridin-2-ylmethylideneamino)-(methylsulfanyl-sulfoniumylidene-methyl)azanide; Broxyquinoline; Carmofur (3); Cetylpyridinium chloride; Chaetochromin; Chloramphenicol (2); Chloramphenicol Hemisuccinate; Chlorhexidine; Chloroacetoxyquinoline; Chloroxine; Ciclopirox Olamine; Ciprofloxacin; Clarithromycin (2; inactive LdtR & RpoH NIHCC); Clinafloxacin; Clioquinol; Closantel; Cloxyquin; CLTC U-6780 B-Aureo Tetra 5; Auxeomycin Clorocipan Isphamycin Aureocarmyl (2); Colistimethate Sodium; Colistin Sulfate; copper; [(6-methylpyridin-2-yl)methylideneamino]-(methylsulfanyl-sulfoniumylidene-methyl)azanide; Coumermycin A1; Demeclocycline hydrochloride (2); Diethylenetriaminepentaacetic acid (1; inactive LOPAC); Dimercaprol; Diphenyleneiodonium chloride (2); Doxycycline hyclate; Doxycycline hydrochloride (2); Ebselen (2; inactive LdtR & RpoH NIHCC); Echinomycin; Enrofloxacin (3); Eruthromycin; Erythromycin Ethylsuccinate; Erythromycin Stearate; Ethionine; FCCP; Fenticlor; Florfenicol; Floxuridine (2); Flucytosine; Fusidic Acid; Fusidic acid sodium; Gatifloxacin (2); Gemifloxacin Mesylate; Gliotoxin; Gramicidin; Hexachlorophene; Hexonic acid, antimony salt; Hinokitol β-Thujaplicin; Hoechst 33342; Kitasamycin; Levofloxacin (3); Linezolide (1; inactive NIHCC); Lomefloxacin hydrochloride (2; inactive LOPAC & VisNR Microsource); Mastoparan; Mechlorethamine; Meclocycline Sulfosalicylate; Mercury, (2-hydroxy-5-nitrophenyl)(6-thioguanosinato-N7,S6)-; Mercury, (4-aminophenyl)(6-thioguanosinato-N7,S6)-; Methylbenzethonium Chloride; Miconazole Nitrate; Minocycline hydrochloride (2); Moxifloxacin HCl; Nadifloxacin; Nanaomycin A; Novobiocin Sodium (2); 2,3-bis[(2-Hydroxyethyl)thiol]-1,4-naphthoquinone; Ouabain; Oxytetracycline; Pazufloxacin (2); Pefloxacin Mesylate (2; inactive NIHCC); Phenylmercuric Acetate; Polymyxin B Sulfate; Pyrithione Zinc; Pyrvinium Pamoate; Ribavirin (2; inactive RpoH Biomol FDA); Rifabutin; Rifampicin; Rifampin; Rifamycin SV; Rifamycin, 3-[(dimethylamino)methyl]-; Rifapentine; Rifaximin (2); Roxithromycin (2); Rufloxacin HCl (2; inactive LdtR & RpoH NIHCC); Sancycline; Siomycin A; Sparfloxacin; Telithromycin; Tetrachloroisophthalonitrile; Tetracycline Hydrochloride; Thimerosal; Tolypomycin Y; Tosufloxacin Tosylate (2); TPEN; Tributylchlorolead; Triclosan; Tyrothricin; Viriditoxin; or combinations thereof as the active agent(s).

7. The composition according to any one of embodiments 1-5, said composition comprising Vanillic acid; Syringic acid; P-Coumaric acid; Silicic acid; Cinnamic acid; Ferulic acid; Fisetin; Oxybenzone; Orbifloxacin; Rosiglitazone maleate; and combinations thereof as the active agent(s); or one of the following combinations of active agents:

a) a, b; a, c; a, d; a, e; a, f; a, g; a, h; a, i; a, j; b, c; b, d, b, e; b, f, b, g; b, h; b, i; b, j; c, d; c, e; c, f, c, g; c, h; c, i; c, j; d, e; d, f, d, g; d, h; d, i; d, j; e, f; e, g; e, h; e, i; e, j; f, g; f, h; f, i; f, j; g, h; g, i; g, j; h, i; h, j; or i, j;

b) a, b, c; a, b, d; a, b, e; a, b, f; a, b, g; a, b, h; a, b, i; a, b, j; a, c, d; a, c, e; a, c, f; a, c, g; a, c, h; a, c, i; a, c, j; a, d, e; a, d, f; a, d, g; a, d, h; a, d, i; a, d, j; a, e, f; a, e, g; a, e, h; a, e, i; a, e, j; a, f, g; a, f, h; a, f, i; a, f, j; a, g, h; a, g, i; a, g, j; a, h, i; a, h, j; a, i, j; b, c, d; b, c, e; b, c, f; b, c, g; b, c, h; b, c, i; b, c, j; b, d, e; b, d, f, b, d, g; b, d, h; b, d, i; b, d, j; b, e, f, b, e, g; b, e, h; b, e, i; b, e, j; b, f, g; b, f, h; b, f, i; b, f, j; b, g, h; b, g, i; b, g, j; b, h, i; b, h, j; b, i, j; c, d, e; c, d, f, c, d, g; c, d, h; c, d, i; c, d, j; c, e, f; c, e, g; c, e, h; c, e, i; c, e, j; c, f, g; c, f, h; c, f, i; c, f, j; c, g, h; c, g, i; c, g, j; c, h, i; c, h, j; c, i, j; d, e, f; d, e, g; d, e, h; d, e, i; d, e, j; d, f, g; d, f, h; d, f, i; d, f, j; d, g, h; d, g, i; d, g, j; d, h, i; d, h, j; d, i, j; e, f, g; e, f, h; e, f, i; e, f, j; e, g, h; e, g, i; e, g, j; e, h, i; e, h, j; e, i, j; f, g, h; f, g, i; f, g, j; f, h, i; f, h, j; f, i, j; g, h, i; g, h, j; g, i, j; or h, i, j;

c) a, b, c, d; a, b, c, e; a, b, c, f; a, b, c, g; a, b, c, h; a, b, c, i; a, b, c, j; a, b, d, e; a, b, d, f; a, b, d, g; a, b, d, h; a, b, d, i; a, b, d, j; a, b, e, f; a, b, e, g; a, b, e, h; a, b, e, i; a, b, e, j; a, b, f, g; a, b, f, h; a, b, f, i; a, b, f, j; a, b, g, h; a, b, g, i; a, b, g, j; a, b, h, i; a, b, h, j; a, b, i, j; a, c, d, e; a, c, d, f; a, c, d, g; a, c, d, h; a, c, d, i; a, c, d, j; a, c, e, f; a, c, e, g; a, c, e, h; a, c, e, i; a, c, e, j; a, c, f, g; a, c, f, h; a, c, f, i; a, c, f, j; a, c, g, h; a, c, g, i; a, c, g, j; a, c, h, i; a, c, h, j; a, c, i, j; a, d, e, f; a, d, e, g; a, d, e, h; a, d, e, i; a, d, e, j; a, d, f, g; a, d, f, h; a, d, f, i; a, d, f, j; a, d, g, h; a, d, g, i; a, d, g, j; a, d, h, i; a, d, h, j; a, d, i, j; a, e, f, g; a, e, f, h; a, e, f, i; a, e, f, j; a, e, g, h; a, e, g, i; a, e, g, j; a, e, h, i; a, e, h, j; a, e, i, j; a, f, g, h; a, f, g, i; a, f, g, j; a, f, h, i; a, f, h, j; a, f, i, j; a, g, h, i; a, g, h, j; a, g, i, j; a, h, i, j; b, c, d, e; b, c, d, f; b, c, d, g; b, c, d, h; b, c, d, i; b, c, d, j; b, c, e, f, b, c, e, g; b, c, e, h; b, c, e, i; b, c, e, j; b, c, f, g; b, c, f, h; b, c, f, i; b, c, f, j; b, c, g, h; b, c, g, i; b, c, g, j; b, c, h, i; b, c, h, j; b, c, i, j; b, d, e, f; b, d, e, g; b, d, e, h; b, d, e, i; b, d, e, j; b, d, f, g; b, d, f, h; b, d, f, i; b, d, f, j; b, d, g, h; b, d, g, i; b, d, g, j; b, d, h, i; b, d, h, j; b, d, i, j; b, e, f, g; b, e, f, h; b, e, f, i; b, e, f, j; b, e, g, h; b, e, g, i; b, e, g, j; b, e, h, i; b, e, h, j; b, e, i, j; b, f, g, h; b, f, g, i; b, f, g, j; b, f, h, i; b, f, h, j; b, f, i, j; b, g, h, i; b, g, h, j; b, g, i, j; b, h, i, j; c, d, e, f; c, d, e, g; c, d, e, h; c, d, e, i; c, d, e, j; c, d, f, g; c, d, f, h; c, d, f, i; c, d, f, j; c, d, g, h; c, d, g, i; c, d, g, j; c, d, h, i; c, d, h, j; c, d, i, j; c, e, f, g; c, e, f, h; c, e, f, i; c, e, f, j; c, e, g, h; c, e, g, i; c, e, g, j; c, e, h, i; c, e, h, j; c, e, i, j; c, f, g, h; c, f, g, i; c, f, g, j; c, f, h, i; c, f, h, j; c, f, i, j; c, g, h, i; c, g, h, j; c, g, i, j; c, h, i, j; d, e, f, g; d, e, f, h; d, e, f, i; d, e, f, j; d, e, g, h; d, e, g, i; d, e, g, j; d, e, h, i; d, e, h, j; d, e, i, j; d, f, g, h; d, f, g, i; d, f, g, j; d, f, h, i; d, f, h, j; d, f, i, j; d, g, h, i; d, g, h, j; d, g, i, j; d, h, i, j; e, f, g, h; e, f, g, i; e, f, g, j; e, f, h, i; e, f, h, j; e, f, i, j; e, g, h, i; e, g, h, j; e, g, i, j; e, h, i, j; f, g, h, i; f, g, h, j; f, g, i, j; f, h, i, j; or g, h, i, j;

d) a, b, c, d, e; a, b, c, d, f; a, b, c, d, g; a, b, c, d, h; a, b, c, d, i; a, b, c, d, j; a, b, c, e, f; a, b, c, e, g; a, b, c, e, h; a, b, c, e, i; a, b, c, e, j; a, b, c, f, g; a, b, c, f, h; a, b, c, f, i; a, b, c, f, j; a, b, c, g, h; a, b, c, g, i; a, b, c, g, j; a, b, c, h, i; a, b, c, h, j; a, b, c, i, j; a, b, d, e, f; a, b, d, e, g; a, b, d, e, h; a, b, d, e, i; a, b, d, e, j; a, b, d, f, g; a, b, d, f, h; a, b, d, f, i; a, b, d, f, j; a, b, d, g, h; a, b, d, g, i; a, b, d, g, j; a, b, d, h, i; a, b, d, h, j; a, b, d, i, j; a, b, e, f, g; a, b, e, f, h; a, b, e, f, i; a, b, e, f, j; a, b, e, g, h; a, b, e, g, i; a, b, e, g, j; a, b, e, h, i; a, b, e, h, j; a, b, e, i, j; a, b, f, g, h; a, b, f, g, i; a, b, f, g, j; a, b, f, h, i; a, b, f, h, j; a, b, f, i, j; a, b, g, h, i; a, b, g, h, j; a, b, g, i, j; a, b, h, i, j; a, c, d, e, f; a, c, d, e, g; a, c, d, e, h; a, c, d, e, i; a, c, d, e, j; a, c, d, f, g; a, c, d, f, h; a, c, d, f, i; a, c, d, f, j; a, c, d, g, h; a, c, d, g, i; a, c, d, g, j; a, c, d, h, i; a, c, d, h, j; a, c, d, i, j; a, c, e, f, g; a, c, e, f, h; a, c, e, f, i; a, c, e, f, j; a, c, e, g, h; a, c, e, g, i; a, c, e, g, j; a, c, e, h, i; a, c, e, h, j; a, c, e, i, j; a, c, f, g, h; a, c, f, g, i; a, c, f, g, j; a, c, f, h, i; a, c, f, h, j; a, c, f, i, j; a, c, g, h, i; a, c, g, h, j; a, c, g, i, j; a, c, h, i, j; a, d, e, f, g; a, d, e, f, h; a, d, e, f, i; a, d, e, f, j; a, d, e, g, h; a, d, e, g, i; a, d, e, g, j; a, d, e, h, i; a, d, e, h, j; a, d, e, i, j; a, d, f, g, h; a, d, f, g, i; a, d, f, g, j; a, d, f, h, i; a, d, f, h, j; a, d, f, i, j; a, d, g, h, i; a, d, g, h, j; a, d, g, i, j; a, d, h, i, j; a, e, f, g, h; a, e, f, g, i; a, e, f, g, j; a, e, f, h, i; a, e, f, h, j; a, e, f, i, j; a, e, g, h, i; a, e, g, h, j; a, e, g, i, j; a, e, h, i, j; a, f, g, h, i; a, f, g, h, j; a, f, g, i, j; a, f, h, i, j; a, g, h, i, j; b, c, d, e, f; b, c, d, e, g; b, c, d, e, h; b, c, d, e, i; b, c, d, e, j; b, c, d, f, g; b, c, d, f, h; b, c, d, f, i; b, c, d, f, j; b, c, d, g, h; b, c, d, g, i; b, c, d, g, j; b, c, d, h, i; b, c, d, h, j; b, c, d, i, j; b, c, e, f, g; b, c, e, f, h; b, c, e, f, i; b, c, e, f, j; b, c, e, g, h; b, c, e, g, i; b, c, e, g, j; b, c, e, h, i; b, c, e, h, j; b, c, e, i, j; b, c, f, g, h; b, c, f, g, i; b, c, f, g, j; b, c, f, h, i; b, c, f, h, j; b, c, f, i, j; b, c, g, h, i; b, c, g, h, j; b, c, g, i, j; b, c, h, i, j; b, d, e, f, g; b, d, e, f, h; b, d, e, f, i; b, d, e, f, j; b, d, e, g, h; b, d, e, g, i; b, d, e, g, j; b, d, e, h, i; b, d, e, h, j; b, d, e, i, j; b, d, f, g, h; b, d, f, g, i; b, d, f, g, j; b, d, f, h, i; b, d, f, h, j; b, d, f, i, j; b, d, g, h, i; b, d, g, h, j; b, d, g, i, j; b, d, h, i, j; b, e, f, g, h; b, e, f, g, i; b, e, f, g, j; b, e, f, h, i; b, e, f, h, j; b, e, f, i, j; b, e, g, h, i; b, e, g, h, j; b, e, g, i, j; b, e, h, i, j; b, f, g, h, i; b, f, g, h, j; b, f, g, i, j; b, f, h, i, j; b, g, h, i, j; c, d, e, f, g; c, d, e, f, h; c, d, e, f, i; c, d, e, f, j; c, d, e, g, h; c, d, e, g, i; c, d, e, g, j; c, d, e, h, i; c, d, e, h, j; c, d, e, i, j; c, d, f, g, h; c, d, f, g, i; c, d, f, g, j; c, d, f, h, i; c, d, f, h, j; c, d, f, i, j; c, d, g, h, i; c, d, g, h, j; c, d, g, i, j; c, d, h, i, j; c, e, f, g, h; c, e, f, g, i; c, e, f, g, j; c, e, f, h, i; c, e, f, h, j; c, e, f, i, j; c, e, g, h, i; c, e, g, h, j; c, e, g, i, j; c, e, h, i, j; c, f, g, h, i; c, f, g, h, j; c, f, g, i, j; c, f, h, i, j; c, g, h, i, j; d, e, f, g, h; d, e, f, g, i; d, e, f, g, j; d, e, f, h, i; d, e, f, h, j; d, e, f, i, j; d, e, g, h, i; d, e, g, h, j; d, e, g, i, j; d, e, h, i, j; d, f, g, h, i; d, f, g, h, j; d, f, g, i, j; d, f, h, i, j; d, g, h, i, j; e, f, g, h, i; e, f, g, h, j; e, f, g, i, j; e, f, h, i, j; e, g, h, i, j; or f, g, h, i, j;

e) a, b, c, d, e, f; a, b, c, d, e, g; a, b, c, d, e, h; a, b, c, d, e, i; a, b, c, d, e, j; a, b, c, d, f, g; a, b, c, d, f, h; a, b, c, d, f, i; a, b, c, d, f, j; a, b, c, d, g, h; a, b, c, d, g, i; a, b, c, d, g, j; a, b, c, d, h, i; a, b, c, d, h, j; a, b, c, d, i, j; a, b, c, e, f, g; a, b, c, e, f, h; a, b, c, e, f, i; a, b, c, e, f, j; a, b, c, e, g, h; a, b, c, e, g, i; a, b, c, e, g, j; a, b, c, e, h, i; a, b, c, e, h, j; a, b, c, e, i, j; a, b, c, f, g, h; a, b, c, f, g, i; a, b, c, f, g, j; a, b, c, f, h, i; a, b, c, f, h, j; a, b, c, f, i, j; a, b, c, g, h, i; a, b, c, g, h, j; a, b, c, g, i, j; a, b, c, h, i, j; a, b, d, e, f, g; a, b, d, e, f, h; a, b, d, e, f, i; a, b, d, e, f, j; a, b, d, e, g, h; a, b, d, e, g, i; a, b, d, e, g, j; a, b, d, e, h, i; a, b, d, e, h, j; a, b, d, e, i, j; a, b, d, f, g, h; a, b, d, f, g, i; a, b, d, f, g, j; a, b, d, f, h, i; a, b, d, f, h, j; a, b, d, f, i, j; a, b, d, g, h, i; a, b, d, g, h, j; a, b, d, g, i, j; a, b, d, h, i, j; a, b, e, f, g, h; a, b, e, f, g, i; a, b, e, f, g, j; a, b, e, f, h, i; a, b, e, f, h, j; a, b, e, f, i, j; a, b, e, g, h, i; a, b, e, g, h, j; a, b, e, g, i, j; a, b, e, h, i, j; a, b, f, g, h, i; a, b, f, g, h, j; a, b, f, g, i, j; a, b, f, h, i, j; a, b, g, h, i, j; a, c, d, e, f, g; a, c, d, e, f, h; a, c, d, e, f, i; a, c, d, e, f, j; a, c, d, e, g, h; a, c, d, e, g, i; a, c, d, e, g, j; a, c, d, e, h, i; a, c, d, e, h, j; a, c, d, e, i, j; a, c, d, f, g, h; a, c, d, f, g, i; a, c, d, f, g, j; a, c, d, f, h, i; a, c, d, f, h, j; a, c, d, f, i, j; a, c, d, g, h, i; a, c, d, g, h, j; a, c, d, g, i, j; a, c, d, h, i, j; a, c, e, f, g, h; a, c, e, f, g, i; a, c, e, f, g, j; a, c, e, f, h, i; a, c, e, f, h, j; a, c, e, f i, j; a, c, e, g, h, i; a, c, e, g, h, j; a, c, e, g, i, j; a, c, e, h, i, j; a, c, f, g, h, i; a, c, f, g, h, j; a, c, f, g, i, j; a, c, f, h, i, j; a, c, g, h, i, j; a, d, e, f, g, h; a, d, e, f, g, i; a, d, e, f, g, j; a, d, e, f, h, i; a, d, e, f, h, j; a, d, e, f, i, j; a, d, e, g, h, i; a, d, e, g, h, j; a, d, e, g, i, j; a, d, e, h, i, j; a, d, f, g, h, i; a, d, f, g, h, j; a, d, f, g, i, j; a, d, f, h, i, j; a, d, g, h, i, j; a, e, f, g, h, i; a, e, f, g, h, j; a, e, f, g, i, j; a, e, f, h, i, j; a, e, g, h, i, j; a, f, g, h, i, j; b, c, d, e, f, g; b, c, d, e, f, h; b, c, d, e, f, i; b, c, d, e, f, j; b, c, d, e, g, h; b, c, d, e, g, i; b, c, d, e, g, j; b, c, d, e, h, i; b, c, d, e, h, j; b, c, d, e, i, j; b, c, d, f, g, h; b, c, d, f, g, i; b, c, d, f, g, j; b, c, d, f, h, i; b, c, d, f, h, j; b, c, d, f, i, j; b, c, d, g, h, i; b, c, d, g, h, j; b, c, d, g, i, j; b, c, d, h, i, j; b, c, e, f, g, h; b, c, e, f, g, i; b, c, e, f, g, j; b, c, e, f, h, i; b, c, e, f, h, j; b, c, e, f, i, j; b, c, e, g, h, i; b, c, e, g, h, j; b, c, e, g, i, j; b, c, e, h, i, j; b, c, f, g, h, i; b, c, f, g, h, j; b, c, f, g, i, j; b, c, f, h, i, j; b, c, g, h, i, j; b, d, e, f, g, h; b, d, e, f, g, i; b, d, e, f, g, j; b, d, e, f, h, i; b, d, e, f, h, j; b, d, e, f, i, j; b, d, e, g, h, i; b, d, e, g, h, j; b, d, e, g, i, j; b, d, e, h, i, j; b, d, f, g, h, i; b, d, f, g, h, j; b, d, f, g, i, j; b, d, f, h, i, j; b, d, g, h, i, j; b, e, f, g, h, i; b, e, f, g, h, j; b, e, f, g, i, j; b, e, f, h, i, j; b, e, g, h, i, j; b, f, g, h, i, j; c, d, e, f, g, h; c, d, e, f, g, i; c, d, e, f, g, j; c, d, e, f, h, i; c, d, e, f, h, j; c, d, e, f, i, j; c, d, e, g, h, i; c, d, e, g, h, j; c, d, e, g, i, j; c, d, e, h, i, j; c, d, f, g, h, i; c, d, f, g, h, j; c, d, f, g, i, j; c, d, f, h, i, j; c, d, g, h, i, j; c, e, f, g, h, i; c, e, f, g, h, j; c, e, f, g, i, j; c, e, f, h, i, j; c, e, g, h, i, j; c, f, g, h, i, j; d, e, f, g, h, i; d, e, f, g, h, j; d, e, f, g, i, j; d, e, f, h, i, j; d, e, g, h, i, j; d, f, g, h, i, j; or e, f, g, h, i, j;

f) a, b, c, d, e, f, g; a, b, c, d, e, f, h; a, b, c, d, e, f, i; a, b, c, d, e, f, j; a, b, c, d, e, g, h; a, b, c, d, e, g, i; a, b, c, d, e, g, j; a, b, c, d, e, h, i; a, b, c, d, e, h, j; a, b, c, d, e, i, j; a, b, c, d, f, g, h; a, b, c, d, f, g, i; a, b, c, d, f, g, j; a, b, c, d, f, h, i; a, b, c, d, f, h, j; a, b, c, d, f, i, j; a, b, c, d, g, h, i; a, b, c, d, g, h, j; a, b, c, d, g, i, j; a, b, c, d, h, i, j; a, b, c, e, f, g, h; a, b, c, e, f, g, i; a, b, c, e, f, g, j; a, b, c, e, f, h, i; a, b, c, e, f, h, j; a, b, c, e, f, i, j; a, b, c, e, g, h, i; a, b, c, e, g, h, j; a, b, c, e, g, i, j; a, b, c, e, h, i, j; a, b, c, f, g, h, i; a, b, c, f, g, h, j; a, b, c, f, g, i, j; a, b, c, f, h, i, j; a, b, c, g, h, i, j; a, b, d, e, f, g, h; a, b, d, e, f, g, i; a, b, d, e, f, g, j; a, b, d, e, f, h, i; a, b, d, e, f, h, j; a, b, d, e, f, i, j; a, b, d, e, g, h, i; a, b, d, e, g, h, j; a, b, d, e, g, i, j; a, b, d, e, h, i, j; a, b, d, f, g, h, i; a, b, d, f, g, h, j; a, b, d, f, g, i, j; a, b, d, f, h, i, j; a, b, d, g, h, i, j; a, b, e, f, g, h, i; a, b, e, f, g, h, j; a, b, e, f, g, i, j; a, b, e, f, h, i, j; a, b, e, g, h, i, j; a, b, f, g, h, i, j; a, c, d, e, f, g, h; a, c, d, e, f, g, i; a, c, d, e, f, g, j; a, c, d, e, f, h, i; a, c, d, e, f, h, j; a, c, d, e, f, i, j; a, c, d, e, g, h, i; a, c, d, e, g, h, j; a, c, d, e, g, i, j; a, c, d, e, h, i, j; a, c, d, f, g, h, i; a, c, d, f, g, h, j; a, c, d, f, g, i, j; a, c, d, f, h, i, j; a, c, d, g, h, i, j; a, c, e, f, g, h, i; a, c, e, f, g, h, j; a, c, e, f, g, i, j; a, c, e, f, h, i, j; a, c, e, g, h, i, j; a, c, f, g, h, i, j; a, d, e, f, g, h, i; a, d, e, f, g, h, j; a, d, e, f, g, i, j; a, d, e, f, h, i, j; a, d, e, g, h, i, j; a, d, f, g, h, i, j; a, e, f, g, h, i, j; b, c, d, e, f, g, h; b, c, d, e, f, g, i; b, c, d, e, f, g, j; b, c, d, e, f, h, i; b, c, d, e, f, h, j; b, c, d, e, f, i, j; b, c, d, e, g, h, i; b, c, d, e, g, h, j; b, c, d, e, g, i, j; b, c, d, e, h, i, j; b, c, d, f, g, h, i; b, c, d, f, g, h, j; b, c, d, f, g, i, j; b, c, d, f, h, i, j; b, c, d, g, h, i, j; b, c, e, f, g, h, i; b, c, e, f, g, h, j; b, c, e, f, g, i, j; b, c, e, f, h, i, j; b, c, e, g, h, i, j; b, c, f, g, h, i, j; b, d, e, f, g, h, i; b, d, e, f, g, h, j; b, d, e, f, g, i, j; b, d, e, f, h, i, j; b, d, e, g, h, i, j; b, d, f, g, h, i, j; b, e, f, g, h, i, j; c, d, e, f, g, h, i; c, d, e, f, g, h, j; c, d, e, f, g, i, j; c, d, e, f, h, i, j; c, d, e, g, h, i, j; c, d, f, g, h, i, j; c, e, f, g, h, i, j; or d, e, f, g, h, i, j;

g) a, b, c, d, e, f, g, h; a, b, c, d, e, f, g, i; a, b, c, d, e, f, g, j; a, b, c, d, e, f, h, i; a, b, c, d, e, f, h, j; a, b, c, d, e, f, i, j; a, b, c, d, e, g, h, i; a, b, c, d, e, g, h, j; a, b, c, d, e, g, i, j; a, b, c, d, e, h, i, j; a, b, c, d, f, g, h, i; a, b, c, d, f, g, h, j; a, b, c, d, f, g, i, j; a, b, c, d, f, h, i, j; a, b, c, d, g, h, i, j; a, b, c, e, f, g, h, i; a, b, c, e, f, g, h, j; a, b, c, e, f, g, i, j; a, b, c, e, f, h, i, j; a, b, c, e, g, h, i, j; a, b, c, f, g, h, i, j; a, b, d, e, f, g, h, i; a, b, d, e, f, g, h, j; a, b, d, e, f, g, i, j; a, b, d, e, f, h, i, j; a, b, d, e, g, h, i, j; a, b, d, f, g, h, i, j; a, b, e, f, g, h, i, j; a, c, d, e, f, g, h, i; a, c, d, e, f, g, h, j; a, c, d, e, f, g, i, j; a, c, d, e, f, h, i, j; a, c, d, e, g, h, i, j; a, c, d, f, g, h, i, j; a, c, e, f, g, h, i, j; a, d, e, f, g, h, i, j; b, c, d, e, f, g, h, i; b, c, d, e, f, g, h, j; b, c, d, e, f, g, i, j; b, c, d, e, f, h, i, j; b, c, d, e, g, h, i, j; b, c, d, f, g, h, i, j; b, c, e, f, g, h, i, j; b, d, e, f, g, h, i, j; or c, d, e, f, g, h, i, j;

h) a, b, c, d, e, f, g, h, i; a, b, c, d, e, f, g, h, j; a, b, c, d, e, f, g, i, j; a, b, c, d, e, f, h, i, j; a, b, c, d, e, g, h, i, j; a, b, c, d, f, g, h, i, j; a, b, c, e, f, g, h, i, j; a, b, d, e, f, g, h, i, j; a, c, d, e, f, g, h, i, j; or b, c, d, e, f, g, h, i, j; or

i) a, b, c, d, e, f, g, h, i, j, where a=Vanillic acid; b=Syringic acid; c=P-Coumaric acid; d=Silicic acid; e=Cinnamic acid; f=Ferulic acid; g=Fisetin; h=Oxybenzone; i=Orbifloxacin; and j=Rosiglitazone maleate or stereoisomers, tautomers and agriculturally acceptable salts thereof.

8. The composition according to any one of embodiments 1-7, said composition comprising between about 0.1% and about 35% active agent(s) by weight and about 65% to about 99.9% by weight of one or more component selected from: agriculturally suitable solvents, agriculturally suitable carriers, agriculturally suitable surfactants and mixtures thereof.

9. The composition according to any one of embodiments 1-8, said active agents being present in equal amounts, approximately equal amounts, or in amounts of about 0.1 g-100 g for each active agent present in said composition, said amounts being by weight.

10. The composition according to embodiment 9, wherein said active agents are present in equal amounts or approximately equal amounts.

11. The composition according to embodiments 1-10, wherein said active agents are present in an amount of approximately 1 g per liter of an agriculturally acceptable carrier.

12. The composition according to embodiment 11, wherein said active agents are syringic acid, p-coumaric acid, vanillic acid, and cinnamic acid.

13. The composition according to embodiments 11-12, wherein the composition comprises a surfactant selected from crop oil concentrates (COC), methylated seed oils (MSO), high surfactant methylated seed oils (HSMSO), silicone surfactants (SS), non-ionic surfactants (NIS) and mixtures thereof.

14. The composition according to embodiment 11-13, wherein the agriculturally acceptable carrier is water.

15. The composition according to embodiments 1-14, said composition comprising syringic acid, p-coumaric acid, vanillic acid, and cinnamic acid, each of which is present in an amount of about 1 g per liter of an agriculturally acceptable carrier and, optionally, an agriculturally acceptable surfactant.

16. The composition according to embodiments 1-15, said composition further comprising a vitamin, such as vitamin A or vitamin C, and/or crop oils or mixtures thereof.

17. A method of preparing a composition comprising mixing a composition according to any one of embodiments 1-16 with an agriculturally acceptable carrier to form an application formulation.

18. The method according to embodiment 17, wherein the agriculturally acceptable carrier is water.

19. An application formulation produced by the method of embodiment 17 or 18.

20. A method of controlling and/or treating citrus greening in a citrus plant comprising the application of an application formulation according to embodiment 19 to said citrus plant.

21. The method according to embodiment 20, wherein said application formulation is applied as a foliar spray, injection into the phloem, trunk feeding, via irrigation, or drench application to the root system.

22. The method according to embodiment 20 or 21, wherein said citrus plant is selected from the group consisting of an orange, a lemon, a lime, a grapefruit, a clementine, a tangerine, a tangelo and a pomelo tree.

23. A fertilizer or inert carrier comprising:

a) one or more active agent as set forth in Tables 1 and/or 2 or stereoisomers, tautomers and/or agrochemically acceptable salts thereof; or

b) a composition comprising one or more active agent as set forth in Tables 1 and/or 2 or stereoisomers, tautomers and/or agrochemically acceptable salts thereof and one or more component selected from: agriculturally suitable solvents, agriculturally suitable carriers, agriculturally suitable surfactants and mixtures thereof and one or more component selected from: agriculturally suitable solvents, agriculturally suitable carriers, agriculturally suitable surfactants and mixtures thereof.

24. The fertilizer or inert carrier according to embodiment 23, wherein the fertilizer or inert carrier comprises one of the following combinations of active agents:

a) a, b; a, c; a, d; a, e; a, f; a, g; a, h; a, i; a, j; b, c; b, d, b, e; b, f, b, g; b, h; b, i; b, j; c, d; c, e; c, f, c, g; c, h; c, i; c, j; d, e; d, f, d, g; d, h; d, i; d, j; e, f; e, g; e, h; e, i; e, j; f, g; f, h; f, i; f, j; g, h; g, i; g, j; h, i; h, j; or i, j;

b) a, b, c; a, b, d; a, b, e; a, b, f; a, b, g; a, b, h; a, b, i; a, b, j; a, c, d; a, c, e; a, c, f; a, c, g; a, c, h; a, c, i; a, c, j; a, d, e; a, d, f; a, d, g; a, d, h; a, d, i; a, d, j; a, e, f; a, e, g; a, e, h; a, e, i; a, e, j; a, f, g; a, f, h; a, f, i; a, f, j; a, g, h; a, g, i; a, g, j; a, h, i; a, h, j; a, i, j; b, c, d; b, c, e; b, c, f; b, c, g; b, c, h; b, c, i; b, c, j; b, d, e; b, d, f, b, d, g; b, d, h; b, d, i; b, d, j; b, e, f, b, e, g; b, e, h; b, e, i; b, e, j; b, f, g; b, f, h; b, f, i; b, f, j; b, g, h; b, g, i; b, g, j; b, h, i; b, h, j; b, i, j; c, d, e; c, d, f, c, d, g; c, d, h; c, d, i; c, d, j; c, e, f; c, e, g; c, e, h; c, e, i; c, e, j; c, f, g; c, f, h; c, f, i; c, f, j; c, g, h; c, g, i; c, g, j; c, h, i; c, h, j; c, i, j; d, e, f; d, e, g; d, e, h; d, e, i; d, e, j; d, f, g; d, f, h; d, f, i; d, f, j; d, g, h; d, g, i; d, g, j; d, h, i; d, h, j; d, i, j; e, f, g; e, f, h; e, f, i; e, f, j; e, g, h; e, g, i; e, g, j; e, h, i; e, h, j; e, i, j; f, g, h; f, g, i; f, g, j; f, h, i; f, h, j; f, i, j; g, h, i; g, h, j; g, i, j; or h, i, j;

c) a, b, c, d; a, b, c, e; a, b, c, f, a, b, c, g; a, b, c, h; a, b, c, i; a, b, c, j; a, b, d, e; a, b, d, f, a, b, d, g; a, b, d, h; a, b, d, i; a, b, d, j; a, b, e, f, a, b, e, g; a, b, e, h; a, b, e, i; a, b, e, j; a, b, f, g; a, b, f, h; a, b, f, i; a, b, f, j; a, b, g, h; a, b, g, i; a, b, g, j; a, b, h, i; a, b, h, j; a, b, i, j; a, c, d, e; a, c, d, f, a, c, d, g; a, c, d, h; a, c, d, i; a, c, d, j; a, c, e, f; a, c, e, g; a, c, e, h; a, c, e, i; a, c, e, j; a, c, f, g; a, c, f, h; a, c, f, i; a, c, f, j; a, c, g, h; a, c, g, i; a, c, g, j; a, c, h, i; a, c, h, j; a, c, i, j; a, d, e, f; a, d, e, g; a, d, e, h; a, d, e, i; a, d, e, j; a, d, f, g; a, d, f, h; a, d, f, i; a, d, f, j; a, d, g, h; a, d, g, i; a, d, g, j; a, d, h, i; a, d, h, j; a, d, i, j; a, e, f, g; a, e, f, h; a, e, f, i; a, e, f, j; a, e, g, h; a, e, g, i; a, e, g, j; a, e, h, i; a, e, h, j; a, e, i, j; a, f, g, h; a, f, g, i; a, f, g, j; a, f, h, i; a, f, h, j; a, f, i, j; a, g, h, i; a, g, h, j; a, g, i, j; a, h, i, j; b, c, d, e; b, c, d, f; b, c, d, g; b, c, d, h; b, c, d, i; b, c, d, j; b, c, e, f; b, c, e, g; b, c, e, h; b, c, e, i; b, c, e, j; b, c, f, g; b, c, f, h; b, c, f, i; b, c, f, j; b, c, g, h; b, c, g, i; b, c, g, j; b, c, h, i; b, c, h, j; b, c, i, j; b, d, e, f; b, d, e, g; b, d, e, h; b, d, e, i; b, d, e, j; b, d, f, g; b, d, f, h; b, d, f, i; b, d, f, j; b, d, g, h; b, d, g, i; b, d, g, j; b, d, h, i; b, d, h, j; b, d, i, j; b, e, f, g; b, e, f, h; b, e, f, i; b, e, f, j; b, e, g, h; b, e, g, i; b, e, g, j; b, e, h, i; b, e, h, j; b, e, i, j; b, f, g, h; b, f, g, i; b, f, g, j; b, f, h, i; b, f, h, j; b, f, i, j; b, g, h, i; b, g, h, j; b, g, i, j; b, h, i, j; c, d, e, f; c, d, e, g; c, d, e, h; c, d, e, i; c, d, e, j; c, d, f, g; c, d, f, h; c, d, f, i; c, d, f, j; c, d, g, h; c, d, g, i; c, d, g, j; c, d, h, i; c, d, h, j; c, d, i, j; c, e, f, g; c, e, f, h; c, e, f, i; c, e, f, j; c, e, g, h; c, e, g, i; c, e, g, j; c, e, h, i; c, e, h, j; c, e, i, j; c, f, g, h; c, f, g, i; c, f, g, j; c, f, h, i; c, f, h, j; c, f, i, j; c, g, h, i; c, g, h, j; c, g, i, j; c, h, i, j; d, e, f, g; d, e, f, h; d, e, f, i; d, e, f, j; d, e, g, h; d, e, g, i; d, e, g, j; d, e, h, i; d, e, h, j; d, e, i, j; d, f, g, h; d, f, g, i; d, f, g, j; d, f, h, i; d, f, h, j; d, f, i, j; d, g, h, i; d, g, h, j; d, g, i, j; d, h, i, j; e, f, g, h; e, f, g, i; e, f, g, j; e, f, h, i; e, f, h, j; e, f, i, j; e, g, h, i; e, g, h, j; e, g, i, j; e, h, i, j; f, g, h, i; f, g, h, j; f, g, i, j; f, h, i, j; or g, h, i, j;

d) a, b, c, d, e; a, b, c, d, f; a, b, c, d, g; a, b, c, d, h; a, b, c, d, i; a, b, c, d, j; a, b, c, e, f, a, b, c, e, g; a, b, c, e, h; a, b, c, e, i; a, b, c, e, j; a, b, c, f, g; a, b, c, f, h; a, b, c, f, i; a, b, c, f, j; a, b, c, g, h; a, b, c, g, i; a, b, c, g, j; a, b, c, h, i; a, b, c, h, j; a, b, c, i, j; a, b, d, e, f; a, b, d, e, g; a, b, d, e, h; a, b, d, e, i; a, b, d, e, j; a, b, d, f, g; a, b, d, f, h; a, b, d, f, i; a, b, d, f, j; a, b, d, g, h; a, b, d, g, i; a, b, d, g, j; a, b, d, h, i; a, b, d, h, j; a, b, d, i, j; a, b, e, f, g; a, b, e, f, h; a, b, e, f, i; a, b, e, f, j; a, b, e, g, h; a, b, e, g, i; a, b, e, g, j; a, b, e, h, i; a, b, e, h, j; a, b, e, i, j; a, b, f, g, h; a, b, f, g, i; a, b, f, g, j; a, b, f, h, i; a, b, f, h, j; a, b, f, i, j; a, b, g, h, i; a, b, g, h, j; a, b, g, i, j; a, b, h, i, j; a, c, d, e, f, a, c, d, e, g; a, c, d, e, h; a, c, d, e, i; a, c, d, e, j; a, c, d, f, g; a, c, d, f, h; a, c, d, f, i; a, c, d, f, j; a, c, d, g, h; a, c, d, g, i; a, c, d, g, j; a, c, d, h, i; a, c, d, h, j; a, c, d, i, j; a, c, e, f, g; a, c, e, f, h; a, c, e, f, i; a, c, e, f, j; a, c, e, g, h; a, c, e, g, i; a, c, e, g, j; a, c, e, h, i; a, c, e, h, j; a, c, e, i, j; a, c, f, g, h; a, c, f, g, i; a, c, f, g, j; a, c, f, h, i; a, c, f, h, j; a, c, f, i, j; a, c, g, h, i; a, c, g, h, j; a, c, g, i, j; a, c, h, i, j; a, d, e, f, g; a, d, e, f, h; a, d, e, f, i; a, d, e, f, j; a, d, e, g, h; a, d, e, g, i; a, d, e, g, j; a, d, e, h, i; a, d, e, h, j; a, d, e, i, j; a, d, f, g, h; a, d, f, g, i; a, d, f, g, j; a, d, f, h, i; a, d, f, h, j; a, d, f, i, j; a, d, g, h, i; a, d, g, h, j; a, d, g, i, j; a, d, h, i, j; a, e, f, g, h; a, e, f, g, i; a, e, f, g, j; a, e, f, h, i; a, e, f, h, j; a, e, f, i, j; a, e, g, h, i; a, e, g, h, j; a, e, g, i, j; a, e, h, i, j; a, f, g, h, i; a, f, g, h, j; a, f, g, i, j; a, f, h, i, j; a, g, h, i, j; b, c, d, e, f; b, c, d, e, g; b, c, d, e, h; b, c, d, e, i; b, c, d, e, j; b, c, d, f, g; b, c, d, f, h; b, c, d, f, i; b, c, d, f, j; b, c, d, g, h; b, c, d, g, i; b, c, d, g, j; b, c, d, h, i; b, c, d, h, j; b, c, d, i, j; b, c, e, f, g; b, c, e, f, h; b, c, e, f, i; b, c, e, f, j; b, c, e, g, h; b, c, e, g, i; b, c, e, g, j; b, c, e, h, i; b, c, e, h, j; b, c, e, i, j; b, c, f, g, h; b, c, f, g, i; b, c, f, g, j; b, c, f, h, i; b, c, f, h, j; b, c, f, i, j; b, c, g, h, i; b, c, g, h, j; b, c, g, i, j; b, c, h, i, j; b, d, e, f, g; b, d, e, f, h; b, d, e, f, i; b, d, e, f, j; b, d, e, g, h; b, d, e, g, i; b, d, e, g, j; b, d, e, h, i; b, d, e, h, j; b, d, e, i, j; b, d, f, g, h; b, d, f, g, i; b, d, f, g, j; b, d, f, h, i; b, d, f, h, j; b, d, f, i, j; b, d, g, h, i; b, d, g, h, j; b, d, g, i, j; b, d, h, i, j; b, e, f, g, h; b, e, f, g, i; b, e, f, g, j; b, e, f, h, i; b, e, f, h, j; b, e, f, i, j; b, e, g, h, i; b, e, g, h, j; b, e, g, i, j; b, e, h, i, j; b, f, g, h, i; b, f, g, h, j; b, f, g, i, j; b, f, h, i, j; b, g, h, i, j; c, d, e, f, g; c, d, e, f, h; c, d, e, f, i; c, d, e, f, j; c, d, e, g, h; c, d, e, g, i; c, d, e, g, j; c, d, e, h, i; c, d, e, h, j; c, d, e, i, j; c, d, f, g, h; c, d, f, g, i; c, d, f, g, j; c, d, f, h, i; c, d, f, h, j; c, d, f, i, j; c, d, g, h, i; c, d, g, h, j; c, d, g, i, j; c, d, h, i, j; c, e, f, g, h; c, e, f, g, i; c, e, f, g, j; c, e, f, h, i; c, e, f, h, j; c, e, f, i, j; c, e, g, h, i; c, e, g, h, j; c, e, g, i, j; c, e, h, i, j; c, f, g, h, i; c, f, g, h, j; c, f, g, i, j; c, f, h, i, j; c, g, h, i, j; d, e, f, g, h; d, e, f, g, i; d, e, f, g, j; d, e, f, h, i; d, e, f, h, j; d, e, f, i, j; d, e, g, h, i; d, e, g, h, j; d, e, g, i, j; d, e, h, i, j; d, f, g, h, i; d, f, g, h, j; d, f, g, i, j; d, f, h, i, j; d, g, h, i, j; e, f, g, h, i; e, f, g, h, j; e, f, g, i, j; e, f, h, i, j; e, g, h, i, j; or f, g, h, i, j;

e) a, b, c, d, e, f; a, b, c, d, e, g; a, b, c, d, e, h; a, b, c, d, e, i; a, b, c, d, e, j; a, b, c, d, f, g; a, b, c, d, f, h; a, b, c, d, f, i; a, b, c, d, f, j; a, b, c, d, g, h; a, b, c, d, g, i; a, b, c, d, g, j; a, b, c, d, h, i; a, b, c, d, h, j; a, b, c, d, i, j; a, b, c, e, f, g; a, b, c, e, f, h; a, b, c, e, f, i; a, b, c, e, f, j; a, b, c, e, g, h; a, b, c, e, g, i; a, b, c, e, g, j; a, b, c, e, h, i; a, b, c, e, h, j; a, b, c, e, i, j; a, b, c, f, g, h; a, b, c, f, g, i; a, b, c, f, g, j; a, b, c, f, h, i; a, b, c, f, h, j; a, b, c, f, i, j; a, b, c, g, h, i; a, b, c, g, h, j; a, b, c, g, i, j; a, b, c, h, i, j; a, b, d, e, f, g; a, b, d, e, f, h; a, b, d, e, f, i; a, b, d, e, f, j; a, b, d, e, g, h; a, b, d, e, g, i; a, b, d, e, g, j; a, b, d, e, h, i; a, b, d, e, h, j; a, b, d, e, i, j; a, b, d, f, g, h; a, b, d, f, g, i; a, b, d, f, g, j; a, b, d, f, h, i; a, b, d, f, h, j; a, b, d, f, i, j; a, b, d, g, h, i; a, b, d, g, h, j; a, b, d, g, i, j; a, b, d, h, i, j; a, b, e, f, g, h; a, b, e, f, g, i; a, b, e, f, g, j; a, b, e, f, h, i; a, b, e, f, h, j; a, b, e, f, i, j; a, b, e, g, h, i; a, b, e, g, h, j; a, b, e, g, i, j; a, b, e, h, i, j; a, b, f, g, h, i; a, b, f, g, h, j; a, b, f, g, i, j; a, b, f, h, i, j; a, b, g, h, i, j; a, c, d, e, f, g; a, c, d, e, f, h; a, c, d, e, f, i; a, c, d, e, f, j; a, c, d, e, g, h; a, c, d, e, g, i; a, c, d, e, g, j; a, c, d, e, h, i; a, c, d, e, h, j; a, c, d, e, i, j; a, c, d, f, g, h; a, c, d, f, g, i; a, c, d, f, g, j; a, c, d, f, h, i; a, c, d, f, h, j; a, c, d, f, i, j; a, c, d, g, h, i; a, c, d, g, h, j; a, c, d, g, i, j; a, c, d, h, i, j; a, c, e, f, g, h; a, c, e, f, g, i; a, c, e, f, g, j; a, c, e, f, h, i; a, c, e, f, h, j; a, c, e, f i, j; a, c, e, g, h, i; a, c, e, g, h, j; a, c, e, g, i, j; a, c, e, h, i, j; a, c, f, g, h, i; a, c, f, g, h, j; a, c, f, g, i, j; a, c, f, h, i, j; a, c, g, h, i, j; a, d, e, f, g, h; a, d, e, f, g, i; a, d, e, f, g, j; a, d, e, f, h, i; a, d, e, f, h, j; a, d, e, f, i, j; a, d, e, g, h, i; a, d, e, g, h, j; a, d, e, g, i, j; a, d, e, h, i, j; a, d, f, g, h, i; a, d, f, g, h, j; a, d, f, g, i, j; a, d, f, h, i, j; a, d, g, h, i, j; a, e, f, g, h, i; a, e, f, g, h, j; a, e, f, g, i, j; a, e, f, h, i, j; a, e, g, h, i, j; a, f, g, h, i, j; b, c, d, e, f, g; b, c, d, e, f, h; b, c, d, e, f, i; b, c, d, e, f, j; b, c, d, e, g, h; b, c, d, e, g, i; b, c, d, e, g, j; b, c, d, e, h, i; b, c, d, e, h, j; b, c, d, e, i, j; b, c, d, f, g, h; b, c, d, f, g, i; b, c, d, f, g, j; b, c, d, f, h, i; b, c, d, f, h, j; b, c, d, f, i, j; b, c, d, g, h, i; b, c, d, g, h, j; b, c, d, g, i, j; b, c, d, h, i, j; b, c, e, f, g, h; b, c, e, f, g, i; b, c, e, f, g, j; b, c, e, f, h, i; b, c, e, f, h, j; b, c, e, f, i, j; b, c, e, g, h, i; b, c, e, g, h, j; b, c, e, g, i, j; b, c, e, h, i, j; b, c, f, g, h, i; b, c, f, g, h, j; b, c, f, g, i, j; b, c, f, h, i, j; b, c, g, h, i, j; b, d, e, f, g, h; b, d, e, f, g, i; b, d, e, f, g, j; b, d, e, f, h, i; b, d, e, f, h, j; b, d, e, f, i, j; b, d, e, g, h, i; b, d, e, g, h, j; b, d, e, g, i, j; b, d, e, h, i, j; b, d, f, g, h, i; b, d, f, g, h, j; b, d, f, g, i, j; b, d, f, h, i, j; b, d, g, h, i, j; b, e, f, g, h, i; b, e, f, g, h, j; b, e, f, g, i, j; b, e, f, h, i, j; b, e, g, h, i, j; b, f, g, h, i, j; c, d, e, f, g, h; c, d, e, f, g, i; c, d, e, f, g, j; c, d, e, f, h, i; c, d, e, f, h, j; c, d, e, f, i, j; c, d, e, g, h, i; c, d, e, g, h, j; c, d, e, g, i, j; c, d, e, h, i, j; c, d, f, g, h, i; c, d, f, g, h, j; c, d, f, g, i, j; c, d, f, h, i, j; c, d, g, h, i, j; c, e, f, g, h, i; c, e, f, g, h, j; c, e, f, g, i, j; c, e, f, h, i, j; c, e, g, h, i, j; c, f, g, h, i, j; d, e, f, g, h, i; d, e, f, g, h, j; d, e, f, g, i, j; d, e, f, h, i, j; d, e, g, h, i, j; d, f, g, h, i, j; or e, f, g, h, i, j;

f) a, b, c, d, e, f, g; a, b, c, d, e, f, h; a, b, c, d, e, f, i; a, b, c, d, e, f, j; a, b, c, d, e, g, h; a, b, c, d, e, g, i; a, b, c, d, e, g, j; a, b, c, d, e, h, i; a, b, c, d, e, h, j; a, b, c, d, e, i, j; a, b, c, d, f, g, h; a, b, c, d, f, g, i; a, b, c, d, f, g, j; a, b, c, d, f, h, i; a, b, c, d, f, h, j; a, b, c, d, f, i, j; a, b, c, d, g, h, i; a, b, c, d, g, h, j; a, b, c, d, g, i, j; a, b, c, d, h, i, j; a, b, c, e, f, g, h; a, b, c, e, f, g, i; a, b, c, e, f, g, j; a, b, c, e, f, h, i; a, b, c, e, f, h, j; a, b, c, e, f, i, j; a, b, c, e, g, h, i; a, b, c, e, g, h, j; a, b, c, e, g, i, j; a, b, c, e, h, i, j; a, b, c, f, g, h, i; a, b, c, f, g, h, j; a, b, c, f, g, i, j; a, b, c, f, h, i, j; a, b, c, g, h, i, j; a, b, d, e, f, g, h; a, b, d, e, f, g, i; a, b, d, e, f, g, j; a, b, d, e, f, h, i; a, b, d, e, f, h, j; a, b, d, e, f, i, j; a, b, d, e, g, h, i; a, b, d, e, g, h, j; a, b, d, e, g, i, j; a, b, d, e, h, i, j; a, b, d, f, g, h, i; a, b, d, f, g, h, j; a, b, d, f, g, i, j; a, b, d, f, h, i, j; a, b, d, g, h, i, j; a, b, e, f, g, h, i; a, b, e, f, g, h, j; a, b, e, f, g, i, j; a, b, e, f, h, i, j; a, b, e, g, h, i, j; a, b, f, g, h, i, j; a, c, d, e, f, g, h; a, c, d, e, f, g, i; a, c, d, e, f, g, j; a, c, d, e, f, h, i; a, c, d, e, f, h, j; a, c, d, e, f, i, j; a, c, d, e, g, h, i; a, c, d, e, g, h, j; a, c, d, e, g, i, j; a, c, d, e, h, i, j; a, c, d, f, g, h, i; a, c, d, f, g, h, j; a, c, d, f, g, i, j; a, c, d, f, h, i, j; a, c, d, g, h, i, j; a, c, e, f, g, h, i; a, c, e, f, g, h, j; a, c, e, f, g, i, j; a, c, e, f, h, i, j; a, c, e, g, h, i, j; a, c, f, g, h, i, j; a, d, e, f, g, h, i; a, d, e, f, g, h, j; a, d, e, f, g, i, j; a, d, e, f, h, i, j; a, d, e, g, h, i, j; a, d, f, g, h, i, j; a, e, f, g, h, i, j; b, c, d, e, f, g, h; b, c, d, e, f, g, i; b, c, d, e, f, g, j; b, c, d, e, f, h, i; b, c, d, e, f, h, j; b, c, d, e, f, i, j; b, c, d, e, g, h, i; b, c, d, e, g, h, j; b, c, d, e, g, i, j; b, c, d, e, h, i, j; b, c, d, f, g, h, i; b, c, d, f, g, h, j; b, c, d, f, g, i, j; b, c, d, f, h, i, j; b, c, d, g, h, i, j; b, c, e, f, g, h, i; b, c, e, f, g, h, j; b, c, e, f, g, i, j; b, c, e, f, h, i, j; b, c, e, g, h, i, j; b, c, f, g, h, i, j; b, d, e, f, g, h, i; b, d, e, f, g, h, j; b, d, e, f, g, i, j; b, d, e, f, h, i, j; b, d, e, g, h, i, j; b, d, f, g, h, i, j; b, e, f, g, h, i, j; c, d, e, f, g, h, i; c, d, e, f, g, h, j; c, d, e, f, g, i, j; c, d, e, f, h, i, j; c, d, e, g, h, i, j; c, d, f, g, h, i, j; c, e, f, g, h, i, j; or d, e, f, g, h, i, j;

g) a, b, c, d, e, f, g, h; a, b, c, d, e, f, g, i; a, b, c, d, e, f, g, j; a, b, c, d, e, f, h, i; a, b, c, d, e, f, h, j; a, b, c, d, e, f, i, j; a, b, c, d, e, g, h, i; a, b, c, d, e, g, h, j; a, b, c, d, e, g, i, j; a, b, c, d, e, h, i, j; a, b, c, d, f, g, h, i; a, b, c, d, f, g, h, j; a, b, c, d, f, g, i, j; a, b, c, d, f, h, i, j; a, b, c, d, g, h, i, j; a, b, c, e, f, g, h, i; a, b, c, e, f, g, h, j; a, b, c, e, f, g, i, j; a, b, c, e, f, h, i, j; a, b, c, e, g, h, i, j; a, b, c, f, g, h, i, j; a, b, d, e, f, g, h, i; a, b, d, e, f, g, h, j; a, b, d, e, f, g, i, j; a, b, d, e, f, h, i, j; a, b, d, e, g, h, i, j; a, b, d, f, g, h, i, j; a, b, e, f, g, h, i, j; a, c, d, e, f, g, h, i; a, c, d, e, f, g, h, j; a, c, d, e, f, g, i, j; a, c, d, e, f, h, i, j; a, c, d, e, g, h, i, j; a, c, d, f, g, h, i, j; a, c, e, f, g, h, i, j; a, d, e, f, g, h, i, j; b, c, d, e, f, g, h, i; b, c, d, e, f, g, h, j; b, c, d, e, f, g, i, j; b, c, d, e, f, h, i, j; b, c, d, e, g, h, i, j; b, c, d, f, g, h, i, j; b, c, e, f, g, h, i, j; b, d, e, f, g, h, i, j; or c, d, e, f, g, h, i, j;

h) a, b, c, d, e, f, g, h, i; a, b, c, d, e, f, g, h, j; a, b, c, d, e, f, g, i, j; a, b, c, d, e, f, h, i, j; a, b, c, d, e, g, h, i, j; a, b, c, d, f, g, h, i, j; a, b, c, e, f, g, h, i, j; a, b, d, e, f, g, h, i, j; a, c, d, e, f, g, h, i, j; or b, c, d, e, f, g, h, i, j; or

i) a, b, c, d, e, f, g, h, i, j,

where a=Vanillic acid; b=Syringic acid; c=P-Coumaric acid; d=Silicic acid; e=Cinnamic acid; f=Ferulic acid; g=Fisetin; h=Oxybenzone; i=Orbifloxacin; and j=Rosiglitazone maleate and stereoisomers, tautomers and agriculturally acceptable salts thereof.

25. The fertilizer or inert carrier according to embodiment 23 or 24, wherein the fertilizer or inert carrier comprises p-coumaric acid, syringic acid, vanillic acid, and cinnamic acid or stereoisomers, tautomers and agriculturally acceptable salts thereof or a composition thereof as set forth in embodiment 23.

26. The fertilizer or inert carrier according to embodiment 25, said active agents being present in the fertilizer or inert carrier in equal amounts or approximately equal amounts.

27. The fertilizer or inert carrier according to any one of embodiments 24-27, wherein the composition added to said fertilizer or inert carrier further comprises a vitamin, vitamin A, vitamin C, one or more crop oil, and mixtures thereof.

28. A method of controlling and/or treating citrus greening in a citrus plant comprising the application of fertilizer according to any one of embodiments 23-27 to said citrus plant or to soil around said citrus plant.

I claim:

1. A composition comprising one or more compound as set forth in Table 1 and/or Table 2 or stereoisomers, tautomers and/or agrochemically acceptable salts thereof (active agent) and one or more component selected from: agriculturally suitable solvents, agriculturally suitable carriers, agriculturally suitable surfactants and mixtures thereof.

2. The composition according to claim 1, wherein said agriculturally suitable solvent is: a polar organic solvent, a non-polar organic solvent, ketone, acetone, methyl ethyl ketone, methyl isobutyl ketone, cyclohexanone, amide, dimethyl formamide, alkanecarboxylic acid amide, N,N-dimethyl decaneamide, N,N-dimethyl octanamide, cyclic solvent, N-methyl-pyrrolidone, N-octyl-pyrrolidone, N-dodecyl-pyrrolidone, N-octyl-caprolactame, N-dodecyl-caprolactame, butyrolactone, a strong polar solvent, dimethylsulfoxide, aromatic hydrocarbons, xylol, mineral oils, white spirit, petroleum, alkyl benzene, spindle oil, ester, propyleneglycol-monomethylether acetate, adipic acid dibutylester, acetic acid hexylester, acetic acid heptylester, citric acid tri-n-butylester, phthalic acid di-n-butylester, alcohol, methanol, ethanol, propanol, benzyl alcohol, 1-methoxy-2-propanol, water or mixtures thereof.

3. The composition according to claim 1, wherein the agriculturally acceptable carrier is selected from water, an alcohol, ethanol, propanol, butanol, organic solvent, mineral oil, vegetable oil, and mixtures thereof.

4. The composition according to claim 1, wherein the agriculturally acceptable surfactant is selected from salts of polyacrylic acid, salts of lignosulfonic acid, salts of phenolsulfonic acid, naphthalenesulfonic acid, polycondensates of ethylene oxide with fatty alcohols, fatty acids or fatty amines, substituted phenols, alkylphenols, arylphenols), salts of sulfosuccinic esters, taurine derivatives, alkyl taurates, phosphoric esters of polyethoxylated alcohols or phenols, fatty esters of polyols, ethoxylated nonylphenols, polyalkylene glycolether of linear or branched alcohols, reaction products of alkyl phenols with ethylene oxide and/or propylene oxide, reaction products of fatty acid amines with ethylene oxide and/or propylene oxide, fattic acid esters, alkyl sulfonates, alkyl sulfates, alkyl ethersulfates, alkyl etherphosphates, arylsulfate, ethoxylated arylalkylphenols, tristyryl-phenol-ethoxylates, ethoxylated and propoxylated arylalkylphenols, sulfated or phosphated arylalkylphenol-ethoxylates, sulfated or phosphated ethoxy-propoxylates, lignosulfonates, gelatin, gum arabic, phospholipids, starch, hydrophobic modified starch and cellulose derivatives, cellulose ester, cellulose ether, polyvinyl alcohol, polyvinyl acetate, polyvinyl pyrrolidone, polyacrylic acid, crop oil concentrates organic (COC), methylated seed oils (MSO), high surfactant methylated seed oils (HSMSO), silicone surfactants (SS), non-ionic surfactants (NIS)polymethacrylic acid and co-polymerisates of (meth)acrylic acid and (meth)acrylic acid esters, and mixtures thereof.

5. The composition according to claim 1, wherein the active agent(s) are present in an amount of about 0.05% and about 99% by weight and agriculturally suitable solvents, agriculturally suitable carriers, and/or agriculturally suitable surfactants are present in an amount of between about 0.05% and about 99% by weight.

6. The composition according to claim 5, said composition comprising (−)-Ephedrine hemisulfate; [4-(4-arsonobenzyl)phenyl]arsonic acid; 1-Butanone, 1-(3-chlorophenyl)-4,4,4-trifluoro-3-hydroxy-3-(trifluoromethyl)-, oxime; 1,3-bis(4-amino-2-methyl-6-quinolyl)urea; 1,4-naphthoquinone; 2-(1,3-benzoxazol-3(2H)-ylmethyl)-5-((cyclohexylamino)methyl)-1,4-benzenediol; 2-[2-(carboxylatomethyl-(carboxymethyl)amino)ethyl-(carboxymethyl)amino]acetate; mercury(+2) cation; 2-aminophenol; antimony; (2S,3R)-2,3-dihydroxybutanedioic acid; hydrate; 2,3-dichloro-5,8-dihydroxynaphthoquinone; 21-O-Acetylstreptovaricinoic acid methyl ester; 4-(((8-hydroxy-7-quinolinyl)(phenyl)methyl)amino)benzoic acid; 4-Chloromercuribenzoic acid; 5-Fluorocytosine; 5-Fluorouracil (2; inactive LdtR LOPAC); 7-[(8-hydroxy-5-nitro-7-quinolyl)methyl]-5-nitro-quinolin-8-ol; calcimycin; A Mithracin; actinomycin D (2); Auranofin; Azithromycin (2); Bactobolin Propanamide; Bay 11-7082; Bay 11-7085; Benzalkonium chloride; beta-Thujaplicin; Bithionate sodium; Bleomycin A5-sulfate; Bromocopper; (dipyridin-2-ylmethylideneamino)-(methylsulfanyl-sulfoniumylidene-methyl)azanide; Broxyquinoline; Carmofur (3); Cetylpyridinium chloride; Chaetochromin; Chloramphenicol (2); Chloramphenicol Hemisuccinate; Chlorhexidine; Chloroacetoxyquinoline; Chloroxine; Ciclopirox Olamine; Ciprofloxacin; Clarithromycin (2; inactive LdtR & RpoH NIHCC); Clinafloxacin; Clioquinol; Closantel; Cloxyquin; CLTC U-6780 B-Aureo Tetra 5; Auxeomycin Clorocipan Isphamycin Aureocarmyl (2); Colistimethate Sodium; Colistin Sulfate; copper; [(6-methylpyridin-2-yl)methylideneamino]-(methylsulfanyl-sulfoniumylidene-methyl)azanide; Coumermycin A1; Demeclocycline hydrochloride (2); Diethylenetriaminepentaacetic acid (1; inactive LOPAC); Dimercaprol; Diphenyleneiodonium chloride (2); Doxycycline hyclate; Doxycycline hydrochloride (2); Ebselen (2; inactive LdtR & RpoH NIHCC); Echinomycin; Enrofloxacin (3); Erthromycin; Erythromycin Ethylsuccinate; Erythromycin Stearate; Ethionine; FCCP; Fenticlor; Florfenicol; Floxuridine (2); Flucytosine; Fusidic Acid; Fusidic acid sodium; Gatifloxacin (2); Gemifloxacin Mesylate; Gliotoxin; Gramicidin; Hexachlorophene; Hexonic acid, antimony salt; Hinokitol β-Thujaplicin; Hoechst 33342; Kitasamycin; Levofloxacin (3); Linezolide (1; inactive NIHCC); Lomefloxacin hydrochloride (2; inactive LOPAC & VisNR Microsource); Mastoparan; Mechlorethamine; Meclocycline Sulfosalicylate; Mercury, (2-hydroxy-5-nitrophenyl)(6-thioguanosinato-N7,S6)-; Mercury, (4-aminophenyl)(6-thioguanosinato-N7,S6)-; Methylbenzethonium Chloride; Miconazole Nitrate; Minocycline hydrochloride (2); Moxifloxacin HCl; Nadifloxacin; Nanaomycin A; Novobiocin Sodium (2); 2,3-bis[(2-Hydroxyethyl)thiol]-1,4-naphthoquinone; Ouabain; Oxytetracycline; Pazufloxacin (2); Pefloxacin Mesylate (2; inactive NIHCC); Phenylmercuric Acetate; Polymyxin B Sulfate; Pyrithione Zinc; Pyrvinium Pamoate; Ribavirin (2; inactive RpoH Biomol FDA); Rifabutin; Rifampicin; Rifampin; Rifamycin SV; Rifamycin, 3-[(dimethylamino)methyl]-; Rifapentine; Rifaximin (2); Roxithromycin (2); Rufloxacin HCl (2; inactive LdtR & RpoH NIHCC); Sancycline; Siomycin A; Sparfloxacin; Telithromycin; Tetrachloroisophthalonitrile; Tetracycline Hydrochloride; Thimerosal; Tolypomycin Y; Tosufloxacin Tosylate (2); TPEN; Tributylchlorolead; Triclosan; Tyrothricin; Viriditoxin; or combinations thereof as the active agent(s).

7. The composition according to claim 5, said composition comprising Vanillic acid; Syringic acid; P-Coumaric acid; Silicic acid; Cinnamic acid; Ferulic acid; Fisetin; Oxybenzone; Orbifloxacin; Rosiglitazone maleate; and combinations thereof as the active agent(s); or one of the following combinations of active agents:
a) a, b; a, c; a, d; a, e; a, f; a, g; a, h; a, i; a, j; b, c; b, d, b, e; b, f, b, g; b, h; b, i; b, j; c, d; c, e; c, f, c, g; c, h; c, i; c, j; d, e; d, f, d, g; d, h; d, i; d, j; e, f; e, g; e, h; e, i; e, j; f, g; f, h; f, i; f, j; g, h; g, i; g, j; h, i; h, j; or i, j;
b) a, b, c; a, b, d; a, b, e; a, b, f; a, b, g; a, b, h; a, b, i; a, b, j; a, c, d; a, c, e; a, c, f; a, c, g; a, c, h; a, c, i; a, c, j; a, d, e; a, d, f; a, d, g; a, d, h; a, d, i; a, d, j; a, e, f; a, e, g; a, e, h; a, e, i; a, e, j; a, f, g; a, f, h; a, f, i; a, f, j; a, g, h; a, g, i; a, g, j; a, h, i; a, h, j; a, i, j; b, c, d; b, c, e; b, c, f; b, c, g; b, c, h; b, c, i; b, c, j; b, d, e; b, d, f, b, d, g; b, d, h; b, d, i; b, d, j; b, e, f, b, e, g; b, e, h; b, e, i; b, e, j; b, f, g; b, f, h; b, f, i; b, f, j; b, g, h; b, g, i; b, g, j; b, h, i; b, h, j; b, i, j; c, d, e; c, d, f, c, d, g; c, d, h; c, d, i; c, d, j; c, e, f; c, e, g; c, e, h; c, e, i; c, e, j; c, f, g; c, f, h; c, f, i; c, f, j; c, g, h; c, g, i; c, g, j; c, h, i; c, h, j; c, i, j; d, e, f; d, e, g; d, e, h; d, e, i; d, e, j; d, f, g; d, f, h; d, f, i; d, f, j; d, g, h; d, g, i; d, g, j; d, h, i; d, h, j; d, i, j; e, f, g; e, f, h; e, f, i; e, f, j; e, g, h; e, g, i; e, g, j; e, h, i; e, h, j; e, i, j; f, g, h; f, g, i; f, g, j; f, h, i; f, h, j; f, i, j; g, h, i; g, h, j; g, i, j; or h, i, j;
c) a, b, c, d; a, b, c, e; a, b, c, f, a, b, c, g; a, b, c, h; a, b, c, i; a, b, c, j; a, b, d, e; a, b, d, f, a, b, d, g; a, b, d, h; a, b, d, i; a, b, d, j; a, b, e, f, a, b, e, g; a, b, e, h; a, b, e, i; a, b, e, j; a, b, f, g; a, b, f, h; a, b, f, i; a, b, f, j; a, b, g, h; a, b, g, i; a, b, g, j; a, b, h, i; a, b, h, j; a, b, i, j; a, c, d, e; a, c, d, f, a, c, d, g; a, c, d, h; a, c, d, i; a, c, d, j; a, c, e, f; a, c, e, g; a, c, e, h; a, c, e, i; a, c, e, j; a, c, f, g; a, c, f, h; a, c, f, i; a, c, f, j; a, c, g, h; a, c, g, i; a, c, g, j; a, c, h, i; a, c, h, j; a, c, i, j; a, d, e, f, a, d, e, g; a, d, e, h; a, d, e, i; a, d, e, j; a, d, f, g; a, d, f, h; a, d, f, i; a, d, f, j; a, d, g, h; a, d, g, i; a, d, g, j; a, d, h, i; a, d, h, j; a, d, i, j; a, e, f, g; a, e, f, h; a, e, f, i; a, e, f, j; a, e, g, h; a, e, g, i; a, e, g, j; a, e, h, i; a, e, h, j; a, e, i, j; a, f, g, h; a, f, g, i; a, f, g, j; a, f, h, i; a, f, h, j; a, f, i, j; a, g, h, i; a, g, h, j; a, g, i, j; a, h, i, j; b, c, d, e; b, c, d, f; b, c, d, g; b, c, d, h; b, c, d, i; b, c, d, j; b, c, e, f; b, c, e, g; b, c, e, h; b, c, e, i; b, c, e, j; b, c, f, g; b, c, f, h; b, c, f, i; b, c, f, j; b, c, g, h; b, c, g, i; b, c, g, j; b, c, h, i; b, c, h, j; b, c, i, j; b, d, e, f; b, d, e, g; b, d, e, h; b, d, e, i; b, d, e, j; b, d, f, g; b, d, f, h; b, d, f, i; b, d, f, j; b, d, g, h; b, d, g, i; b, d, g, j; b, d, h, i; b, d, h, j; b, d, i, j; b, e, f, g; b, e, f, h; b, e, f, i; b, e, f, j; b, e, g, h; b, e, g, i; b, e, g, j; b, e, h, i; b, e, h, j; b, e, i, j; b, f, g, h; b, f, g, i; b, f, g, j; b, f, h, i; b, f, h, j; b, f, i, j; b, g, h, i; b, g, h, j; b, g, i, j; b, h, i, j; c, d, e, f; c, d, e, g; c, d, e, h; c, d, e, i; c, d, e, j; c, d, f, g; c, d, f, h; c, d, f, i; c, d, f, j; c, d, g, h; c, d, g, i; c, d, g, j; c, d, h, i; c, d, h, j; c, d, i, j; c, e, f, g; c, e, f, h; c, e, f, i; c, e, f, j; c, e, g, h; c, e, g, i; c, e, g, j; c, e, h, i; c, e, h, j; c, e, i, j; c, f, g, h; c, f, g, i; c, f, g, j; c, f, h, i; c, f, h, j; c, f, i, j; c, g, h, i; c, g, h, j; c, g, i, j; c, h, i, j; d, e, f, g; d, e, f, h; d, e, f, i; d, e, f, j; d, e, g, h; d, e, g, i; d, e, g, j; d, e, h, i; d, e, h, j; d, e, i, j; d, f, g, h; d, f, g, i; d, f, g, j; d, f, h, i; d, f, h, j; d, f, i, j; d, g, h, i; d, g, h, j; d, g, i, j; d, h, i, j; e, f, g, h; e, f, g, i; e, f, g, j; e, f, h, i; e, f, h, j; e, f, i, j; e, g, h, i; e, g, h, j; e, g, i, j; e, h, i, j; f, g, h, i; f, g, h, j; f, g, i, j; f, h, i, j; or g, h, i, j;
d) a, b, c, d, e; a, b, c, d, f; a, b, c, d, g; a, b, c, d, h; a, b, c, d, i; a, b, c, d, j; a, b, c, e, f; a, b, c, e, g; a, b, c, e, h; a, b, c, e, i; a, b, c, e, j; a, b, c, f, g; a, b, c, f, h; a, b, c, f, i; a, b, c, f, j; a, b, c, g, h; a, b, c, g, i; a, b, c, g, j; a, b, c, h, i; a, b, c, h, j; a, b, c, i, j; a, b, d, e, f; a, b, d, e, g; a, b, d, e, h; a, b, d, e, i; a, b, d, e, j; a, b, d, f, g; a, b, d, f, h; a, b, d, f, i; a, b, d, f, j; a, b, d, g, h; a, b, d, g, i; a, b, d, g, j; a, b, d, h, i; a, b, d, h, j; a, b, d, i, j; a, b, e, f, g; a, b, e, f, h; a, b, e, f, i; a, b, e, f, j; a, b, e, g, h; a, b, e, g, i; a, b, e, g, j; a, b, e, h, i; a, b, e, h, j; a, b, e, i, j; a, b, f, g, h; a, b, f, g, i; a, b, f, g, j; a, b, f, h, i; a, b, f, h, j; a, b, f, i, j; a, b, g, h, i; a, b, g, h, j; a, b, g, i, j; a, b, h, i, j; a, c, d, e, f; a, c, d, e, g; a, c, d, e, h; a, c, d, e, i; a, c, d, e, j; a, c, d, f, g; a, c, d, f, h; a, c, d, f, i; a, c, d, f, j; a, c, d, g, h; a, c, d, g, i; a, c, d, g, j; a, c, d, h, i; a, c, d, h, j; a, c, d, i, j; a, c, e, f, g; a, c, e, f, h; a, c, e, f, i; a, c, e, f, j; a, c, e, g, h; a, c, e, g, i; a, c, e, g, j; a, c, e, h, i; a, c, e, h, j; a, c, e, i, j; a, c, f, g, h; a, c, f, g, i; a, c, f, g, j; a, c, f, h, i; a, c, f, h, j; a, c, f, i, j; a, c, g, h, i; a, c, g, h, j; a, c, g, i, j; a, c, h, i, j; a, d, e, f, g; a, d, e, f, h; a, d, e, f, i; a, d, e, f, j; a, d, e, g, h; a, d, e, g, i; a, d, e, g, j; a, d, e, h, i; a, d, e, h, j; a, d, e, i, j; a, d, f, g, h; a, d, f, g, i; a, d, f, g, j; a, d, f, h, i; a, d, f, h, j; a, d, f, i, j; a, d, g, h, i; a, d, g, h, j; a, d, g, i, j; a, d, h, i, j; a, e, f, g, h; a, e, f, g, i; a, e, f, g, j; a, e, f, h, i; a, e, f, h, j; a, e, f, i, j; a, e, g, h, i; a, e, g, h, j; a, e, g, i, j; a, e, h, i, j; a, f, g, h, i; a, f, g, h, j; a, f, g, i, j; a, f, h, i, j; a, g, h, i, j; b, c, d, e, f; b, c, d, e, g; b, c, d, e, h; b, c, d, e, i; b, c, d, e, j; b, c, d, f, g; b, c, d, f, h; b, c, d, f, i; b, c, d, f, j; b, c, d, g, h; b, c, d, g, i; b, c, d, g, j; b, c, d, h, i; b, c, d, h, j; b, c, d, i, j; b, c, e, f, g; b, c, e, f, h; b, c, e, f, i; b, c, e, f, j; b, c, e, g, h; b, c, e, g, i; b, c, e, g, j; b, c, e, h, i; b, c, e, h, j; b, c, e, i, j; b, c, f, g, h; b, c, f, g, i; b, c, f, g, j; b, c, f, h, i; b, c, f, h, j; b, c, f, i, j; b, c, g, h, i; b, c, g, h, j; b, c, g, i, j; b, c, h, i, j; b, d, e, f, g; b, d, e, f, h; b, d, e, f, i; b, d, e, f, j; b, d, e, g, h; b, d, e, g, i; b, d, e, g, j; b, d, e, h, i; b, d, e, h, j; b, d, e, i, j; b, d, f, g, h; b, d, f, g, i; b, d, f, g, j; b, d, f, h, i; b, d, f, h, j; b, d, f, i, j; b, d, g, h, i; b, d, g, h, j; b, d, g, i, j; b, d, h, i, j; b, e, f, g, h; b, e, f, g, i; b, e, f, g, j; b, e, f, h, i; b, e, f, h, j; b, e, f, i, j; b, e, g, h, i; b, e, g, h, j; b, e, g, i, j; b, e, h, i, j; b, f, g, h, i; b, f, g, h, j; b, f, g, i, j; b, f, h, i, j; b, g, h, i, j; c, d, e, f, g; c, d, e, f, h; c, d, e, f, i; c, d, e, f, j; c, d, e, g, h; c, d, e, g, i; c, d, e, g, j; c, d, e, h, i; c, d, e, h, j; c, d, e, i, j; c, d, f, g, h; c, d, f, g, i; c, d, f, g, j; c, d, f, h, i; c, d, f, h, j; c, d, f, i, j; c, d, g, h, i; c, d, g, h, j; c, d, g, i, j; c, d, h, i, j; c, e, f, g, h; c, e, f, g, i; c, e, f, g, j; c, e, f, h, i; c, e, f, h, j; c, e, f, i, j; c, e, g, h, i; c, e, g, h, j; c, e, g, i, j; c, e, h, i, j; c, f, g, h, i; c, f, g, h, j; c, f, g, i, j; c, f, h, i, j; c, g, h, i, j; d, e, f, g, h; d, e, f, g, i; d, e, f, g, j; d, e, f, h, i; d, e, f, h, j; d, e, f, i, j; d, e, g, h, i; d, e, g, h, j; d, e, g, i, j; d, e, h, i, j; d, f, g, h, i; d, f, g, h, j; d, f, g, i, j; d, f, h, i, j; d, g, h, i, j; e, f, g, h, i; e, f, g, h, j; e, f, g, i, j; e, f, h, i, j; e, g, h, i, j; or f, g, h, i, j;
e) a, b, c, d, e, f; a, b, c, d, e, g; a, b, c, d, e, h; a, b, c, d, e, i; a, b, c, d, e, j; a, b, c, d, f, g; a, b, c, d, f, h; a, b, c, d, f, i; a, b, c, d, f, j; a, b, c, d, g, h; a, b, c, d, g, i; a, b, c, d, g, j; a, b, c, d, h, i; a, b, c, d, h, j; a, b, c, d, i, j; a, b, c, e, f, g; a, b, c, e, f, h; a, b, c, e, f, i; a, b, c, e, f, j; a, b, c, e, g, h; a, b, c, e, g, i; a, b, c, e, g, j; a, b, c, e, h, i; a, b, c, e, h, j; a, b, c, e, i, j; a, b, c, f, g, h; a, b, c, f, g, i; a, b, c, f, g, j; a, b, c, f, h, i; a, b, c, f, h, j; a, b, c, f, i, j; a, b, c, g, h, i; a, b, c, g, h, j; a, b, c, g, i, j; a, b, c, h, i, j; a, b, d, e, f, g; a, b, d, e, f, h; a, b, d, e, f, i; a, b, d, e, f, j; a, b, d, e, g, h; a, b, d, e, g, i; a, b, d, e, g, j; a, b, d, e, h, i; a, b, d, e, h, j; a, b, d, e, i, j; a, b, d, f, g, h; a, b, d, f, g, i; a, b, d, f, g, j; a, b, d, f, h, i; a, b, d, f, h, j; a, b, d, f, i, j; a, b, d, g, h, i; a, b, d, g, h, j; a, b, d, g, i, j; a, b, d, h, i, j; a, b, e, f, g, h; a, b, e, f, g, i; a, b, e, f, g, j; a, b, e, f, h, i; a, b, e, f, h, j; a, b, e, f, i, j; a, b, e, g, h, i; a, b, e, g, h, j; a, b, e, g, i, j; a, b, e, h, i, j; a, b, f, g, h, i; a, b, f, g, h, j; a, b, f, g, i, j; a, b, f, h, i, j; a, b, g, h, i, j; a, c, d, e, f, g; a, c, d, e, f, h; a, c, d, e, f, i; a, c, d, e, f, j; a, c, d, e, g, h; a, c, d, e, g, i; a, c, d, e, g, j; a, c, d, e, h, i; a, c, d, e, h, j; a, c, d, e, i, j; a, c, d, f, g, h; a, c, d, f, g, i; a, c, d, f, g, j; a, c, d, f, h, i; a, c, d, f, h, j; a, c, d, f, i, j; a, c, d, g, h, i; a, c, d, g, h, j; a, c, d, g, i, j; a, c, d, h, i, j; a, c, e, f, g, h; a, c, e, f, g, i; a, c, e, f, g, j; a, c, e, f, h, i; a, c, e, f, h, j; a, c, e, f, i, j; a, c, e, g, h, i; a, c, e, g, h, j; a, c, e, g, i, j; a, c, e, h, i, j; a, c, f, g, h, i; a, c, f, g, h, j; a, c, f, g, i, j; a, c, f, h, i, j; a, c, g, h, i, j; a, d, e, f, g, h; a, d, e, f, g, i; a, d, e, f, g, j; a, d, e, f, h, i; a, d, e, f, h, j; a, d, e, f, i, j; a, d, e, g, h, i; a, d, e, g, h, j; a, d, e, g, i, j; a, d, e, h, i, j; a, d, f, g, h, i; a, d, f, g, h, j; a, d, f, g, i, j; a, d, f, h, i, j; a, d, g, h, i, j; a, e, f, g, h, i; a, e, f, g, h, j; a, e, f, g, i, j; a, e, f, h, i, j; a, e, g, h, i, j; a, f, g, h, i, j; b, c, d, e, f, g; b, c, d, e, f, h; b, c, d, e, f, i; b, c, d, e, f, j; b, c, d, e, g, h; b, c, d, e, g, i; b, c, d, e, g, j; b, c, d, e, h, i; b, c, d, e, h, j; b, c, d, e, i, j; b, c, d, f, g, h; b, c, d, f, g, i; b, c, d, f, g, j; b, c, d, f, h, i; b, c, d, f, h, j; b, c, d, f, i, j; b, c, d, g, h, i; b, c, d, g, h, j; b, c, d, g, i, j; b, c, d, h, i, j; b, c, e, f, g, h; b, c, e, f, g, i; b, c, e, f, g, j; b, c, e, f, h, i; b, c, e, f, h, j; b, c, e, f, i, j; b, c, e, g, h, i; b, c, e, g, h, j; b, c, e, g, i, j; b, c, e, h, i, j; b, c, f, g, h, i; b, c, f, g, h, j; b, c, f, g, i, j; b, c, f, h, i, j; b, c, g, h, i, j; b, d, e, f, g, h; b, d, e, f, g, i; b, d, e, f, g, j; b, d, e, f, h, i; b, d, e, f, h, j; b, d, e, f, i, j; b, d, e, g, h, i; b, d, e, g, h, j; b, d, e, g, i, j; b, d, e, h, i, j; b, d, f, g, h, i; b, d, f, g, h, j; b, d, f, g, i, j; b, d, f, h, i, j; b, d, g, h, i, j; b, e, f, g, h, i; b, e, f, g, h, j; b, e, f, g, i, j; b, e, f, h, i, j; b, e, g, h, i, j; b, f, g, h, i, j; c, d, e, f, g, h; c, d, e, f, g, i; c, d, e, f, g, j; c, d, e, f, h, i; c, d, e, f, h, j; c, d, e, f, i, j; c, d, e, g, h, i; c, d, e, g, h, j; c, d, e, g, i, j; c, d, e, h, i, j; c, d, f, g, h, i; c, d, f, g, h, j; c, d, f, g, i, j; c, d, f, h, i, j; c, d, g, h, i, j; c, e, f, g, h, i; c, e, f, g, h, j; c, e, f, g, i, j; c, e, f, h, i, j; c, e, g, h, i, j; c, f, g, h, i, j; d, e, f, g, h, i; d, e, f, g, h, j; d, e, f, g, i, j; d, e, f, h, i, j; d, e, g, h, i, j; d, f, g, h, i, j; or e, f, g, h, i, j;
f) a, b, c, d, e, f, g; a, b, c, d, e, f, h; a, b, c, d, e, f, i; a, b, c, d, e, f, j; a, b, c, d, e, g, h; a, b, c, d, e, g, i; a, b, c, d, e, g, j; a, b, c, d, e, h, i; a, b, c, d, e, h, j; a, b, c, d, e, i, j; a, b, c, d, f, g, h; a, b, c, d, f, g, i; a, b, c, d, f, g, j; a, b, c, d, f, h, i; a, b, c, d, f, h, j; a, b, c, d, f, i, j; a, b, c, d, g, h, i; a, b, c, d, g, h, j; a, b, c, d, g, i, j; a, b, c, d, h, i, j; a, b, c, e, f, g, h; a, b, c, e, f, g, i; a, b, c, e, f, g, j; a, b, c, e, f, h, i; a, b, c, e, f, h, j; a, b, c, e, f, i, j; a, b, c, e, g, h, i; a, b, c, e, g, h, j; a, b, c, e, g, i, j; a, b, c, e, h, i, j; a, b, c, f, g, h, i; a, b, c, f, g, h, j; a, b, c, f, g, i, j; a, b, c, f, h, i, j; a, b, c, g, h, i, j; a, b, d, e, f, g, h; a, b, d, e, f, g, i; a, b, d, e, f, g, j; a, b, d, e, f, h, i; a, b, d, e, f, h, j; a, b, d, e, f, i, j; a, b, d, e, g, h, i; a, b, d, e, g, h, j; a, b, d, e, g, i, j; a, b, d, e, h, i, j; a, b, d, f, g, h, i; a, b, d, f, g, h, j; a, b, d, f, g, i, j; a, b, d, f, h, i, j; a, b, d, g, h, i, j; a, b, e, f, g, h, i; a, b, e, f, g, h, j; a, b, e, f, g, i, j; a, b, e, f, h, i, j; a, b, e, g, h, i, j; a, b, f, g, h, i, j; a, c, d, e, f, g, h; a, c, d, e, f, g, i; a, c, d, e, f, g, j; a, c, d, e, f, h, i; a, c, d, e, f, h, j; a, c, d, e, f, i, j; a, c, d, e, g, h, i; a, c, d, e, g, h, j; a, c, d, e, g, i, j; a, c, d, e, h, i, j; a, c, d, f, g, h, i; a, c, d, f, g, h, j; a, c, d, f, g, i, j; a, c, d, f, h, i, j; a, c, d, g, h, i, j; a, c, e, f, g, h, i; a, c, e, f, g, h, j; a, c, e, f, g, i, j; a, c, e, f, h, i, j; a, c, e, g, h, i, j; a, c, f, g, h, i, j; a, d, e, f, g, h, i; a, d, e, f, g, h, j; a, d, e, f, g, i, j; a, d, e, f, h, i, j; a, d, e, g, h, i, j; a, d, f, g, h, i, j; a, e, f, g, h, i, j; b, c, d, e, f, g, h; b, c, d, e, f, g, i; b, c, d, e, f, g, j; b, c, d, e, f, h, i; b, c, d, e, f, h, j; b, c, d, e, f, i, j; b, c, d, e, g, h, i; b, c, d, e, g, h, j; b, c, d, e, g, i, j; b, c, d, e, h, i, j; b, c, d, f, g, h, i; b, c, d, f, g, h, j; b, c, d, f, g, i, j; b, c, d, f, h, i, j; b, c, d, g, h, i, j; b, c, e, f, g, h, i; b, c, e, f, g, h, j; b, c, e, f, g, i, j; b, c, e, f, h, i, j; b, c, e, g, h, i, j; b, c, f, g, h, i, j; b, d, e, f, g, h, i; b, d, e, f, g, h, j; b, d, e, f, g, i, j; b, d, e, f, h, i, j; b, d, e, g, h, i, j; b, d, f, g, h, i, j; b, e, f, g, h, i, j; c, d, e, f, g, h, i; c, d, e, f, g, h, j; c, d, e, f, g, i, j; c, d, e, f, h, i, j; c, d, e, g, h, i, j; c, d, f, g, h, i, j; c, e, f, g, h, i, j; or d, e, f, g, h, i, j;
g) a, b, c, d, e, f, g, h; a, b, c, d, e, f, g, i; a, b, c, d, e, f, g, j; a, b, c, d, e, f, h, i; a, b, c, d, e, f, h, j; a, b, c, d, e, f, i, j; a, b, c, d, e, g, h, i; a, b, c, d, e, g, h, j; a, b, c, d, e, g, i, j; a, b, c, d, e, h, i, j; a, b, c, d, f, g, h, i; a, b, c, d, f, g, h, j; a, b, c, d, f, g, i, j; a, b, c, d, f, h, i, j; a, b, c, d, g, h, i, j; a, b, c, e, f, g, h, i; a, b, c, e, f, g, h, j; a, b, c, e, f, g, i, j; a, b, c, e, f, h, i, j; a, b, c, e, g, h, i, j; a, b, c, f, g, h, i, j; a, b, d, e, f, g, h, i; a, b, d, e, f, g, h, j; a, b, d, e, f, g, i, j; a, b, d, e, f, h, i, j; a, b, d, e, g, h, i, j; a, b, d, f, g, h, i, j; a, b, e, f, g, h, i, j; a, c, d, e, f, g, h, i; a, c, d, e, f, g, h, j; a, c, d, e, f, g, i, j; a, c, d, e, f, h, i, j; a, c, d, e, g, h, i, j; a, c, d, f, g, h, i, j; a, c, e, f, g, h, i, j; a, d, e, f, g, h, i, j; b, c, d, e, f, g, h, i; b, c, d, e, f, g, h, j; b, c, d, e, f, g, i, j; b, c, d, e, f, h, i, j; b, c, d, e, g, h, i, j; b, c, d, f, g, h, i, j; b, c, e, f, g, h, i, j; b, d, e, f, g, h, i, j; or c, d, e, f, g, h, i, j;
h) a, b, c, d, e, f, g, h, i; a, b, c, d, e, f, g, h, j; a, b, c, d, e, f, g, i, j; a, b, c, d, e, f, h, i, j; a, b, c, d, e, g, h, i, j; a, b, c, d, f, g, h, i, j; a, b, c, e, f, g, h, i, j; a, b, d, e, f, g, h, i, j; a, c, d, e, f, g, h, i, j; or b, c, d, e, f, g, h, i, j; or
i) a, b, c, d, e, f, g, h, i, j,
where a=Vanillic acid; b=Syringic acid; c=P-Coumaric acid; d=Silicic acid; e=Cinnamic acid; f=Ferulic acid; g=Fisetin; h=Oxybenzone; i=Orbifloxacin; and j=Rosiglitazone maleate and stereoisomers, tautomers and agriculturally acceptable salts thereof.

8. The composition according to claim 5, said composition comprising between about 0.1% and about 35% active agent(s) by weight and about 65% to about 99.9% by weight of one or more component selected from: agriculturally suitable solvents, agriculturally suitable carriers, agriculturally suitable surfactants and mixtures thereof.

9. The composition according to claim 7, said active agents being present in equal amounts, approximately equal amounts, or in amounts of about 0.1 g-100 g for each active agent present in said composition, said amounts being by weight.

10. The composition according to claim 9, wherein said active agents are present in equal amounts or approximately equal amounts.

11. The composition according to claim 9, wherein said active agents are present in an amount of approximately 1 g per liter of an agriculturally acceptable carrier.

12. The composition according to claim 9, wherein said active agents are syringic acid, p-coumaric acid, vanillic acid, and cinnamic acid.

13. The composition according to claim 11, wherein the composition comprises a surfactant selected from crop oil concentrates (COC), methylated seed oils (MSO), high surfactant methylated seed oils (HSMSO), silicone surfactants (SS), non-ionic surfactants (NIS) and mixtures thereof.

14. The composition according to claim 12, wherein the agriculturally acceptable carrier is water.

15. The composition according to claim 1, said composition comprising syringic acid, p-coumaric acid, vanillic acid, and cinnamic acid, each of which is present in an amount of about 1 g per liter of an agriculturally acceptable carrier and, optionally, an agriculturally acceptable surfactant.

16. The composition according to claim 1, said composition further comprising a vitamin, vitamin A, vitamin C, one or more crop oil, and mixtures thereof.

17. A method of preparing a composition comprising mixing a composition according to claim 1 with an agriculturally acceptable carrier to form an application formulation.

18. The method according to claim 17, wherein the agriculturally acceptable carrier is water.

19. An application formulation produced by the method of claim 17.

20. A method of controlling and/or treating citrus greening in a citrus plant comprising the application of an application formulation comprising the composition of claim 1 to said citrus plant.

21. The method according to claim 20, wherein said application formulation is applied as a foliar spray, injection into the phloem, trunk feeding, via irrigation, or drench application to the root system.

22. The method according to claim 20, wherein said citrus plant is selected from the group consisting of an orange, a lemon, a lime, a grapefruit, a clementine, a tangerine, a tangelo and a pomelo tree.

23. The method according to claim 20, wherein said application formulation comprises syringic acid, p-coumaric acid, vanillic acid, and cinnamic acid.

24. A fertilizer or inert carrier comprising:
a) one or more active agent as set forth in Tables 1 and/or 2 or stereoisomers, tautomers and/or agrochemically acceptable salts thereof; or
b) a composition comprising one or more active agent as set forth in Tables 1 and/or 2 or stereoisomers, tautomers and/or agrochemically acceptable salts thereof and one or more component selected from: agriculturally suitable solvents, agriculturally suitable carriers, agriculturally suitable surfactants and mixtures thereof.

25. The fertilizer or inert carrier according to claim 24, wherein the fertilizer or inert carrier comprises one of the following combinations of active agents:
a) a, b; a, c; a, d; a, e; a, f; a, g; a, h; a, i; a, j; b, c; b, d, b, e; b, f, b, g; b, h; b, i; b, j; c, d; c, e; c, f, c, g; c, h; c, i; c, j; d, e; d, f, d, g; d, h; d, i; d, j; e, f; e, g; e, h; e, i; e, j; f, g; f, h; f, i; f, j; g, h; g, i; g, j; h, i; h, j; or i, j;
b) a, b, c; a, b, d; a, b, e; a, b, f; a, b, g; a, b, h; a, b, i; a, b, j; a, c, d; a, c, e; a, c, f; a, c, g; a, c, h; a, c, i; a, c, j; a, d, e; a, d, f; a, d, g; a, d, h; a, d, i; a, d, j; a, e, f; a, e, g; a, e, h; a, e, i; a, e, j; a, f, g; a, f, h; a, f, i; a, f, j; a, g, h; a, g, i; a, g, j; a, h, i; a, h, j; a, i, j; b, c, d; b, c, e; b, c, f; b, c, g; b, c, h; b, c, i; b, c, j; b, d, e; b, d, f, b, d, g; b, d, h; b, d, i; b, d, j; b, e, f, b, e, g; b, e, h; b, e, i; b, e, j; b, f, g; b, f, h; b, f, i; b, f, j; b, g, h; b, g, i; b, g, j; b, h, i; b, h, j; b, i, j; c, d, e; c, d, f, c, d, g; c, d, h; c, d, i; c, d, j; c, e, f; c, e, g; c, e, h; c, e, i; c, e, j; c, f, g; c, f, h; c, f, i; c, f, j; c, g, h; c, g, i; c, g, j; c, h, i; c, h, j; c, i, j; d, e, f; d, e, g; d, e, h; d, e, i; d, e, j; d, f, g; d, f, h; d, f, i; d, f, j; d, g, h; d, g, i; d, g, j; d, h, i; d, h, j; d, i, j; e, f, g; e, f, h; e, f, i; e, f, j; e, g, h; e, g, i; e, g, j; e, h, i; e, h, j; e, i, j; f, g, h; f, g, i; f, g, j; f, h, i; f, h, j; f, i, j; g, h, i; g, h, j; g, i, j; or h, i, j;
c) a, b, c, d; a, b, c, e; a, b, c, f, a, b, c, g; a, b, c, h; a, b, c, i; a, b, c, j; a, b, d, e; a, b, d, f, a, b, d, g; a, b, d, h; a, b, d, i; a, b, d, j; a, b, e, f, a, b, e, g; a, b, e, h; a, b, e, i; a, b, e, j; a, b, f, g; a, b, f, h; a, b, f, i; a, b, f, j; a, b, g, h; a, b, g, i; a, b, g, j; a, b, h, i; a, b, h, j; a, b, i, j; a, c, d, e; a, c, d, f, a, c, d, g; a, c, d, h; a, c, d, i; a, c, d, j; a, c, e, f; a, c, e, g; a, c, e, h; a, c, e, i; a, c, e, j; a, c, f, g; a, c, f, h; a, c, f, i; a, c, f, j; a, c, g, h; a, c, g, i; a, c, g, j; a, c, h, i; a, c, h, j; a, c, i, j; a, d, e, f, a, d, e, g; a, d, e, h; a, d, e, i; a, d, e, j; a, d, f, g; a, d, f, h; a, d, f, i; a, d, f, j; a, d, g, h; a, d, g, i; a, d, g, j; a, d, h, i; a, d, h, j; a, d, i, j; a, e, f, g; a, e, f, h; a, e, f, i; a, e, f, j; a, e, g, h; a, e, g, i; a, e, g, j; a, e, h, i; a, e, h, j; a, e, i, j; a, f, g, h; a, f, g, i; a, f, g, j; a, f, h, i; a, f, h, j; a, f, i, j; a, g, h, i; a, g, h, j; a, g, i, j; a, h, i, j; b, c, d, e; b, c, d, f; b, c, d, g; b, c, d, h; b, c, d, i; b, c, d, j; b, c, e, f; b, c, e, g; b, c, e, h; b, c, e, i; b, c, e, j; b, c, f, g; b, c, f, h; b, c, f, i; b, c, f, j; b, c, g, h; b, c, g, i; b, c, g, j; b, c, h, i; b, c, h, j; b, c, i, j; b, d, e, f; b, d, e, g; b, d, e, h; b, d, e, i; b, d, e, j; b, d, f, g; b, d, f, h; b, d, f, i; b, d, f, j; b, d, g, h; b, d, g, i; b, d, g, j; b, d, h, i; b, d, h, j; b, d, i, j; b, e, f, g; b, e, f, h; b, e, f, i; b, e, f, j; b, e, g, h; b, e, g, i; b, e, g, j; b, e, h, i; b, e, h, j; b, e, i, j; b, f, g, h; b, f, g, i; b, f, g, j; b, f, h, i; b, f, h, j; b, f, i, j; b, g, h, i; b, g, h, j; b, g, i, j; b, h, i, j; c, d, e, f; c, d, e, g; c, d, e, h; c, d, e, i; c, d, e, j; c, d, f, g; c, d, f, h; c, d, f, i; c, d, f, j; c, d, g, h; c, d, g, i; c, d, g, j; c, d, h, i; c, d, h, j; c, d, i, j; c, e, f, g; c, e, f, h; c, e, f, i; c, e, f, j; c, e, g, h; c, e, g, i; c, e, g, j; c, e, h, i; c, e, h, j; c, e, i, j; c, f, g, h; c, f, g, i; c, f, g, j; c, f, h, i; c, f, h, j; c, f, i, j; c, g, h, i; c, g, h, j; c, g, i, j; c, h, i, j; d, e, f, g; d, e, f, h; d, e, f, i; d, e, f, j; d, e, g, h; d, e, g, i; d, e, g, j; d, e, h, i; d, e, h, j; d, e, i, j; d, f, g, h; d, f, g, i; d, f, g, j; d, f, h, i; d, f, h, j; d, f, i, j; d, g, h, i; d, g, h, j; d, g, i, j; d, h, i, j; e, f, g, h; e, f, g, i; e, f, g, j; e, f, h, i; e, f, h, j; e, f, i, j; e, g, h, i; e, g, h, j; e, g, i, j; e, h, i, j; f, g, h, i; f, g, h, j; f, g, i, j; f, h, i, j; or g, h, i, j;
d) a, b, c, d, e; a, b, c, d, f; a, b, c, d, g; a, b, c, d, h; a, b, c, d, i; a, b, c, d, j; a, b, c, e, f, a, b, c, e, g; a, b, c, e, h; a, b, c, e, i; a, b, c, e, j; a, b, c, f, g; a, b, c, f, h; a, b, c, f, i; a, b, c, f, j; a, b, c, g, h; a, b, c, g, i; a, b, c, g, j; a, b, c, h, i; a, b, c, h, j; a, b, c, i, j; a, b, d, e, f; a, b, d, e, g; a, b, d, e, h; a, b, d, e, i; a, b, d, e, j; a, b, d, f, g; a, b, d, f, h; a, b, d, f, i; a, b, d, f, j; a, b, d, g, h; a, b, d, g, i; a, b, d, g, j; a, b, d, h, i; a, b, d, h, j; a, b, d, i, j; a, b, e, f, g; a, b, e, f, h; a, b, e, f, i; a, b, e, f, j; a, b, e, g, h; a, b, e, g, i; a, b, e, g, j; a, b, e, h, i; a, b, e, h, j; a, b, e, i, j; a, b, f, g, h; a, b, f, g, i; a, b, f, g, j; a, b, f, h, i; a, b, f, h, j; a, b, f, i, j; a, b, g, h, i; a, b, g, h, j; a, b, g, i, j; a, b, h, i, j; a, c, d, e, f, a, c, d, e, g; a, c, d, e, h; a, c, d, e, i; a, c, d, e, j; a, c, d, f, g; a, c, d, f, h; a, c, d, f, i; a, c, d, f, j; a, c, d, g, h; a, c, d, g, i; a, c, d, g, j; a, c, d, h, i; a, c, d, h, j; a, c, d, i, j; a, c, e, f, g; a, c, e, f, h; a, c, e, f, i; a, c, e, f, j; a, c, e, g, h; a, c, e, g, i; a, c, e, g, j; a, c, e, h, i; a, c, e, h, j; a, c, e, i, j; a, c, f, g, h; a, c, f, g, i; a, c, f, g, j; a, c, f, h, i; a, c, f, h, j; a, c, f, i, j; a, c, g, h, i; a, c, g, h, j; a, c, g, i, j; a, c, h, i, j; a, d, e, f, g; a, d, e, f, h; a, d, e, f, i; a, d, e, f, j; a, d, e, g, h; a, d, e, g, i; a, d, e, g, j; a, d, e, h, i; a, d, e, h, j; a, d, e, i, j; a, d, f, g, h; a, d, f, g, i; a, d, f, g, j; a, d, f, h, i; a, d, f, h, j; a, d, f, i, j; a, d, g, h, i; a, d, g, h, j; a, d, g, i, j; a, d, h, i, j; a, e, f, g, h; a, e, f, g, i; a, e, f, g, j; a, e, f, h, i; a, e, f, h, j; a, e, f, i, j; a, e, g, h, i; a, e, g, h, j; a, e, g, i, j; a, e, h, i, j; a, f, g, h, i; a, f, g, h, j; a, f, g, i, j; a, f, h, i, j; a, g, h, i, j; b, c, d, e, f; b, c, d, e, g; b, c, d, e, h; b, c, d, e, i; b, c, d, e, j; b, c, d, f, g; b, c, d, f, h; b, c, d, f, i; b, c, d, f, j; b, c, d, g, h; b, c, d, g, i; b, c, d, g, j; b, c, d, h, i; b, c, d, h, j; b, c, d, i, j; b, c, e, f, g; b, c, e, f, h; b, c, e, f, i; b, c, e, f, j; b, c, e, g, h; b, c, e, g, i; b, c, e, g, j; b, c, e, h, i; b, c, e, h, j; b, c, e, i, j; b, c, f, g, h; b, c, f, g, i; b, c, f, g, j; b, c, f, h, i; b, c, f, h, j; b, c, f, i, j; b, c, g, h, i; b, c, g, h, j; b, c, g, i, j; b, c, h, i, j; b, d, e, f, g; b, d, e, f, h; b, d, e, f, i; b, d, e, f, j; b, d, e, g, h; b, d, e, g, i; b, d, e, g, j; b, d, e, h, i; b, d, e, h, j; b, d, e, i, j; b, d, f, g, h; b, d, f, g, i; b, d, f, g, j; b, d, f, h, i; b, d, f, h, j; b, d, f, i, j; b, d, g, h, i; b, d, g, h, j; b, d, g, i, j; b, d, h, i, j; b, e, f, g, h; b, e, f, g, i; b, e, f, g, j; b, e, f, h, i; b, e, f, h, j; b, e, f, i, j; b, e, g, h, i; b, e, g, h, j; b, e, g, i, j; b, e, h, i, j; b, f, g, h, i; b, f, g, h, j; b, f, g, i, j; b, f, h, i, j; b, g, h, i, j; c, d, e, f, g; c, d, e, f, h; c, d, e, f, i; c, d, e, f, j; c, d, e, g, h; c, d, e, g, i; c, d, e, g, j; c, d, e, h, i; c, d, e, h, j; c, d, e, i, j; c, d, f, g, h; c, d, f, g, i; c, d, f, g, j; c, d, f, h, i; c, d, f, h, j; c, d, f, i, j; c, d, g, h, i; c, d, g, h, j; c, d, g, i, j; c, d, h, i, j; c, e, f, g, h; c, e, f, g, i; c, e, f, g, j; c, e, f, h, i; c, e, f, h, j; c, e, f, i, j; c, e, g, h, i; c, e, g, h, j; c, e, g, i, j; c, e, h, i, j; c, f, g, h, i; c, f, g, h, j; c, f, g, i, j; c, f, h, i, j; c, g, h, i, j; d, e, f, g, h; d, e, f, g, i; d, e, f, g, j; d, e, f, h, i; d, e, f, h, j; d, e, f, i, j; d, e, g, h, i; d, e, g, h, j; d, e, g, i, j; d, e, h, i, j; d, f, g, h, i; d, f, g, h, j; d, f, g, i, j; d, f, h, i, j; d, g, h, i, j; e, f, g, h, i; e, f, g, h, j; e, f, g, i, j; e, f, h, i, j; e, g, h, i, j; or f, g, h, i, j;
e) a, b, c, d, e, f; a, b, c, d, e, g; a, b, c, d, e, h; a, b, c, d, e, i; a, b, c, d, e, j; a, b, c, d, f, g; a, b, c, d, f, h; a, b, c, d, f, i; a, b, c, d, f, j; a, b, c, d, g, h; a, b, c, d, g, i; a, b, c, d, g, j; a, b, c, d, h, i; a, b, c, d, h, j; a, b, c, d, i, j; a, b, c, e, f, g; a, b, c, e, f, h; a, b, c, e, f, i; a, b, c, e, f, j; a, b, c, e, g, h; a, b, c, e, g, i; a, b, c, e, g, j; a, b, c, e, h, i; a, b, c, e, h, j; a, b, c, e, i, j; a, b, c, f, g, h; a, b, c, f, g, i; a, b, c, f, g, j; a, b, c, f, h, i; a, b, c, f, h, j; a, b, c, f, i, j; a, b, c, g, h, i; a, b, c, g, h, j; a, b, c, g, i, j; a, b, c, h, i, j; a, b, d, e, f, g; a, b, d, e, f, h; a, b, d, e, f, i; a, b, d, e, f, j; a, b, d, e, g, h; a, b, d, e, g, i; a, b, d, e, g, j; a, b, d, e, h, i; a, b, d, e, h, j; a, b, d, e, i, j; a, b, d, f, g, h; a, b, d, f, g, i; a, b, d, f, g, j; a, b, d, f, h, i; a, b, d, f, h, j; a, b, d, f, i, j; a, b, d, g, h, i; a, b, d, g, h, j; a, b, d, g, i, j; a, b, d, h, i, j; a, b, e, f, g, h; a, b, e, f, g, i; a, b, e, f, g, j; a, b, e, f, h, i; a, b, e, f, h, j; a, b, e, f, i, j; a, b, e, g, h, i; a, b, e, g, h, j; a, b, e, g, i, j; a, b, e, h, i, j; a, b, f, g, h, i; a, b, f, g, h, j; a, b, f, g, i, j; a, b, f, h, i, j; a, b, g, h, i, j; a, c, d, e, f, g; a, c, d, e, f, h; a, c, d, e, f, i; a, c, d, e, f, j; a, c, d, e, g, h; a, c, d, e, g, i; a, c, d, e, g, j; a, c, d, e, h, i; a, c, d, e, h, j; a, c, d, e, i, j; a, c, d, f, g, h; a, c, d, f, g, i; a, c, d, f, g, j; a, c, d, f, h, i; a, c, d, f, h, j; a, c, d, f, i, j; a, c, d, g, h, i; a, c, d, g, h, j; a, c, d, g, i, j; a, c, d, h, i, j; a, c, e, f, g, h; a, c, e, f, g, i; a, c, e, f, g, j; a, c, e, f, h, i; a, c, e, f, h, j; a, c, e, f, i, j; a, c, e, g, h, i; a, c, e, g, h, j; a, c, e, g, i, j; a, c, e, h, i, j; a, c, f, g, h, i; a, c, f, g, h, j; a, c, f, g, i, j; a, c, f, h, i, j; a, c, g, h, i, j; a, d, e, f, g, h; a, d, e, f, g, i; a, d, e, f, g, j; a, d, e, f, h, i; a, d, e, f, h, j; a, d, e, f, i, j; a, d, e, g, h, i; a, d, e, g, h, j; a, d, e, g, i, j; a, d, e, h, i, j; a, d, f, g, h, i; a, d, f, g, h, j; a, d, f, g, i, j; a, d, f, h, i, j; a, d, g, h, i, j; a, e, f, g, h, i; a, e, f, g, h, j; a, e, f, g, i, j; a, e, f, h, i, j; a, e, g, h, i, j; a, f, g, h, i, j; b, c, d, e, f, g; b, c, d, e, f, h; b, c, d, e, f, i; b, c, d, e, f, j; b, c, d, e, g, h; b, c, d, e, g, i; b, c, d, e, g, j; b, c, d, e, h, i; b, c, d, e, h, j; b, c, d, e, i, j; b, c, d, f, g, h; b, c, d, f, g, i; b, c, d, f, g, j; b, c, d, f, h, i; b, c, d, f, h, j; b, c, d, f, i, j; b, c, d, g, h, i; b, c, d, g, h, j; b, c, d, g, i, j; b, c, d, h, i, j; b, c, e, f, g, h; b, c, e, f, g, i; b, c, e, f, g, j; b, c, e, f, h, i; b, c, e, f, h, j; b, c, e, f, i, j; b, c, e, g, h, i; b, c, e, g, h, j; b, c, e, g, i, j; b, c, e, h, i, j; b, c, f, g, h, i; b, c, f, g, h, j; b, c, f, g, i, j; b, c, f, h, i, j; b, c, g, h, i, j; b, d, e, f, g, h; b, d, e, f, g, i; b, d, e, f, g, j; b, d, e, f, h, i; b, d, e, f, h, j; b, d, e, f, i, j; b, d, e, g, h, i; b, d, e, g, h, j; b, d, e, g, i, j; b, d, e, h, i, j; b, d, f, g, h, i; b, d, f, g, h, j; b, d, f, g, i, j; b, d, f, h, i, j; b, d, g, h, i, j; b, e, f, g, h, i; b, e, f, g, h, j; b, e, f, g, i, j; b, e, f, h, i, j; b, e, g, h, i, j; b, f, g, h, i, j; c, d, e, f, g, h; c, d, e, f, g, i; c, d, e, f, g, j; c, d, e, f, h, i; c, d, e, f, h, j; c, d, e, f, i, j; c, d, e, g, h, i; c, d, e, g, h, j; c, d, e, g, i, j; c, d, e, h, i, j; c, d, f, g, h, i; c, d, f, g, h, j; c, d, f, g, i, j; c, d, f, h, i, j; c, d, g, h, i, j; c, e, f, g, h, i; c, e, f, g, h, j; c, e, f, g, i, j; c, e, f, h, i, j; c, e, g, h, i, j; c, f, g, h, i, j; d, e, f, g, h, i; d, e, f, g, h, j; d, e, f, g, i, j; d, e, f, h, i, j; d, e, g, h, i, j; d, f, g, h, i, j; or e, f, g, h, i, j;
f) a, b, c, d, e, f, g; a, b, c, d, e, f, h; a, b, c, d, e, f, i; a, b, c, d, e, f, j; a, b, c, d, e, g, h; a, b, c, d, e, g, i; a, b, c, d, e, g, j; a, b, c, d, e, h, i; a, b, c, d, e, h, j; a, b, c, d, e, i, j; a, b, c, d, f, g, h; a, b, c, d, f, g, i; a, b, c, d, f, g, j; a, b, c, d, f, h, i; a, b, c, d, f, h, j; a, b, c, d, f, i, j; a, b, c, d, g, h, i; a, b, c, d, g, h, j; a, b, c, d, g, i, j; a, b, c, d, h, i, j; a, b, c, e, f, g, h; a, b, c, e, f, g, i; a, b, c, e, f, g, j; a, b, c, e, f, h, i; a, b, c, e, f, h, j; a, b, c, e, f, i, j; a, b, c, e, g, h, i; a, b, c, e, g, h, j; a, b, c, e, g, i, j; a, b, c, e, h, i, j; a, b, c, f, g, h, i; a, b, c, f, g, h, j; a, b, c, f, g, i, j; a, b, c, f, h, i, j; a, b, c, g, h, i, j; a, b, d, e, f, g, h; a, b, d, e, f, g, i; a, b, d, e, f, g, j; a, b, d, e, f, h, i; a, b, d, e, f, h, j; a, b, d, e, f, i, j; a, b, d, e, g, h, i; a, b, d, e, g, h, j; a, b, d, e, g, i, j; a, b, d, e, h, i, j; a, b, d, f, g, h, i; a, b, d, f, g, h, j; a, b, d, f, g, i, j; a, b, d, f, h, i, j; a, b, d, g, h, i, j; a, b, e, f, g, h, i; a, b, e, f, g, h, j; a, b, e, f, g, i, j; a, b, e, f, h, i, j; a, b, e, g, h, i, j; a, b, f, g, h, i, j; a, c, d, e, f, g, h; a, c, d, e, f, g, i; a, c, d, e, f, g, j; a, c, d, e, f, h, i; a, c, d, e, f, h, j; a, c, d, e, f, i, j; a, c, d, e, g, h, i; a, c, d, e, g, h, j; a, c, d, e, g, i, j; a, c, d, e, h, i, j; a, c, d, f, g, h, i; a, c, d, f, g, h, j; a, c, d, f, g, i, j; a, c, d, f, h, i, j; a, c, d, g, h, i, j; a, c, e, f, g, h, i; a, c, e, f, g, h, j; a, c, e, f, g, i, j; a, c, e, f, h, i, j; a, c, e, g, h, i, j; a, c, f, g, h, i, j; a, d, e, f, g, h, i; a, d, e, f, g, h, j; a, d, e, f, g, i, j; a, d, e, f, h, i, j; a, d, e, g, h, i, j; a, d, f, g, h, i, j; a, e, f, g, h, i, j; b, c, d, e, f, g, h; b, c, d, e, f, g, i; b, c, d, e, f, g, j; b, c, d, e, f, h, i; b, c, d, e, f, h, j; b, c, d, e, f, i, j; b, c, d, e, g, h, i; b, c, d, e, g, h, j; b, c, d, e, g, i, j; b, c, d, e, h, i, j; b, c, d, f, g, h, i; b, c, d, f, g, h, j; b, c, d, f, g, i, j; b, c, d, f, h, i, j; b, c, d, g, h, i, j; b, c, e, f, g, h, i; b, c, e, f, g, h, j; b, c, e, f, g, i, j; b, c, e, f, h, i, j; b, c, e, g, h, i, j; b, c, f, g, h, i, j; b, d, e, f, g, h, i; b, d, e, f, g, h, j; b, d, e, f, g, i, j; b, d, e, f, h, i, j; b, d, e, g, h, i, j; b, d, f, g, h, i, j; b, e, f, g, h, i, j; c, d, e, f, g, h, i; c, d, e, f, g, h, j; c, d, e, f, g, i, j; c, d, e, f, h, i, j; c, d, e, g, h, i, j; c, d, f, g, h, i, j; c, e, f, g, h, i, j; or d, e, f, g, h, i, j;
g) a, b, c, d, e, f, g, h; a, b, c, d, e, f, g, i; a, b, c, d, e, f, g, j; a, b, c, d, e, f, h, i; a, b, c, d, e, f, h, j; a, b, c, d, e, f, i, j; a, b, c, d, e, g, h, i; a, b, c, d, e, g, h, j; a, b, c, d, e, g, i, j; a, b, c, d, e, h, i, j; a, b, c, d, f, g, h, i; a, b, c, d, f, g, h, j; a, b, c, d, f, g, i, j; a, b, c, d, f, h, i, j; a, b, c, d, g, h, i, j; a, b, c, e, f, g, h, i; a, b, c, e, f, g, h, j; a, b, c, e, f, g, i, j; a, b, c, e, f, h, i, j; a, b, c, e, g, h, i, j; a, b, c, f, g, h, i, j; a, b, d, e, f, g, h, i; a, b, d, e, f, g, h, j; a, b, d, e, f, g, i, j; a, b, d, e, f, h, i, j; a, b, d, e, g, h, i, j; a, b, d, f, g, h, i, j; a, b, e, f, g, h, i, j; a, c, d, e, f, g, h, i; a, c, d, e, f, g, h, j; a, c, d, e, f, g, i, j; a, c, d, e, f, h, i, j; a, c, d, e, g, h, i, j; a, c, d, f, g, h, i, j; a, c, e, f, g, h, i, j; a, d, e, f, g, h, i, j; b, c, d, e, f, g, h, i; b, c, d, e, f, g, h, j; b, c, d, e, f, g, i, j; b, c, d, e, f, h, i, j; b, c, d, e, g, h, i, j; b, c, d, f, g, h, i, j; b, c, e, f, g, h, i, j; b, d, e, f, g, h, i, j; or c, d, e, f, g, h, i, j;
h) a, b, c, d, e, f, g, h, i; a, b, c, d, e, f, g, h, j; a, b, c, d, e, f, g, i, j; a, b, c, d, e, f, h, i, j; a, b, c, d, e, g, h, i, j; a, b, c, d, f, g, h, i, j; a, b, c, e, f, g, h, i, j; a, b, d, e, f, g, h, i, j; a, c, d, e, f, g, h, i, j; or b, c, d, e, f, g, h, i, j; or
i) a, b, c, d, e, f, g, h, i, j,
where a=Vanillic acid; b=Syringic acid; c=P-Coumaric acid; d=Silicic acid; e=Cinnamic acid; f=Ferulic acid; g=Fisetin; h=Oxybenzone; i=Orbifloxacin; and j=Rosiglitazone maleate and stereoisomers, tautomers and agriculturally acceptable salts thereof.

26. The fertilizer or inert carrier according to claim 24, wherein the fertilizer or inert carrier comprises p-coumaric acid, syringic acid, vanillic acid, and cinnamic acid or stereoisomers, tautomers and agriculturally acceptable salts thereof or a composition comprising p-coumaric acid, syringic acid, vanillic acid, and cinnamic acid or stereoisomers, tautomers and agriculturally acceptable salts thereof and one or more component selected from: agriculturally suitable solvents, agriculturally suitable carriers, agriculturally suitable surfactants and mixtures thereof.

27. The fertilizer or inert carrier according to claim 26, said active agents being present in the fertilizer or inert carrier in equal amounts or approximately equal amounts.

28. The fertilizer or inert carrier according to claim 24, wherein the composition added to said fertilizer or inert carrier further comprises a vitamin, vitamin A, vitamin C, one or more crop oil, and mixtures thereof.

29. A method of controlling and/or treating citrus greening in a citrus plant comprising the application of fertilizer according to claim 24 to said citrus plant or to soil around said citrus plant.
